(19) United States
(12) Patent Application Publication
(10) Pub. No.: US 2025/0272817 A1
(43) Pub. Date: Aug. 28, 2025

(54) CODE GENERATION SUPPORT DEVICE AND CODE GENERATION SUPPORT PROGRAM PRODUCTS

(71) Applicant: Keyence Corporation, Osaka (JP)

(72) Inventors: Kimihiko SUGINO, Osaka (JP); Yohei OKAWA, Osaka (JP)

(73) Assignee: Keyence Corporation, Osaka (JP)

(21) Appl. No.: 19/032,147

(22) Filed: Jan. 20, 2025

(30) Foreign Application Priority Data
Feb. 22, 2024 (JP) 2024-025944

(51) Int. Cl. G06T 7/00; G06F 16/353; G06T 7/70

(52) U.S. Cl. CPC G06T 7/0004; G06F 16/353; G06T 7/70; G06T 2207/30164

(57) ABSTRACT

Provided are a code generation support device and a code generation support program that enable easy and appropriate measurement setting work on shape data obtained from a measurement head for performing a desired measurement on a measurement object. Shape data representing a three-dimensional shape is captured. A measurement screen including an image of a workpiece is displayed on a display device. On a measurement screen, designation of a geometric element and designation of a measurement item are received as designation information. An index indicating the received designation information is displayed on the measurement screen. Furthermore, a value of the measurement item in the workpiece is calculated based on the received designation information. A text code is generated together with the calculation of the value of the measurement item. The text code includes information for calling a processing program necessary for the calculation, and the designation information necessary for the calculation.

### CROSS-REFERENCE TO RELATED APPLICATIONS

The present application claims foreign priority based on Japanese Patent Application No. 2024-025944, filed Feb. 22, 2024, the contents of which are incorporated herein by reference.

### BACKGROUND OF THE INVENTION

### 1. Technical Field

The present invention relates to a code generation support device and a code generation support program that support generation of a code for performing measurement processing on shape data obtained from a measurement head that measures a shape of a measurement object.

### 2. Description of the Related Art

In order to measure a shape of a measurement object (hereinafter, it is referred to as a workpiece), an optical measurement device is used. For example, JP2022-138028A discloses an optical displacement measurement system as an example of a measurement device capable of measuring a shape of a workpiece. In the optical displacement measurement system, band-shaped light extending in one direction is emitted from a measurement head. When the workpiece passes through a light irradiation area, a plurality of pieces of profile data are acquired based on the light reflected from the workpiece to the measurement head.

By arranging the plurality of pieces of profile data (cross-sectional shape data) in a direction corresponding to a movement direction of the workpiece, three-dimensional data (shape data) indicating a three-dimensional shape of the workpiece is generated.

According to the above measurement device, for example, the three-dimensional shapes of a plurality of the workpieces moving at a constant speed by a belt conveyor can be sequentially measured. Moreover, it is possible to inspect whether there is an abnormality in the shape of the workpiece based on a measurement result of the three-dimensional shape.

With respect to the measurement and inspection of the workpiece using the measurement device, it is possible to automatically perform desired measurement by appropriately processing the shape data. In order to appropriately process the shape data, it is preferable to use dedicated application software corresponding to the measurement device. However, in a case where a plurality of different types of measurement devices, image processing devices, and the like are used in combination, there is a possibility that dedicated application software cannot be used. Therefore, for example, a user creates a unique program for each device related to the combination. However, it is not easy for the user to create an appropriate processing program for each measurement content for shape data representing a three-dimensional shape. Therefore, even if the desired measurement using the measurement device is attempted to be automated, the setting work is highly difficult.

### SUMMARY OF THE INVENTION

An object of the present invention is to provide a code generation support device and a code generation support program that enable easy and appropriate measurement setting work on shape data obtained from a measurement head for performing a desired measurement on a measurement object.

A code generation support device according to one embodiment of the present invention includes: a capture unit configured to capture shape data representing a three-dimensional shape of a measurement object; a screen generation unit configured to generate a measurement screen including an image of the measurement object based on the shape data captured by the capture unit and cause a display unit to display the measurement screen; a reception unit configured to receive, as designation information, designation of one or a plurality of geometric elements and designation of one or a plurality of measurement items related to the one or plurality of geometric elements on the measurement screen displayed on the display unit; an index display unit configured to cause an index indicating the received designation information to be displayed on the measurement screen displayed on the display unit in response to reception of the designation by the reception unit; a measurement setting generation unit configured to generate measurement setting data for calculating values of the one or plurality of measurement items in the measurement object based on the designation information received by the reception unit; an execution unit configured to calculate values of the one or plurality of measurement items in the measurement object based on the shape data captured by the capture unit and the measurement setting data generated by the measurement setting generation unit; and a code generation unit configured to select, from a plurality of processing programs respectively corresponding to a plurality of processes for respectively specifying a plurality of predefined types of geometric elements and a plurality of processes for respectively calculating values of a plurality of predefined types of measurement items, a plurality of processing programs respectively corresponding to a process for specifying the one or plurality of designated geometric elements and a process for calculating values of the one or plurality of designated measurement items, and generate a text code including a plurality of pieces of processing program information indicating the plurality of selected processing programs and the designation information received by the reception unit.

A code generation support program according to one embodiment of the present invention is a code generation support program executable by a processing device, the code generation support program causing the processing device to execute: a process of capturing shape data representing a three-dimensional shape of a measurement object; a process of generating a measurement screen including an image of the measurement object based on the shape data captured by the capturing process and causing a display unit to display the measurement screen; a process of receiving, as designation information, designation of one or a plurality of geometric elements and designation of one or a plurality of measurement items related to the one or plurality of geometric elements on the measurement screen displayed on the display unit; a process of causing an index indicating the received designation information to be displayed on the measurement screen displayed on the display unit in response to reception of the designation by the receiving process; a process of generating measurement setting data for calculating values of the one or plurality of measurement items in the measurement object based on the designation information received by the receiving process; a process of calculating values of the one or plurality of measurement items in the measurement object based on the shape data captured by the capturing process and the measurement setting data generated by the process of generating the measurement setting data; and a process of selecting, from a plurality of processing programs respectively corresponding to a plurality of processes for respectively specifying a plurality of predefined types of geometric elements and a plurality of processes for respectively calculating values of a plurality of predefined types of measurement items, a plurality of processing programs respectively corresponding to a process for specifying the one or plurality of designated geometric elements and a process for calculating values of the one or plurality of designated measurement items, and generating a text code including a plurality of pieces of processing program information indicating the plurality of selected processing programs and the designation information received by the receiving process.

According to the present invention, it is possible to easily and appropriately perform measurement setting work on shape data obtained from a measurement head for performing a desired measurement on a measurement object.

### BRIEF DESCRIPTION OF THE DRAWINGS

FIG. 1 is a diagram for explaining an outline of configurations of a main measurement system and a sub-measurement system;

FIG. 2 is a diagram for explaining a relationship between a text code and a library;

FIG. 3 is a block diagram illustrating a configuration of a control system of a main measurement device of the main measurement system;

FIG. 4 is a block diagram illustrating a configuration of a control system of the sub-measurement device;

FIG. 5 is a flowchart illustrating a large flow of a code generation support process;

FIG. 6 is a diagram for explaining a flow of an operation requested to a user at the time of executing the code generation support process;

FIG. 7 is an external perspective view of a workpiece exemplified in a generation example of a text code;

FIG. 8 is a diagram illustrating an initial state of a measurement screen displayed on a display device;

FIG. 9 is a diagram illustrating a transition example of a measurement screen displayed on the display device in a first phase;

FIG. 10 is a diagram illustrating a transition example of a measurement screen displayed on the display device in the first phase;

FIG. 11 is a diagram illustrating a transition example of a measurement screen displayed on the display device in the first phase;

FIG. 12 is a diagram illustrating a transition example of a measurement screen displayed on the display device in the first phase;

FIG. 13 is a diagram illustrating a transition example of a measurement screen displayed on the display device in the first phase;

FIG. 14 is a diagram illustrating a transition example of a measurement screen displayed on the display device in the first phase;

FIG. 15 is a diagram illustrating a transition example of a measurement screen displayed on the display device in the first phase;

FIG. 16 is a diagram illustrating a transition example of a measurement screen displayed on the display device in the first phase;

FIG. 17 is a flowchart illustrating an example of a shape data capture process;

FIG. 18 is a flowchart illustrating an example of the shape data capture process;

FIG. 19 is a diagram illustrating a transition example of a measurement screen displayed on the display device in a second phase;

FIG. 20 is a diagram illustrating a transition example of a measurement screen displayed on the display device in the second phase;

FIG. 21 is a diagram illustrating a transition example of a measurement screen displayed on the display device in the second phase;

FIG. 22 is a diagram illustrating a transition example of a measurement screen displayed on the display device in the second phase;

FIG. 23 is a flowchart illustrating an example of correction setting process;

FIG. 24 is a diagram illustrating a transition example of a measurement screen displayed on the display device in a third phase;

FIG. 25 is a diagram illustrating a transition example of a measurement screen displayed on the display device in the third phase;

FIG. 26 is a diagram illustrating a transition example of a measurement screen displayed on the display device in the third phase;

FIG. 27 is a diagram illustrating a transition example of a measurement screen displayed on the display device in the third phase;

FIG. 28 is a diagram illustrating a transition example of a measurement screen displayed on the display device in the third phase;

FIG. 29 is a diagram illustrating a transition example of a measurement screen displayed on the display device in the third phase;

FIG. 30 is a diagram illustrating a transition example of a measurement screen displayed on the display device in the third phase;

FIG. 31 is a diagram illustrating a transition example of a measurement screen displayed on the display device in the third phase;

FIG. 32 is a diagram illustrating a transition example of a measurement screen displayed on the display device in the third phase;

FIG. 33 is a diagram illustrating a transition example of a measurement screen displayed on the display device in the third phase;

FIG. 34 is a diagram illustrating a transition example of a measurement screen displayed on the display device in the third phase;

FIG. 35 is a diagram illustrating a transition example of a measurement screen displayed on the display device in the third phase;

FIG. 36 is a diagram illustrating a transition example of a measurement screen displayed on the display device in the third phase;

FIG. 37 is a diagram illustrating a transition example of a measurement screen displayed on the display device in the third phase;

FIG. 38 is a diagram illustrating a transition example of a measurement screen displayed on the display device in the third phase;

FIG. 39 is a flowchart illustrating an example of a measurement condition setting process;

FIG. 40 is a flowchart illustrating an example of the measurement condition setting process;

FIG. 41 is a diagram illustrating a transition example of a measurement screen displayed on the display device in a fourth phase;

FIG. 42 is a diagram illustrating a transition example of a measurement screen displayed on the display device in the fourth phase;

FIG. 43 is a diagram illustrating a transition example of a measurement screen displayed on the display device in the fourth phase;

FIG. 44 is a flowchart illustrating an example of a text code generation process;

FIG. 45 is a diagram illustrating an example of a text code generated by a code generation unit of FIG. 3;

FIG. 46 is a diagram illustrating a transition example of a measurement screen displayed on the display device by a function of synthesizing a plurality of pieces of shape data;

FIG. 47 is a diagram illustrating a transition example of a measurement screen displayed on the display device by a function of synthesizing a plurality of pieces of shape data;

FIG. 48 is a diagram illustrating a transition example of a measurement screen displayed on the display device by a function of synthesizing a plurality of pieces of shape data;

FIG. 49 is a diagram illustrating a transition example of a measurement screen displayed on the display device by a function of synthesizing a plurality of pieces of shape data; and

FIG. 50 is a flowchart illustrating an example of a synthesis condition setting process.

### DETAILED DESCRIPTION

Hereinafter, a code generation support device and a code generation support program according to an embodiment of the present invention will be described with reference to the drawings. The code generation support device is incorporated in, for example, one measurement system that performs predetermined measurement on the shape of a measurement object (hereinafter, the workpiece is referred to as a workpiece). Furthermore, the code generation support device is used to support setting work of a measurement device included in another measurement system so that the above-described one measurement is performed in another measurement system. In the following description, one measurement system including the configuration of the code generation support device is referred to as a main measurement system, and another measurement system including a support target (measurement device) of setting work is referred to as a sub-measurement system.

### 1. Outline of Hardware Configurations of Main Measurement System and Sub-Measurement System

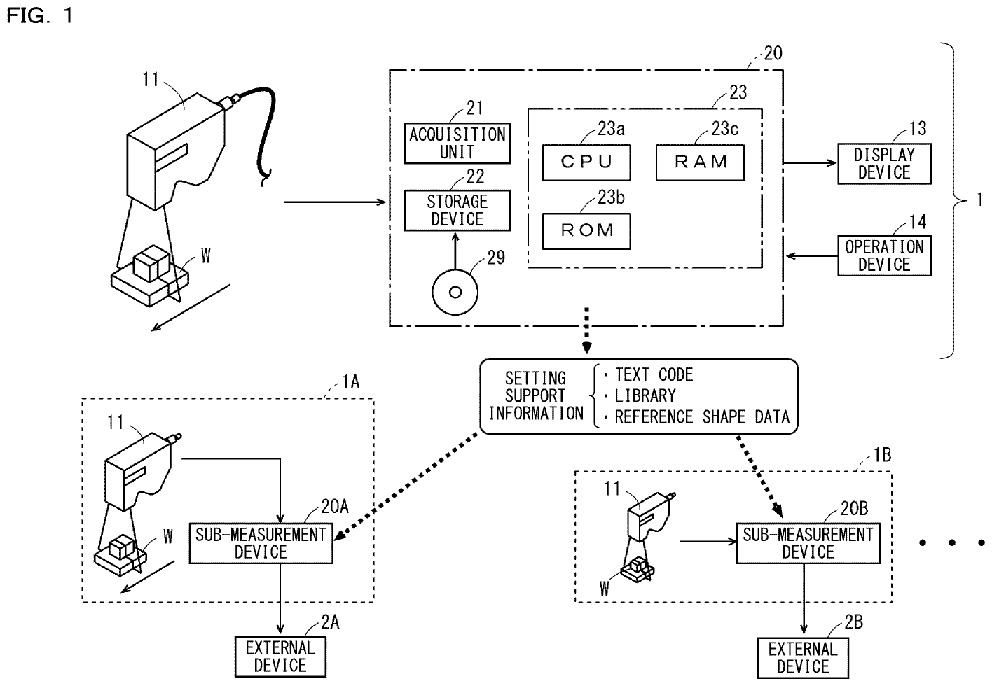

FIG. 1 is a diagram for explaining an outline of configurations of a main measurement system and a sub-measurement system. As illustrated in FIG. 1, the main measurement system 1 of the present example can measure and inspect the shape of each of a plurality of workpieces W conveyed by, for example, a belt conveyor, and includes a measurement head 11, a display device 13, an operation device 14, and a main measurement device 20.

The measurement head 11 of this example is fixed at a position facing a conveyance path of the workpiece W. Furthermore, the measurement head 11 includes a light projecting unit (not illustrated). The light projecting unit of the measurement head 11 irradiates strip-shaped measurement light extending in one direction toward the workpiece W moving on the conveyance path. Moreover, the measurement head 11 includes a light receiving unit (not illustrated). The light receiving unit of the measurement head 11 receives the measurement light reflected by the workpiece W and outputs a light reception amount distribution. The light receiving unit of the measurement head 11 is connected to the main measurement device 20. In the main measurement device 20, shape data indicating the three-dimensional shape of the workpiece W is generated based on the light reception amount distribution output from the measurement head 11.

Here, the shape data according to the present embodiment includes plane position information according to a plane coordinate system determined in advance for the measurement head 11 and height information corresponding to each plane position in the plane coordinate system. More specifically, the shape data may be configured by XY coordinates of each point sequence arranged in a lattice shape and Z coordinates corresponding to each point sequence as plane position information according to the plane coordinate system. Since each point sequence in the shape data is arranged in a lattice shape, the point sequences are arranged at an equal pitch in the X direction and are also arranged at an equal pitch in the Y direction. At this time, the pitch in the X direction and the pitch in the Y direction may be the same or different. Note that the shape data may include luminance information or the like corresponding to each plane position in addition to the plane position information and the height information.

The main measurement device 20 is an example of a code generation support device according to an embodiment of the present invention. The main measurement device 20 is configured by, for example, a personal computer, and includes an acquisition unit 21, a storage device 22, and a control unit 23. The acquisition unit 21 includes a communication interface and a memory, and is configured to receive the light reception amount distribution output from the measurement head 11, generate profile data from the received light reception amount distribution, and temporarily store the profile data. The storage device 22 includes a recording medium such as a nonvolatile memory or a hard disk, and stores a code generation support program. The code generation support program is a program for generating and outputting setting support information for supporting various setting work of the sub-measurement devices 20A, 20B, . . . to be described later.

The control unit 23 includes a CPU 23a, a ROM (read-only memory) 23b, and a RAM (random access memory) 23c. In the control unit 23, the RAM 23c is used as a work area of the CPU 23a. The ROM 23b stores a system program. The CPU 23a executes the code generation support program stored in the storage device 22 to implement various functional units for generating the setting support information. A configuration of a control system of the main measurement device 20 including these functional units will be described later.

Note that the code generation support program may be stored in the ROM 23b of the control unit 23 instead of the storage device 22. Furthermore, the code generation support program may be provided in a state of being stored in a recording medium 29 such as a CD-ROM or a USB memory, and may be installed in the storage device 22 or the ROM 23b.

The display device 13 includes a liquid crystal display (LCD) panel or an organic electroluminescence (EL) panel, and is connected to the main measurement device 20. The operation device 14 includes a keyboard and a pointing device, is configured to be operable by a user, and is connected to the main measurement device 20.

FIG. 1 illustrates a plurality of sub-measurement systems 1A, 1B, . . . having a common configuration. A configuration of the sub-measurement system 1A will be described as a representative of the plurality of sub-measurement systems 1A, 1B, . . . .

The sub-measurement system 1A includes a measurement head 11 and a sub-measurement device 20A. The measurement head 11 of the sub-measurement system 1A has the same configuration as the measurement head 11 of the main measurement system 1.

The sub-measurement device 20A is, for example, a personal computer, and basically has the same configuration as the main measurement device 20, but the storage device of the sub-measurement device 20A does not store the above code generation support program. The configuration of the control system of the sub-measurement device 20A will be described later.

As described above, in the main measurement device 20, the setting support information is generated and output on the basis of the operation of the user by executing the code generation support program. Various settings related to the measurement of the workpiece W are performed in the sub-measurement device 20A using the setting support information output from the main measurement device 20 of the main measurement system 1. In the sub-measurement device 20A after the setting using the setting support information, predetermined measurement (or inspection) is performed on the shape of the workpiece W based on the shape data obtained from the measurement head 11.

The sub-measurement device 20A is connected to an external device 2A. The external device 2A is, for example, a programmable logic controller (PLC). A measurement result (or an inspection result) by the sub-measurement device 20A is given to the external device 2A. Similarly to the sub-measurement device 20A, an external device 2B is also connected to the sub-measurement device 20B.

The setting support information generated by the main measurement device 20 includes a text code (source code), a library, and reference shape data. The text code is data generated by the main measurement device 20 based on an operation of a user. The library is, for example, data prepared in advance by the manufacturer of the main measurement device 20. The reference shape data is shape data of the workpiece W mainly used when a text code is generated in the main measurement device 20.

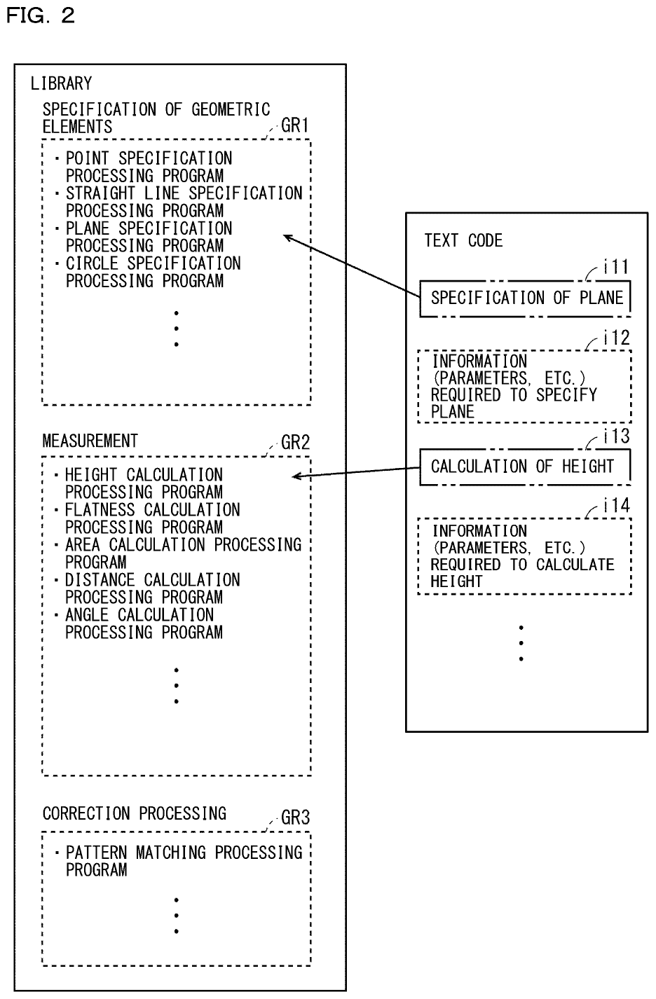

Here, an outline of a relationship between the text code and the library will be described. FIG. 2 is a diagram for explaining a relationship between a text code and a library. The library includes a plurality of processing programs capable of appropriately performing a plurality of pieces of predefined processing on the shape data of the workpiece W. The library may be provided in the form of, for example, a dynamic link library (DLL) file. The plurality of processing programs of the library of this example include processing programs classified into three groups (first group GR1, second group GR2 and third group GR3). Note that the text code can be easily modified by the user, and thus, for example, it is easy to use a plurality of different types of measurement devices, image processing devices, and the like in combination in order to execute inspection.

The plurality of processing programs classified into the first group GR1 are used to specify portions of a plurality of types of geometric shapes from the shape data of the workpiece W, and exist for each type (geometric element) of the geometric shape. The geometric element includes a point, a straight line, a plane, a circle, and the like. In the example of FIG. 2, a “point specification processing program”, a “straight line specification processing program”, a “plane specification processing program”, and the like are illustrated.

The plurality of processing programs classified into the second group GR2 are used to perform a plurality of kinds of measurements on the shape of the workpiece W from the shape data of the workpiece W, and exist for each type of measurement (measurement item). The measurement items include height, flatness, area, distance, angle, and the like. In the example of FIG. 2, a “height calculation processing program”, a “flatness calculation processing program”, an “area calculation processing program”, and the like are illustrated.

The plurality of processing programs classified into the third group GR3 are used to perform position correction on the shape data of the workpiece W by a plurality of types of methods, and exist for each position correction method. The position correction method includes a correction method based on pattern matching. In the example of FIG. 2, a “pattern matching processing program” is illustrated. Here, the position correction includes correction of a position in the plane coordinate system. Furthermore, the position correction may include correction of a rotational posture in the plane coordinate system in addition to correction of a position in the plane coordinate system. Furthermore, the position correction may include correction of a position in the height coordinate system corresponding to the height information in addition to correction of a position in the plane coordinate system. Moreover, the position correction may include correction of an attitude (three-dimensional attitude) in a three-dimensional coordinate system including a plane coordinate system and a height coordinate system. Note that the number of processing programs classified into the third group GR3 may be one.

The text code includes character information (processing program information to be described later) indicating a processing program to be called from the library in order to specify one or a plurality of geometric elements from the shape data or perform one or a plurality of measurements. This character information can be said to be information indicating a “function” required for processing for specifying one or a plurality of geometric elements or performing one or a plurality of measurements.

Furthermore, the text code includes character information (designation information to be described later) indicating a parameter or the like necessary for specifying one or a plurality of geometric elements or performing one or a plurality of measurements. This character information can be said to be information indicating an “argument” accompanying the “function” for specifying one or a plurality of geometric elements or performing one or a plurality of measurements.

In the example of FIG. 2, “specification of plane”, “information required to specify plane”, “calculation of height”, and “information required to calculate height” are indicated as the character information i11, i12, i13, and i14 included in the text code.

According to this text code, by reading character information i11 of “specification of plane”, a “plane specification processing program” can be selected and called from a plurality of processing programs in the library. Furthermore, a desired planar portion of the workpiece W can be specified based on the called “plane specification processing program” and the character information i12 including the contents of the “information required to specify a plane”.

Moreover, according to the text code, the “height calculation processing program” can be selected and called from the plurality of processing programs in the library by reading the character information i13 of “calculation of height”. Furthermore, the height of the desired portion of the workpiece W can be measured from the shape data of the workpiece W based on the called “height calculation processing program” and the character information i14 including the contents of “information required to calculate a height”.

### 2. Control System of Main Measurement Device 20

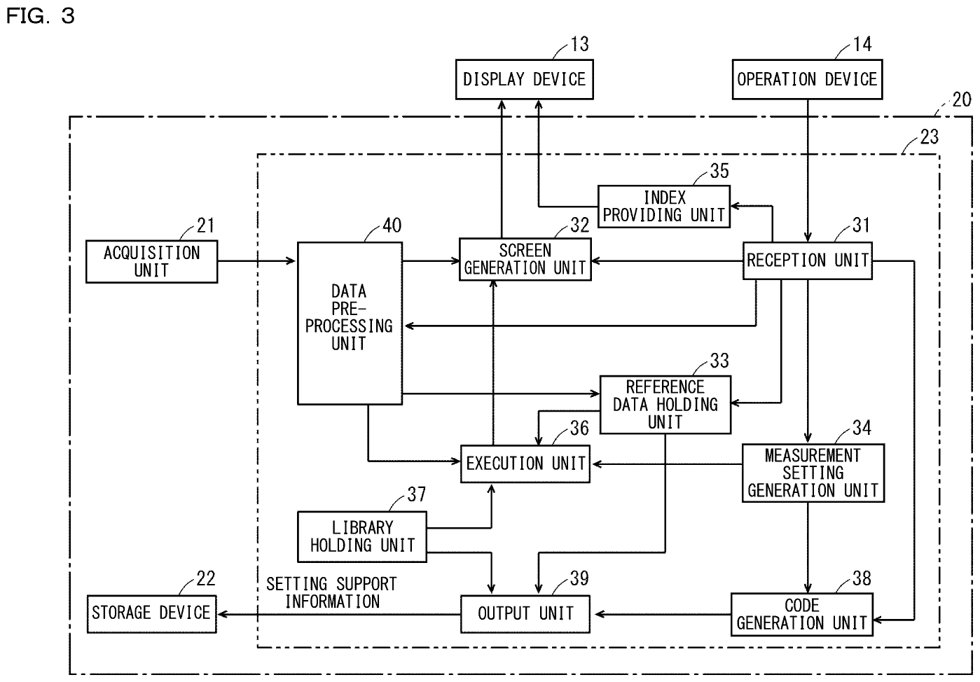

FIG. 3 is a block diagram illustrating a configuration of a control system of the main measurement device 20 of the main measurement system 1. As illustrated in FIG. 3, the control unit 23 of the main measurement system 1 includes, as functional units, a reception unit 31, a screen generation unit 32, a reference data holding unit 33, a measurement setting generation unit 34, an index providing unit 35, an execution unit 36, a library holding unit 37, a code generation unit 38, an output unit 39, and a data pre-processing unit 40. As described above, the functional units of the control unit 23 are implemented by the CPU 23a (FIG. 1) of the control unit 23 executing the code generation support program stored in the storage device 22. Note that a part or all of the functional units of the control unit 23 may be realized by hardware such as an electronic circuit.

As described above, the main measurement system 1 measures the shapes of a plurality of workpieces W conveyed by a belt conveyor, for example. Here, an encoder is provided in a conveyance device of the workpiece W such as a belt conveyor. In the main measurement device 20, the movement distance of each workpiece W conveyed by the conveyance device in a conveyance direction can be grasped based on the output from the encoder of the conveyance device. The data pre-processing unit 40 captures profile data generated by the acquisition unit 21 and temporarily stored at a preset pitch. Specifically, the data pre-processing unit 40 captures the profile data generated by the acquisition unit 21 every time each workpiece W moves by a predefined distance (a set pitch) based on the output from the encoder of the conveyance device. Furthermore, the data pre-processing unit 40 generates shape data from the plurality of pieces of captured profile data, and performs processing (filter processing or the like) as necessary on the shape data. Note that the data pre-processing unit 40 may not perform processing on the generated shape data. Furthermore, in a case where a synthesis condition for synthesizing a plurality of pieces of shape data is set, the data pre-processing unit 40 synthesizes a plurality of pieces of shape data according to the set synthesis condition. The synthesis of the plurality of pieces of shape data will be described later.

The screen generation unit 32 generates a measurement screen including an image of the workpiece W on the basis of the shape data subjected to processing as necessary by the data pre-processing unit 40, and causes the display device 13 to display the measurement screen. Note that the screen generation unit 32 generating an image or a measurement screen means that the screen generation unit 32 generates image data so that the image or the measurement screen is displayed on the display device 13. The image of the workpiece W generated by the screen generation unit 32 includes a two-dimensional height image and a three-dimensional height image. The three-dimensional height image is an image in which a plurality of images indicating the height of each part of the workpiece W viewed from a plurality of directions is switched and displayed. The two-dimensional height image is an image indicating the height of each part of the workpiece W viewed from one direction. In the following description, in a case where it is not necessary to distinguish between the two-dimensional height image and the three-dimensional height image, these images are collectively referred to as height images.

The reception unit 31 receives input of various types of information, various designations, various selections, and the like on the basis of an operation of the operation device 14 by a user. For example, the reception unit 31 receives designation of one or a plurality of geometric elements and designation of one or a plurality of measurement items as designation information on the measurement screen displayed on the display device 13 based on the operation of the operation device 14 by the user. In response to the reception of the designation information by the reception unit 31, the index providing unit 35 displays an index indicating the received designation information on the measurement screen displayed on the display device 13. Furthermore, the reception unit 31 receives an instruction to output the setting support information based on the operation of the operation device 14 by the user.

The reference data holding unit 33 holds the reference shape data. In a case where the reference shape data is held in the reference data holding unit 33, the reception unit 31 can receive, as the correction information, designation of a correction method for position correction of the shape data based on the reference shape data. As a result, the correction information of the shape data is set in the main measurement device 20. In this case, the data pre-processing unit 40 corrects the shape data captured from the acquisition unit 21 on the basis of the correction information.

The measurement setting generation unit 34 generates measurement setting data for calculating the value of one or a plurality of measurement items in the workpiece W based on the designation information received by the reception unit 31. The execution unit 36 calculates values of one or a plurality of measurement items in the workpiece W based on the shape data obtained through the data pre-processing unit 40 and the measurement setting data generated by the measurement setting generation unit 34.

The library holding unit 37 holds a library including the plurality of processing programs. The number of libraries held by the library holding unit 37 may be one or a plurality of.

The code generation unit 38 generates a text code including a plurality of pieces of processing program information and one or a plurality of pieces of designation information received by the reception unit 31. The processing program information is information for selecting and calling a part of the processing programs from the library.

In response to the reception of the instruction to output the setting support information by the reception unit 31, the output unit 39 associates the library and the reference shape data with the text code generated by the code generation unit 38. Furthermore, the output unit 39 outputs the text code, the library, and the reference shape data associated with each other to a predefined output destination (for example, in the storage device 22) as the setting support information. As a result, the user can extract desired setting support information from the storage device 22 of the main measurement device 20 at the time of setting work of the sub-measurement devices 20A and 20B.

### 3. Control System of Sub-Measurement Devices 20A and 20B

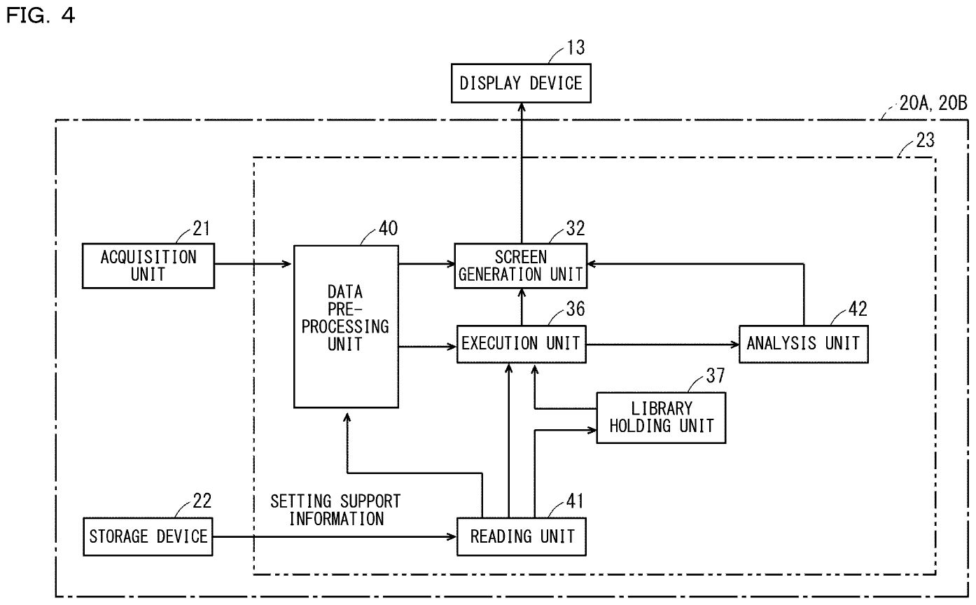

FIG. 4 is a block diagram illustrating a configuration of a control system of the sub-measurement devices 20A and 20B. As illustrated in FIG. 4, the control unit 23 of each of the sub-measurement devices 20A and 20B of the present example includes a screen generation unit 32, an execution unit 36, a library holding unit 37, a data pre-processing unit 40, a reading unit 41, and an analysis unit 42 as functional units for measuring the shape of the workpiece W. These functional units are realized, for example, by the CPU of the control unit 23 of the sub-measurement devices 20A and 20B executing a program for measuring the shape of the workpiece W stored in advance in the storage device 22. Note that a part or all of the functional units of the control unit 23 may be realized by hardware such as an electronic circuit.

At the time of setting the sub-measurement devices 20A and 20B for measuring the shape of the workpiece W, the setting support information extracted from the storage device 22 of the main measurement device 20 is input to the sub-measurement devices 20A and 20B. The input setting support information is stored in the storage device 22. The reading unit 41 reads the setting support information stored in the storage device 22. The library holding unit 37 holds a library of setting support information read by the reading unit 41.

The acquisition unit 21 of the sub-measurement devices 20A and 20B has the same configuration and function as the acquisition unit 21 of the main measurement device 20. Similarly to the data pre-processing unit 40 of the main measurement device 20, the data pre-processing unit 40 of the sub-measurement devices 20A and 20B captures the profile data generated by the acquisition unit 21 and temporarily stored at a preset pitch. Furthermore, the data pre-processing unit 40 generates shape data from the plurality of pieces of captured profile data, and performs processing (filter processing or the like) as necessary on the generated shape data.

Moreover, the data pre-processing unit 40 performs position correction, synthesis, or the like of the shape data captured from the acquisition unit 21 on the basis of the text code and the reference shape data read by the reading unit 41.

The execution unit 36 calculates values of one or a plurality of measurement items in the workpiece W based on the shape data obtained through the data pre-processing unit 40, the text code read by the reading unit 41, and the library held in the library holding unit 37.

The analysis unit 42 performs various analyses on the basis of the calculation result (measurement result) obtained by the execution unit 36. The screen generation unit 32 causes the display device 13 to display the image of the workpiece W on the basis of the shape data obtained through the data pre-processing unit 40. Furthermore, the screen generation unit 32 causes the display device 13 to display the calculation result obtained by the execution unit 36 and the analysis result obtained by the analysis unit 42.

### 4. Code Generation Support Process and Operation Procedure of Main Measurement Device 20 by User

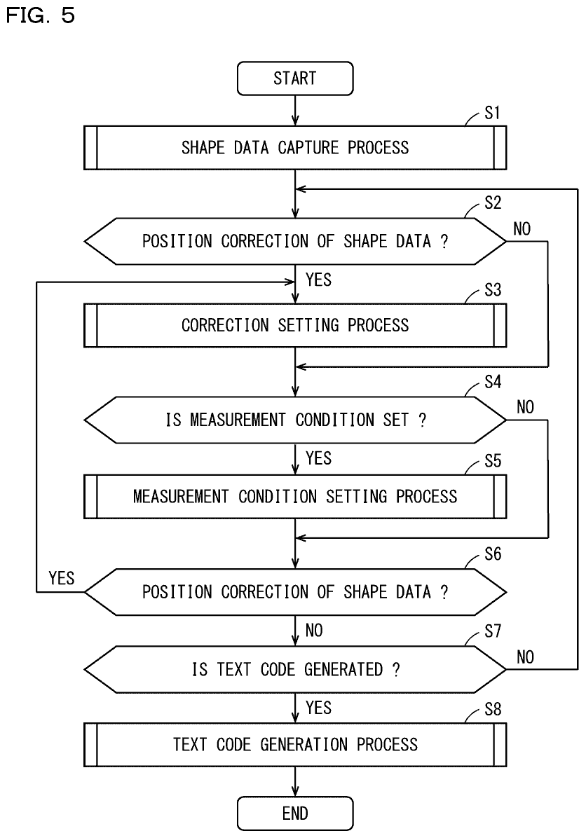

In the main measurement device 20, the following code generation support process is performed by executing the code generation support program. FIG. 5 is a flowchart illustrating a large flow of the code generation support process. The code generation support process is started based on an instruction by a user's operation.

As illustrated in FIG. 5, when the code generation support process is started, the control unit 23 in FIG. 1 performs a shape data capture process (step S1). The shape data capture process is a process for capturing profile data of the workpiece W, setting the capture condition, and generating shape data. Details of the shape data capture process will be described later.

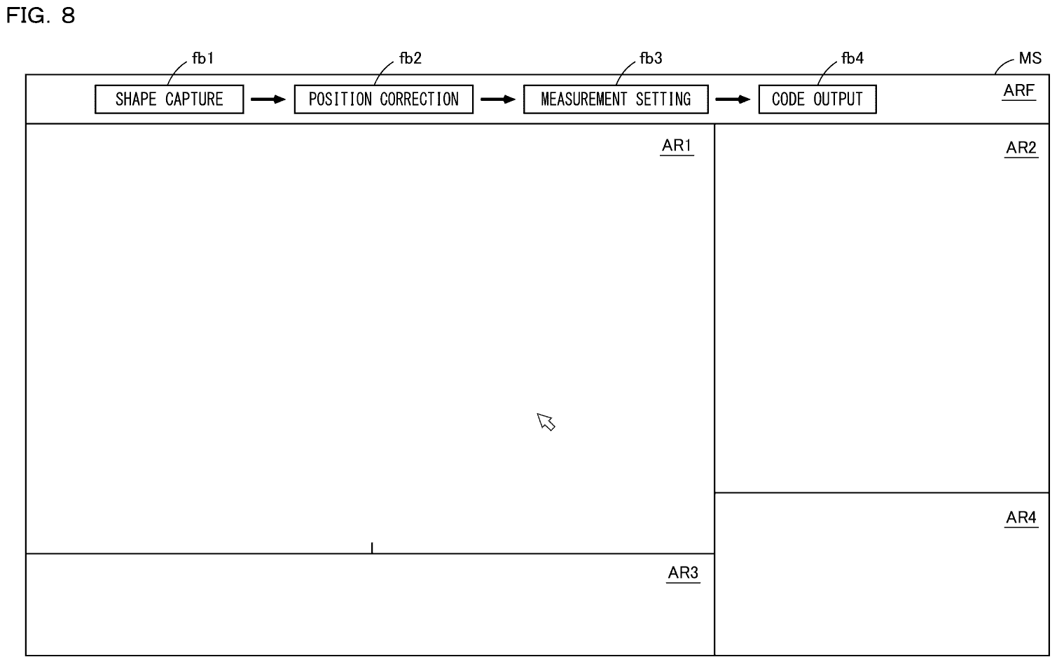

Next, the control unit 23 in FIG. 1 determines whether or not to perform position correction of the shape data generated in step S1 (step S2). This determination is made based on whether or not an instruction to perform position correction of the shape data has been issued by a user's operation. Specifically, the determination is made based on whether or not the user has operated a second phase button fb2 (FIG. 8) to be described later by operating the operation device 14.

In a case where it is determined in step S2 that the position correction of the shape data is not performed, the process proceeds to step S4 described later. On the other hand, in a case where it is determined in step S2 that position correction of the shape data is to be performed, the control unit 23 in FIG. 1 performs correction setting process (step S3). The correction setting process is a process for setting correction information of the shape data. Details of the correction setting process will be described later.

Next, the control unit 23 in FIG. 1 determines whether or not to set a measurement condition (step S4). This determination is made based on whether or not an instruction to set a measurement condition has been issued by a user's operation. Specifically, the determination is made based on whether or not the user has operated a third phase button fb3 (FIG. 8) to be described later by operating the operation device 14.

In a case where it is determined in step S4 that the setting of the measurement condition is not performed, the process proceeds to step S6 described later. On the other hand, in a case where it is determined in step S4 to set the measurement condition, the control unit 23 in FIG. 1 performs a measurement condition setting process (step S5). The measurement condition setting process is a process of setting the measurement condition of the workpiece W using designation information based on various designations of the user. Details of the measurement condition setting process will be described later. Here, in a case where a plurality of pieces of correction information is set in the correction setting process, for each measurement condition in the measurement condition setting process, the correction information to be applied in association with the measurement condition may be selectable from a plurality of pieces of set correction information.

Next, as in step S2, the control unit 23 in FIG. 1 determines whether or not to perform position correction on the shape data captured in step S1 (step S6). In a case where it is determined in step S6 that position correction of the shape data is to be performed, the process proceeds to step S3.

On the other hand, in a case where the position correction of the shape data is not performed in step S6, the control unit 23 in FIG. 1 determines whether or not to generate a text code (step S7). This determination is made based on whether or not there is an instruction to generate a text code by a user's operation. Specifically, the determination is made based on whether or not the user has operated a fourth phase button fb4 (FIG. 8) to be described later by operating the operation device 14.

In step S7, in a case where it is determined not to generate the text code, the process proceeds to step S2 described above. On the other hand, in a case where it is determined in step S7 to generate the text code, the control unit 23 in FIG. 1 performs a text code generation process (step S8). The text code generation process is a process of generating a text code of the setting support information on the basis of the correction information set in the above correction setting process, the measurement condition set in the measurement condition setting process, and the like. Furthermore, the text code generation process of the present example includes a process of outputting the library and the reference shape data together with the text code, that is, a process of outputting the setting support information. Details of the text code generation process will be described later. When the text code generation process ends, the code generation support process ends.

When executing the code generation support process, the user of the main measurement device 20 needs to perform an operation corresponding to each of the shape data capture process, the correction setting process, the measurement condition setting process, and the text code generation process.

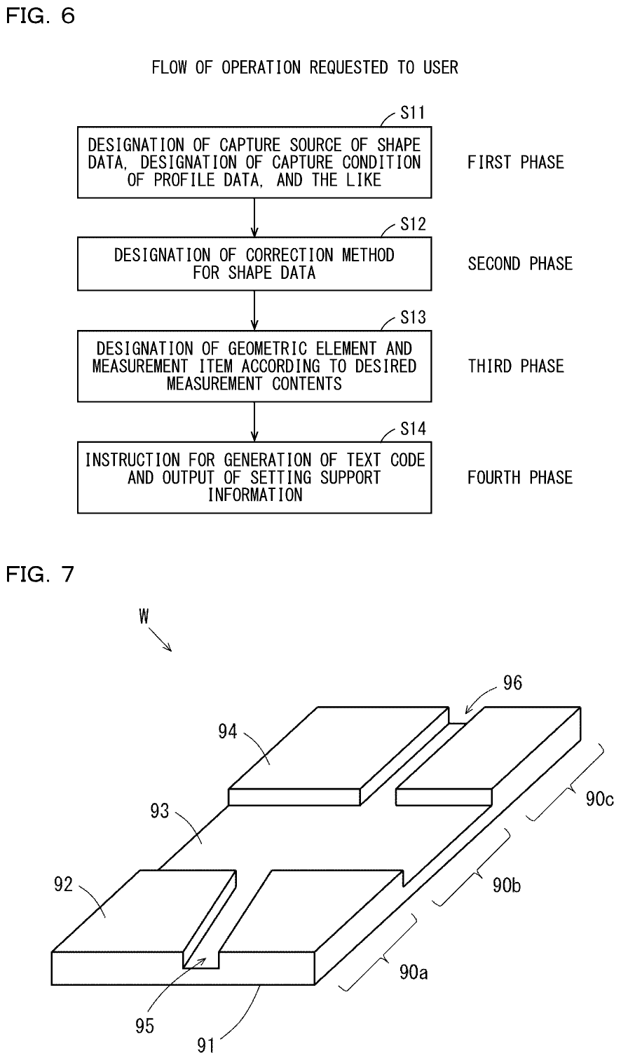

FIG. 6 is a diagram for explaining a flow of an operation requested to the user at the time of executing the code generation support process. As illustrated in FIG. 6, the user designates a capture source of the shape data, designates the capture condition of the profile data of the workpiece W, and the like as the operation corresponding to the shape data capture process of FIG. 5 (step S11). The operating stage of the main measurement device 20 by the user at this time is referred to as a first phase.

Next, as an operation corresponding to the correction setting process of FIG. 5, the user designates a correction method for the shape data to be captured, and the like (step S12). The operating stage of the main measurement device 20 by the user at this time is referred to as a second phase.

Next, as an operation corresponding to the measurement condition setting process of FIG. 5, the user designates a geometric element and a measurement item according to desired measurement contents (step S13). The operating stage of the main measurement device 20 by the user at this time is referred to as a third phase.

Finally, the user instructs generation of a text code and output of setting support information as an operation corresponding to the text code generation process of FIG. 5 (step S14). The operating stage of the main measurement device 20 by the user at this time is referred to as a fourth phase.

The user can basically generate text codes by operating the main measurement device 20 according to this order for the first phase, the second phase, the third phase and the fourth phase. Note that the order of the second phase and the third phase may be interchanged or repeated. Furthermore, the second phase and the third phase may be the same phase. In this case, processing corresponding to the second phase and processing corresponding to the third phase may be selectively executed according to selection of a tool to be described later.

The user inputs the setting support information obtained by the series of operations to, for example, the sub-measurement devices 20A and 20B of the sub-measurement systems 1A and 1B, respectively. Alternatively, in a case where the measurement of the workpiece W by the sub-measurement systems 1A and 1B is incorporated into the operation of another system in a manufacturing line or the like, the setting support information is incorporated into the operation program of the another system. As a result, the user can easily perform setting work for performing desired measurement with each of the sub-measurement devices 20A and 20B.

### 5. Generation Example of Text Code

Hereinafter, an example of the operation procedure of the main measurement device 20 by the user for generating the text code will be described together with the transition of a measurement screen displayed on the display device 13. First, the shape of the workpiece W to be measured in the text code generation example described below will be described.

### <1> Workpiece W to be Measured

FIG. 7 is an external perspective view of a workpiece W exemplified in the generation example of the text code. As illustrated in FIG. 7, the workpiece W of the present example is a rectangular plate-like member extending in one direction, and includes a first portion 90a, a second portion 90b, and a third portion 90c arranged in the one direction.

Furthermore, the workpiece W includes a bottom surface portion 91. The bottom surface portion 91 is formed flat throughout the first portion 90a, the second portion 90b, and the third portion 90c. Moreover, the workpiece W includes a first upper surface portion 92, a second upper surface portion 93, and a third upper surface portion 94 facing a direction opposite to the bottom surface portion 91.

The first upper surface portion 92, the second upper surface portion 93, and the third upper surface portion 94 are upper surface portions of the first portion 90a, the second portion 90b, and the third portion 90c, respectively. Thicknesses of the first portion 90a and the third portion 90c are the same, and a thickness of the second portion 90b is smaller than the thicknesses of the first portion 90a and the third portion 90c. Accordingly, steps are formed between the first upper surface portion 92 and the second upper surface portion 93 and between the second upper surface portion 93 and the third upper surface portion 94.

In the first portion 90a, a groove 95 extending in a direction inclined with respect to one direction is formed in a central portion of the first upper surface portion 92. In the third portion 90c, a groove 96 extending in one direction is formed in a central portion of the third upper surface portion 94. The height of the bottom portion of each of the grooves 95 and 96 is equal to the height of the second upper surface portion 93 and is flush with each other.

<2> Initial State of Measurement Screen

FIG. 8 is a diagram illustrating an initial state of the measurement screen displayed on the display device 13. When the text code is generated in the main measurement device 20, the measurement screen MS including a phase display area ARF, a first display area AR1, a second display area AR2, a third display area AR3, and a fourth display area AR4 is displayed on the display device 13.

As illustrated in FIG. 8, the phase display area ARF is a band-shaped area extending at a constant width in the left-right direction at the upper end of the measurement screen MS. The first display area AR1 is a rectangular area extending in a relatively wide range from the left edge of the measurement screen MS to the central portion of the measurement screen MS. The second display area AR2 is a rectangular area located between the first display area AR1 and the right edge of the measurement screen MS.

The third display area AR3 is a band-shaped area located between the first display area AR1 and the lower edge of the measurement screen MS. The fourth display area AR4 is a relatively small rectangular area located at the lower right corner of the measurement screen MS and adjacent to the first display area AR1, the second display area AR2, and the third display area AR3.

In the initial state, in the phase display area ARF, a first phase button fb1, a second phase button fb2, a third phase button fb3, and a fourth phase button fb4 are disposed in this order from left to right. Furthermore, an arrow from right to left is indicated between each two adjacent phase buttons.

The first phase button fb1 is a button indicating a first phase of the operation stage of the user, and corresponds to the shape data capture process described above. The first phase button fb1 is provided with a character string “shape capture” for allowing the user to intuitively grasp the content of the shape data capture process.

The second phase button fb2 is a button indicating a second phase of the operation stage of the user, and corresponds to the correction setting process described above. The second phase button fb2 is provided with a character string “position correction” for allowing the user to intuitively grasp the contents of the correction setting process.

The third phase button fb3 is a button indicating a third phase of the operation stage of the user, and corresponds to the measurement condition setting process described above. The third phase button fb3 is provided with a character string “measurement setting” for allowing the user to intuitively grasp the contents of the measurement condition setting process.

The fourth phase button fb4 is a button indicating a fourth phase of the operation stage of the user, and corresponds to the text code generation process described above. The fourth phase button fb4 is provided with a character string “code output” for allowing the user to intuitively grasp the contents of the text code generation process.

As a result, by visually recognizing the phase display area ARF of the measurement screen MS, the user can grasp that there are roughly four phases as operation stages for generating the text code and the content to be performed in each phase.

The four phase buttons fb1 to fb4 can be operated by a user with a pointer. When the user operates any one of the phase buttons fb1 to fb4, the display state of the measurement screen MS is switched so that an image corresponding to the operated phase button is displayed. Furthermore, among the phase buttons fb1 to fb4, the operated phase button is displayed in a display mode (for example, highlight display) different from other phase buttons. Accordingly, the user can perform various operations while grasping the current operation stage.

In the initial state, in a case where none of the phase buttons fb1 to fb4 is operated, no image is displayed in the first display area AR1, the second display area AR2, the third display area AR3, and the fourth display area AR4.

### <3> First Phase

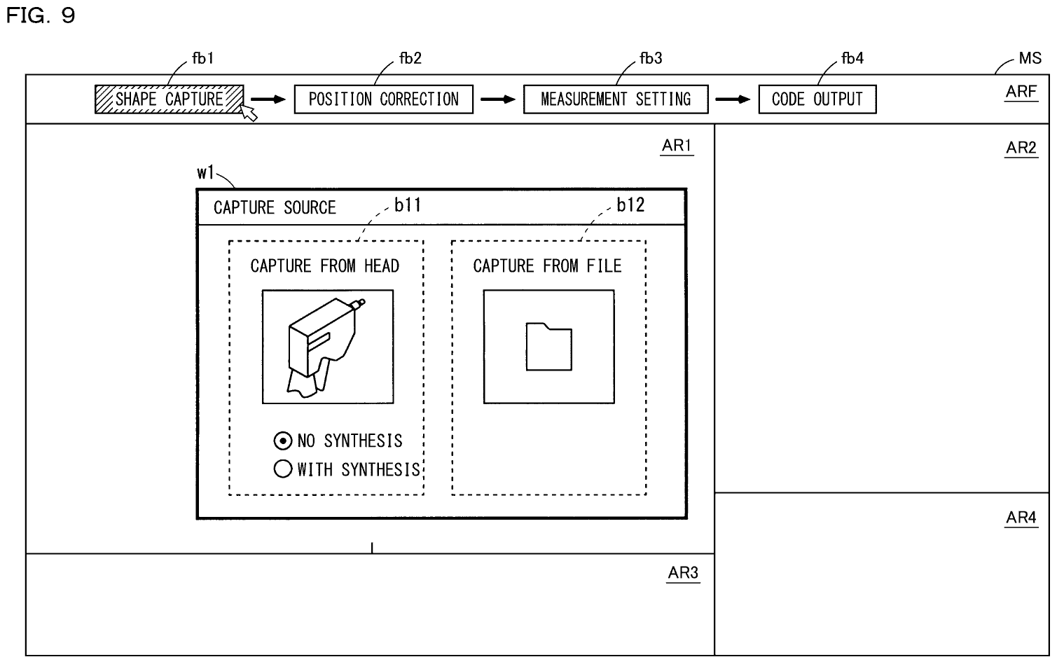

When the first phase button fb1 of FIG. 8 is operated, the shape data capture process is started. FIGS. 9 to 16 are diagrams illustrating a transition example of the measurement screen MS displayed on the display device 13 in the first phase. As illustrated in FIG. 9, when the first phase button fb1 is operated, the display mode of the first phase button fb1 changes so as to be distinguishable from other phase buttons. Furthermore, a setting window w1 prompting an instruction related to the capture of the shape data of the workpiece W is superimposed and displayed at the center of the measurement screen MS.

In the setting window w1, a head button b11 and a file button b12 are displayed. The head button b11 is a button for capturing shape data of the workpiece W from any one of the one or the plurality of measurement heads 11 connected to the main measurement device 20. The head button b11 of this example includes a radio button for selecting whether or not to sunthesize a plurality of pieces of shape data captured from the measurement head 11. Here, it is assumed that the shape data is not synthesized. An example of synthesizing a plurality of pieces of shape data captured from the measurement head 11 will be described later. The file button b12 is a button for capturing shape data stored in advance in the storage device 22 or the like of the main measurement device 20 in FIG. 3. Note that the option for selecting whether or not to synthesize may be displayed only the first time of setting of the data capture source. In a case where the setting of the data capture source is changed, an option for selecting whether or not to synthesize may not be displayed. That is, the option for selecting whether or not to synthesize is not necessarily displayed until the setting of the data capture source for generating a new text code is performed (until the time of next new creation) after the setting of the data capture source for generating one text code is once performed.

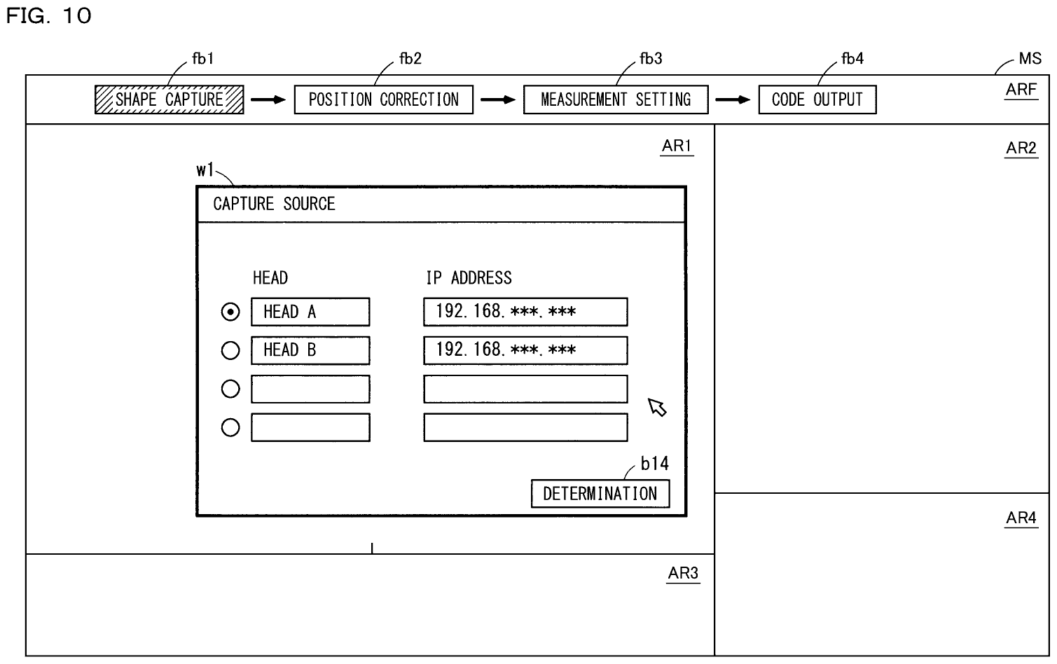

The user can designate the capture source of the shape data by operating the head button b11 or the file button b12. For example, the user operates the head button b11. In this case, as illustrated in FIG. 10, the name of the measurement head 11 currently connected to the main measurement device 20 is displayed in a selectable manner in the setting window w1.

Furthermore, an IP address indicating a connection destination of the measurement head 11 is displayed next to each name of the measurement head 11. Moreover, a determination button b14 is displayed at the bottom of the setting window w1. Therefore, the user selects a desired measurement head 11 and operates the determination button b14. As a result, the user can capture the shape data of the workpiece W using the desired measurement head 11.

On the other hand, in a case where the user operates the file button b12 in the setting window w1 of FIG. 9, an image, an operation button, and the like for designating a folder or the like from which the shape data is captured are displayed in the setting window w1. As a result, the user can capture desired shape data by designating the capture source.

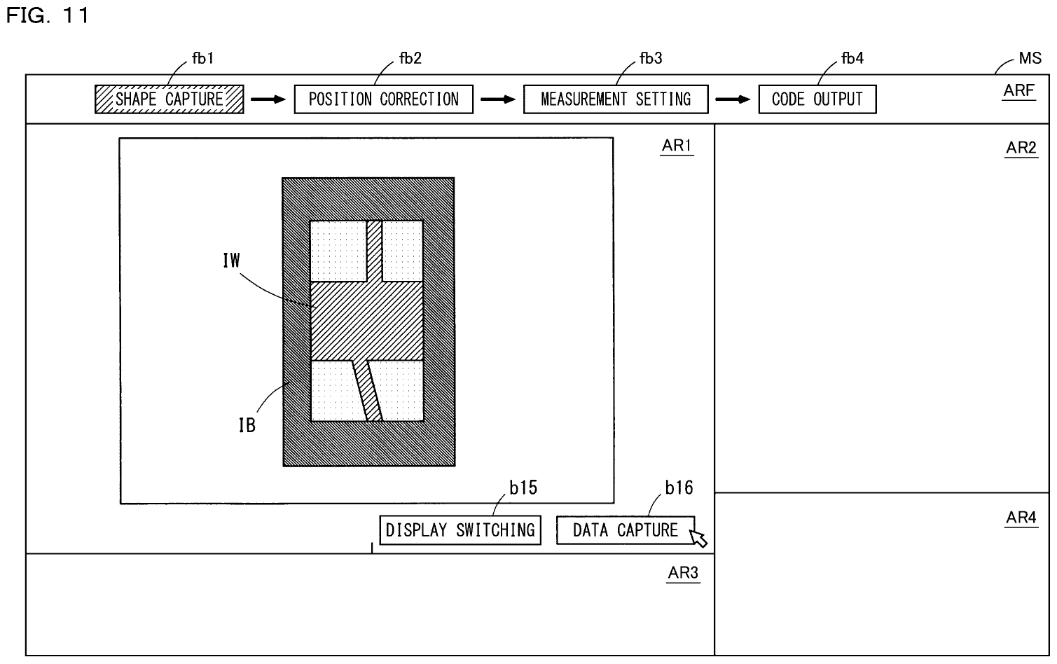

In a case where the capture of the shape data using the measurement head 11 is determined on the measurement screen MS of FIG. 10, the data pre-processing unit 40 of FIG. 3 captures the profile data from the acquisition unit 21 at a predetermined pitch to generate the shape data. In this case, as illustrated in FIG. 11, an image of the workpiece W based on the generated shape data is displayed in the first display area AR1. Furthermore, a display switching button b15 and a data capture button b16 are displayed in the first display area AR1.

Here, in the first display area AR1, basically, at least one of the two-dimensional height image and the three-dimensional height image based on the shape data is displayed. In the example of FIG. 11, the two-dimensional height image is displayed in the first display area AR1. In the height image, a difference in height of each part of the surface of the workpiece W is indicated by a difference in luminance or color. In the height images illustrated in predetermined drawings after FIG. 11, the difference in height of each part of the surface of the workpiece W is indicated by hatching and the difference in density of the dot pattern. It is assumed that a higher density of the hatching and the dot pattern indicates a lower height of the corresponding portion, and a lower density of the hatching and the dot pattern indicates a higher height of the corresponding portion.

In the present example, it is assumed that shape data of the upper surface of the table member and the surface of the workpiece W are captured in a state where the workpiece W of FIG. 7 is placed on the table member. Therefore, the height image described below includes an image IB of the table member on which the workpiece W is placed together with an image IW of the workpiece W in FIG. 7.

The display switching button b15 in FIG. 11 is a button for switching the image of the workpiece W displayed in the first display area AR1. The user can display the three-dimensional height image in place of the two-dimensional height image in the first display area AR1 by operating the display switching button b15. Alternatively, the user can display the two-dimensional height image and the three-dimensional height image side by side in the first display area AR1.

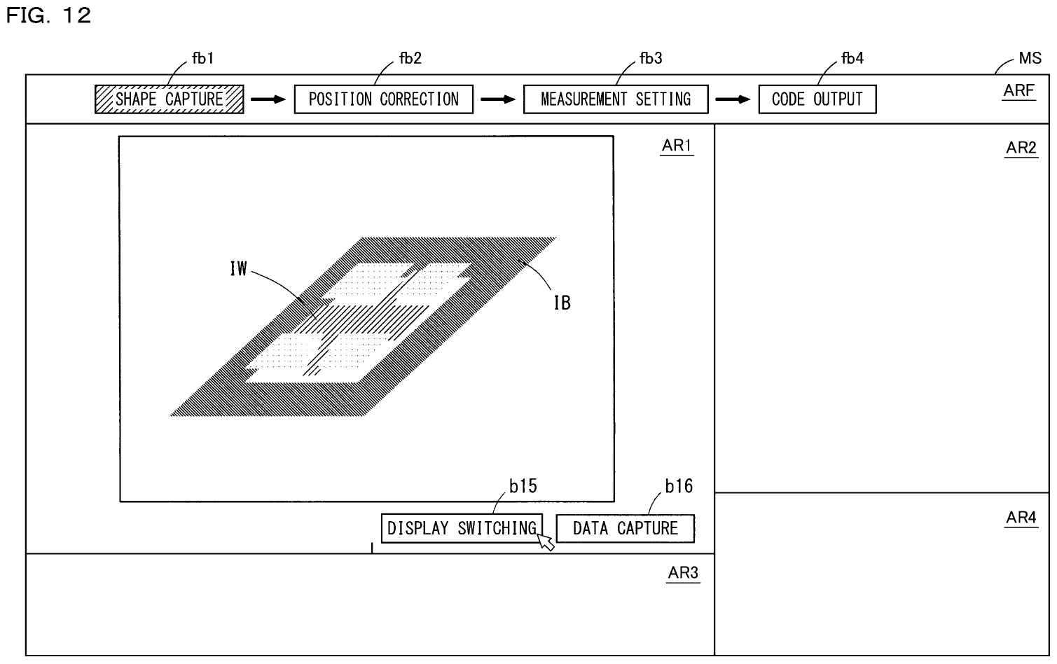

For example, the user operates the display switching button b15 in FIG. 11 with the operation device 14. In this case, as illustrated in FIG. 12, a three-dimensional height image is displayed in the first display area AR1 instead of the two-dimensional height image.

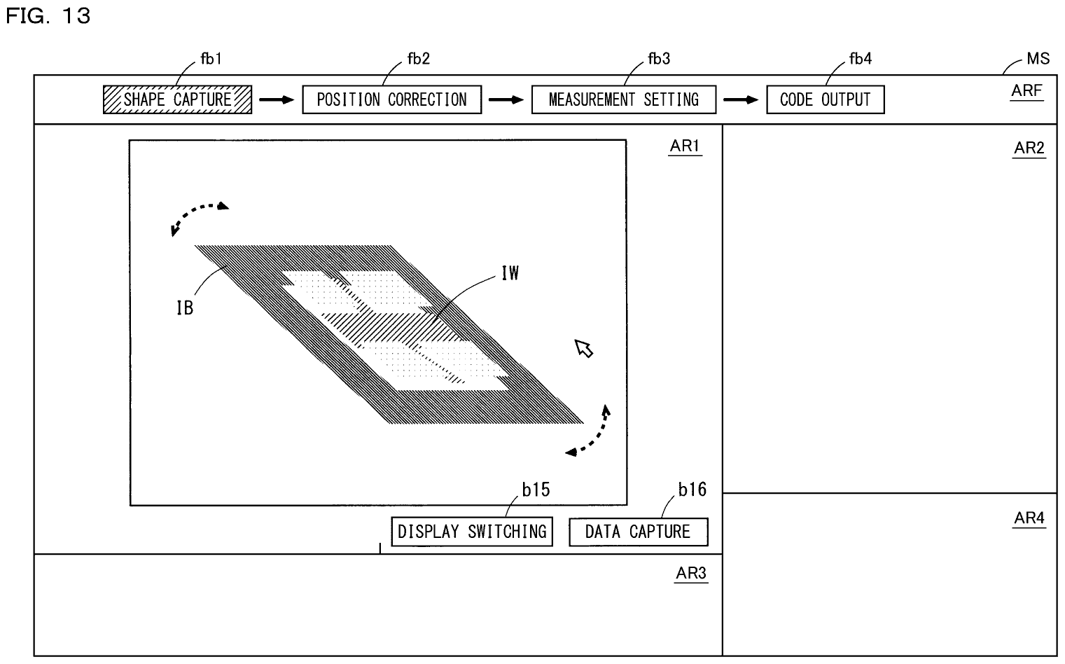

As described above, the three-dimensional height image is an image in which a plurality of images indicating the height of each part of the workpiece W viewed from a plurality of directions is switched and displayed. Therefore, for example, the user can switch the three-dimensional height image displayed in the first display area AR1 to an image corresponding to a desired viewing direction (viewpoint switching) as illustrated in FIG. 13 by performing a drag operation or the like.

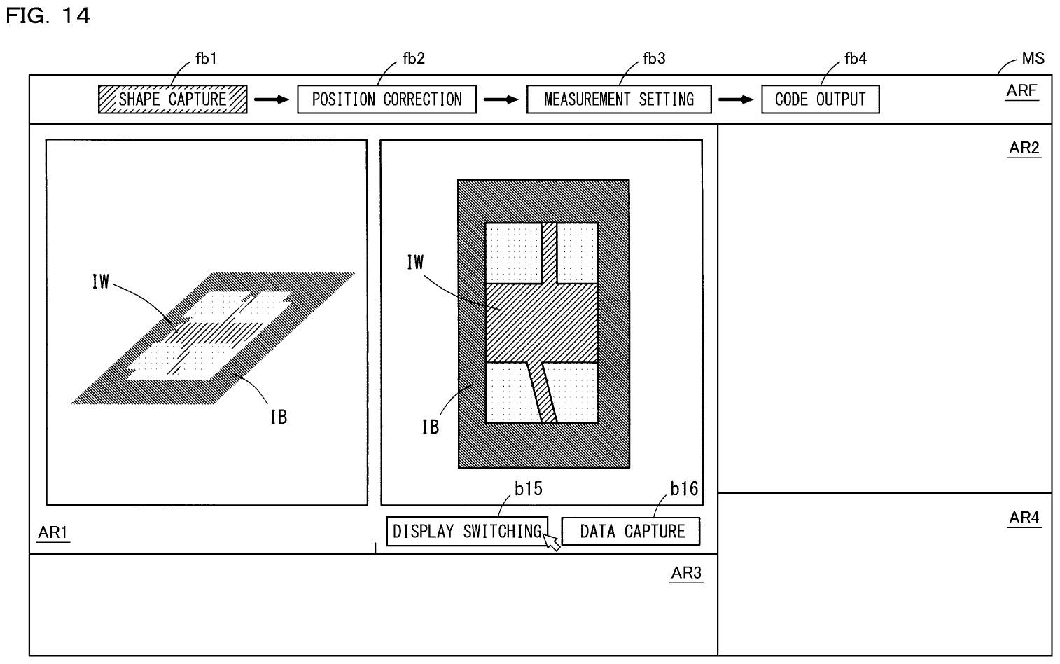

In the measurement screen MS of FIG. 12 or 13, the user further operates the display switching button b15 by the operation device 14. In this case, as illustrated in FIG. 14, the two-dimensional height image and the three-dimensional height image are displayed side by side in the first display area AR1. In the example of FIG. 14, the three-dimensional height image is located on the left, and the two-dimensional height image is located on the right.

In order to generate the text code, shape data (the above-described reference shape data) serving as a reference for determining what kind of measurement should be performed on which portion of the workpiece W is required. The data capture button b16 in FIGS. 11 to 15 is a button for temporarily holding a part of the shape data sequentially generated in the main measurement device 20. As a result, the user can stock shape data as a candidate for the reference shape data by operating the data capture button b16.

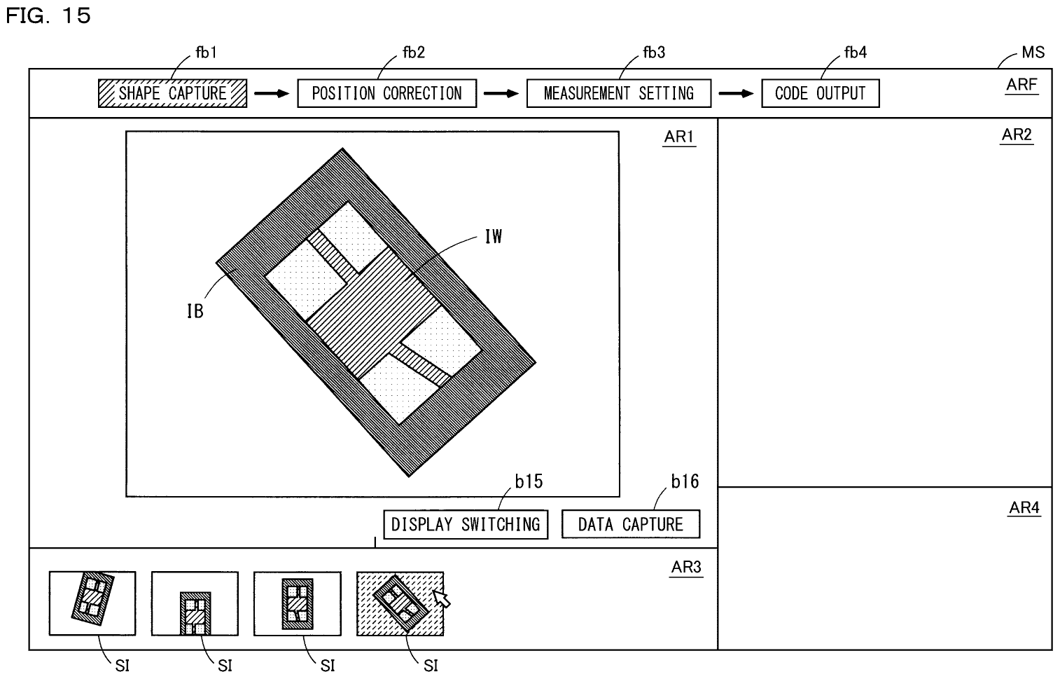

For example, the user operates the data capture button b16 with the operation device 14. In this case, the shape data corresponding to the image displayed in the first display area AR1 at the time of operating the data capture button b16 is temporarily held. Furthermore, as illustrated in FIG. 15, a thumbnail image SI based on the shape data is displayed in the third display area AR3. The thumbnail image SI may be, for example, a reduced image of any image displayed in the first display area AR1 when the data capture button b16 is operated.

In the example of FIG. 15, since the plurality of pieces of shape data is held, four thumbnail images SI respectively corresponding to the plurality of pieces of held shape data are arranged in the third display area AR3.

In the third display area AR3, the plurality of thumbnail images SI can be selected by the user. For example, the user clicks one thumbnail image SI among the plurality of thumbnail images SI. In this case, the one thumbnail image SI is displayed in a display mode (for example, highlight display) different from that of the other thumbnail images SI. Furthermore, in the first display area AR1, a height image corresponding to one thumbnail image SI is displayed.

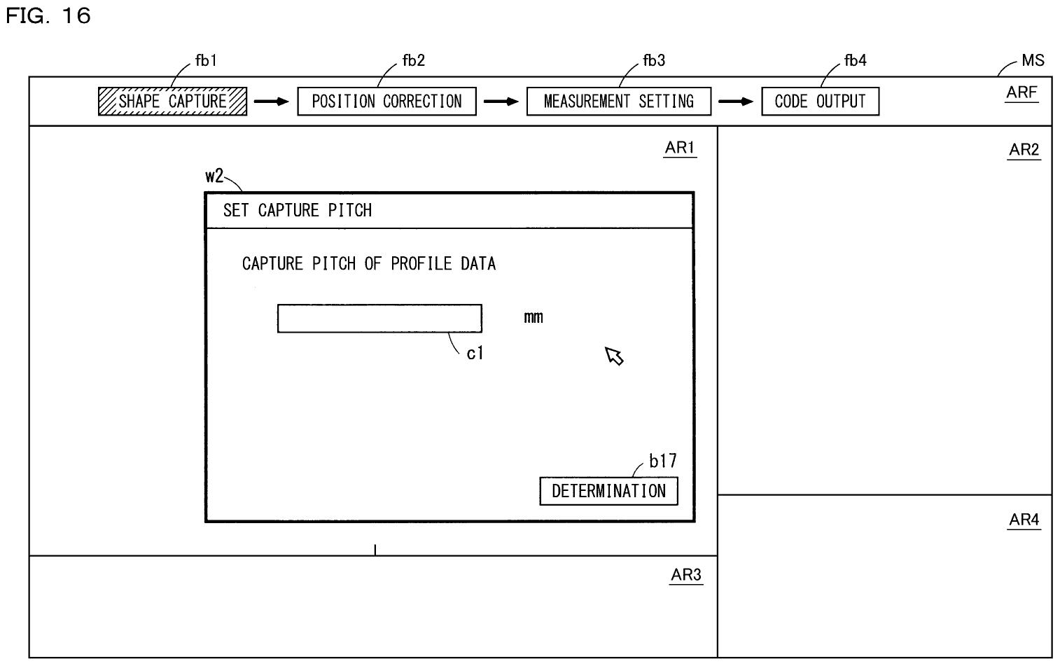

When the first phase button fb1 is operated, as illustrated in FIG. 16, following the setting window w1 illustrated in FIG. 10, a setting window w2 for setting a pitch (capture pitch) for capturing profile data may be displayed in a superimposed manner at the center of the measurement screen MS. In the setting window w2, an input field c1 and a determination button b17 for inputting the capture pitch are displayed. Therefore, the user inputs a desired capture pitch into the input field c1 by the operation device 14. Furthermore, the user operates the determination button b17. As a result, the capture pitch of the profile data is set. The data pre-processing unit 40 calculates a movement distance of the workpiece W based on an output signal (encoder signal) from an encoder provided in a conveyance device such as a belt conveyor, and generates shape data based on the calculated movement distance and a set capture pitch. The setting of the capture pitch is reflected on the pitch in the Y direction in the point sequence of the shape data to be captured.

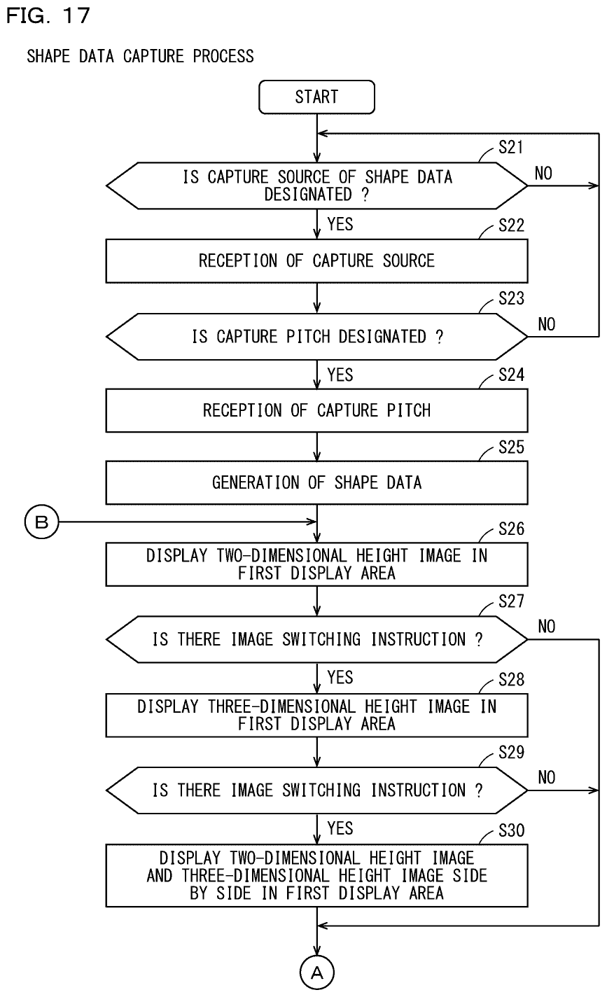

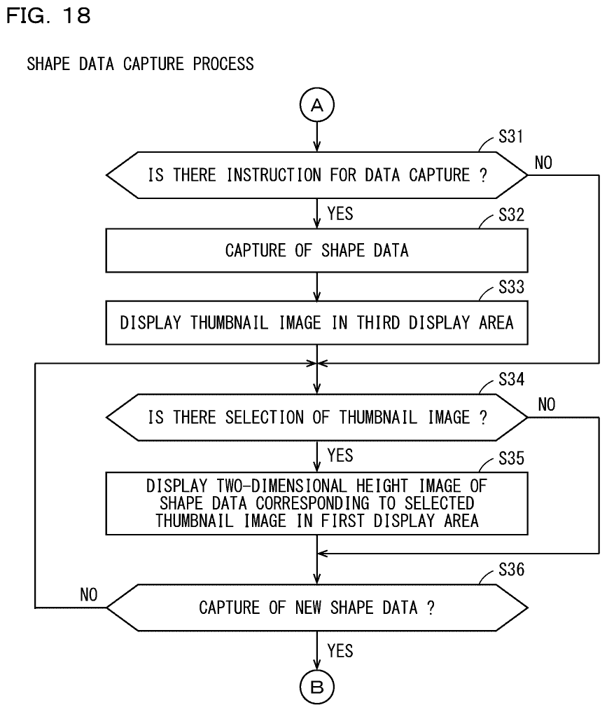

As described above, the first phase is an operation stage corresponding to the shape data capture process of FIG. 5. Therefore, the shape data capture process will be described in detail. FIGS. 17 and 18 are flowcharts illustrating an example of the shape data capture process. In the shape data capture process of the present example, basically, as conditions for generating the shape data, a capture source (a capture source of the shape data) for capturing the profile data of the workpiece W and a capture pitch of the profile data are set. Thereafter, shape data is generated based on a user's operation.

The shape data capture process is started, for example, in response to the user operating the first phase button fb1. Furthermore, the shape data capture process ends, for example, in response to the user operating the phase buttons fb2, fb3, and fb4 other than the first phase button fb1.

When the shape data capture process is started, that is, when the first phase button fb1 is operated, the reception unit 31 in FIG. 3 determines whether or not the capture source of the shape data is designated (step S21). In a case where the capture source of the shape data is not designated, the process of step S20 is repeated. On the other hand, in a case where the capture source of the shape data is designated, the reception unit 31 receives the designation of the capture source (step S22). The designation of the capture source of the shape data is performed on the basis of, for example, an operation of a user interface displayed on the measurement screen MS of FIGS. 9 and 10.

Next, the reception unit 31 determines whether or not the capture pitch of the profile data is designated (step S23). In a case where the capture pitch is not designated, the processing proceeds to step S21. On the other hand, in a case where the capture pitch is designated, the reception unit 31 receives the designation of the capture pitch (step S24). The designation of the capture pitch of the profile data is performed, for example, on the basis of an operation of a user interface displayed on the measurement screen MS of FIG. 16. Note that, in a case where the capture pitch of the profile data is determined in advance or is set in advance separately from the shape data capture process, the processing of steps S23 and S24 may not be performed.

By the processing of steps S21 to S24 described above, shape data based on the output from the measurement head 11 can be generated. Next, the data pre-processing unit 40 in FIG. 3 sequentially generates shape data on the basis of a plurality of pieces of profile data obtained from the designated capture source via the acquisition unit 21 (step S25). The generation processing of the shape data is continuously executed thereafter. Furthermore, the screen generation unit 32 in FIG. 3 displays the two-dimensional height image in the first display area AR1 of the measurement screen MS based on the sequentially generated shape data (step S26).

Next, the reception unit 31 determines whether or not there is an image switching instruction (step S27). This determination is made based on, for example, whether or not the display switching button b15 in FIG. 11 is operated. In a case where there is no image switching instruction, the process proceeds to step S31 described later. On the other hand, in a case where there is an instruction to switch the image, the screen generation unit 32 displays the three-dimensional height image instead of the two-dimensional height image in the first display area AR1 of the measurement screen MS (step S28).

Next, the reception unit 31 determines whether or not there is an image switching instruction (step S29). This determination is made based on, for example, whether or not the display switching button b15 in FIG. 12 or 13 is operated. In a case where there is no image switching instruction, the process proceeds to step S31 described later. On the other hand, in a case where there is an image switching instruction, the screen generation unit 32 displays the two-dimensional height image and the three-dimensional height image side by side simultaneously in the first display area AR1 of the measurement screen MS (step S30).

Next, the reception unit 31 determines whether or not there is an instruction to capture shape data (step S31). This determination is made based on, for example, whether or not the data capture button b16 in FIGS. 11 to 15 has been operated. In a case where there is no instruction to capture the shape data, the process proceeds to step S34 described later. On the other hand, in a case where there is an instruction to capture the shape data, the data pre-processing unit 40 captures the shape data generated at the timing of the instruction (step S32).

Next, the screen generation unit 32 displays the thumbnail image SI in the third display area AR3 of the measurement screen MS based on the shape data captured in the immediately preceding step S32 (step S33).

Next, the reception unit 31 determines whether or not there is selection of the thumbnail image SI displayed in the third display area AR3 (step S34). In a case where the thumbnail image SI is not selected, the process proceeds to step S36 described later. On the other hand, in a case where the thumbnail image SI is selected, the screen generation unit 32 displays the two-dimensional height image of the shape data corresponding to the selected thumbnail image SI in the first display area AR1 (step S35). Here, the processing of step S35 includes the processing of steps S26 to S30 described above. Consequently, the image displayed in first display area AR1 can be switched and displayed based on the switching instruction by the user.

Next, the reception unit 31 determines whether or not there is an instruction to capture new shape data (step S36). This determination is made based on the operation of the operation device 14 by the user. In a case where there is an instruction to capture new shape data, the process proceeds to step S26. In a case where there is no instruction to capture new shape data, the processing proceeds to step S34.

### <4> Second Phase

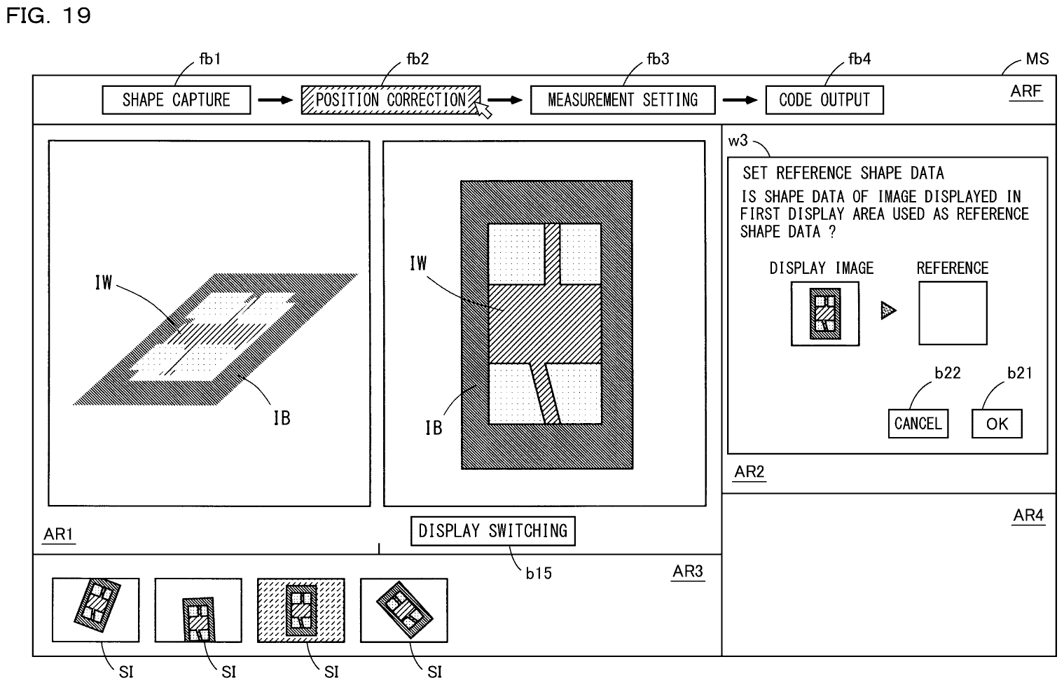

When the second phase button fb2 is operated on the measurement screen MS in the first phase, the shape data capture process is ended, and the correction setting process is started. FIGS. 19 to 22 are diagrams illustrating transition examples of a measurement screen MS displayed on the display device 13 in the second phase.

As illustrated in FIG. 19, when the second phase button fb2 is operated, the display mode of the first phase button fb1 returns to the initial display mode. On the other hand, the display mode of the second phase button fb2 changes so as to be distinguishable from other phase buttons (for example, highlight display). Furthermore, in a case where the reference shape data is not set at the time of operating the second phase button fb2, a setting window w3 prompting setting of the reference shape data is superimposed and displayed on the second display area AR2.

In the setting window w3, a message to the user for setting the reference shape data is displayed. In the setting window w3 of FIG. 19, a message “IS SHAPE DATA OF IMAGE DISPLAYED IN FIRST DISPLAY AREA USED AS REFERENCE SHAPE DATA?” is displayed. Furthermore, an OK button b21 and a cancel button b22 are displayed in the setting window w3. The OK button b21 is a button for setting shape data corresponding to the height image displayed in the first display area AR1 as reference shape data. The cancel button b22 is a button for canceling the setting operation of the reference shape data.

As a result, the user can visually recognize the height image displayed in the first display area AR1 while selecting the plurality of thumbnail images SI, and can set desired shape data as the reference shape data by operating the OK button b21. The set reference shape data is held in the reference data holding unit 33 of FIG. 3.

Note that, in the display state of FIG. 19, the operation allowed to the user is limited to the operation of selecting one of the plurality of thumbnail images SI displayed in the third display area AR3, the operation of the OK button b21, and the operation of the cancel button b22. This prevents erroneous operation by the user.

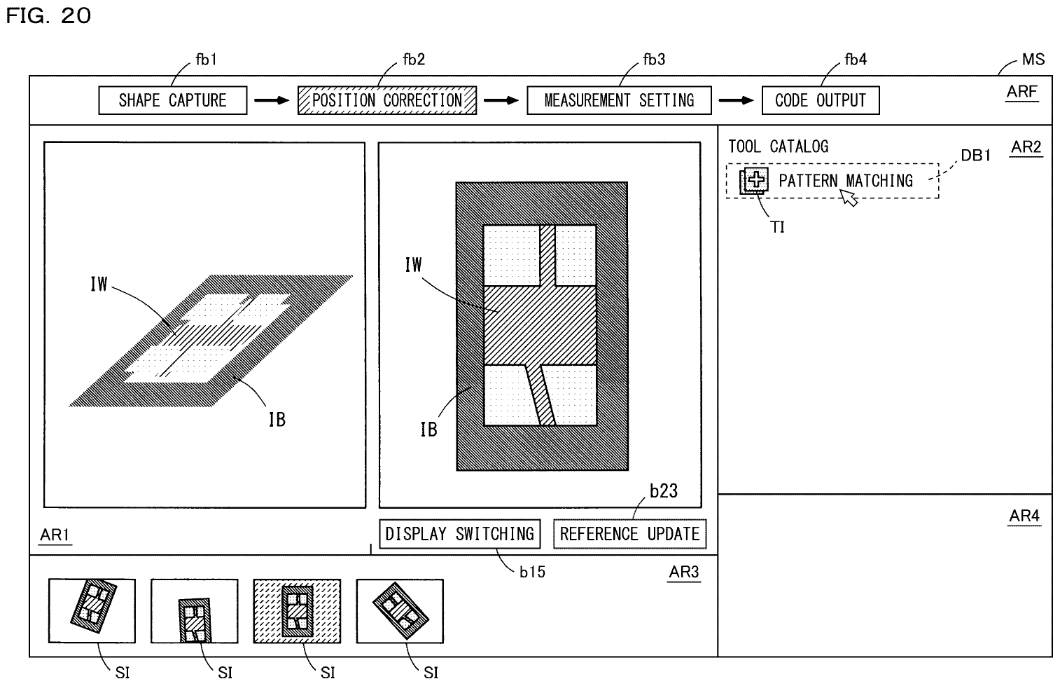

Furthermore, in a case where the reference shape data has already been set at the time of operating the second phase button fb2, the display of the setting window w3 is omitted. Therefore, a measurement screen MS of FIG. 20 to be described later is displayed on the display device 13.

In the following description, a function (function to be set) to be realized using any of a plurality of processing programs included in the library is referred to as a tool. When the setting of the reference shape data is completed, as illustrated in FIG. 20, a height image (in this example, a two-dimensional height image and a three-dimensional height image) of the reference shape data set in the first display area AR1 is displayed. Furthermore, a reference update button b23 for resetting the reference shape data is displayed in the first display area AR1 together with the display switching button b15. When the user operates the reference update button b23, a setting window w3 in FIG. 19 is superimposed and displayed on the measurement screen MS. Accordingly, the user can set the reference shape data again.

Moreover, in the measurement screen MS of FIG. 20, a tool catalog is displayed on the second display area AR2. The tool catalog displays (lists) types of tools that can be set at the present time. In the tool catalog of this example, a display block DB1 including a tool icon TI indicating the type of tool that can be set at the present time and a character string indicating the type is displayed in a selectable manner.

In the tool catalog of FIG. 20, only the display block DB1 corresponding to correction based on pattern matching is displayed. Accordingly, the user can designate the setting of the correction method based on the pattern matching by operating the display block DB1.

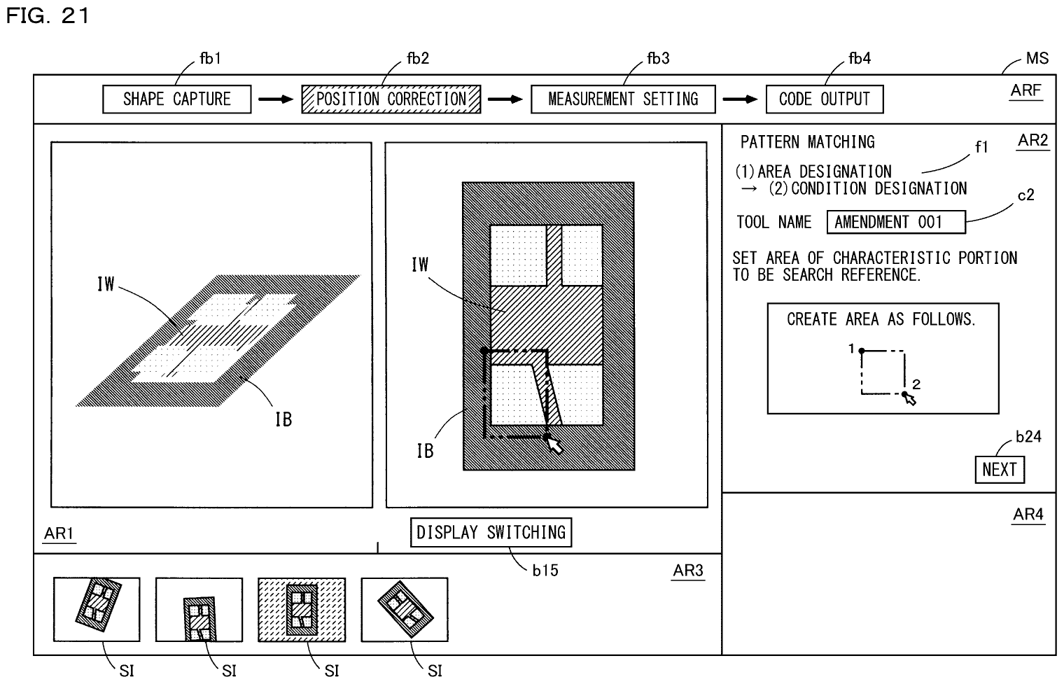

When the display block DB1 of FIG. 20 is operated, as illustrated in FIG. 21, a flow f1 of the setting work corresponding to the display block DB1 is displayed in the second display area AR2. Furthermore, an input field c2 of a tool name for enabling a tool that is a setting target at the present time to be identified from other tools is displayed.

Moreover, in the present example, a message, an illustration, and the like for setting an area of a characteristic portion to be a search reference at the time of performing correction processing of position correction by pattern matching are displayed. Moreover, a next button b24 is displayed.

Accordingly, the user inputs the tool name in the input field c2. Furthermore, the user designates an area to be a search reference on the two-dimensional height image of the first display area AR1 by a drag operation or the like according to the message and the illustration displayed in the second display area AR2. Then, the next button b24 is operated. In the example of FIG. 21, as indicated by a thick two-dot chain line, about a half area of the first portion 90a (FIG. 7) of the workpiece W is set as an area to be a search reference. Note that the height image of the workpiece W to be operated at the time of setting the tool is preferably a two-dimensional height image in consideration of ease of designation.

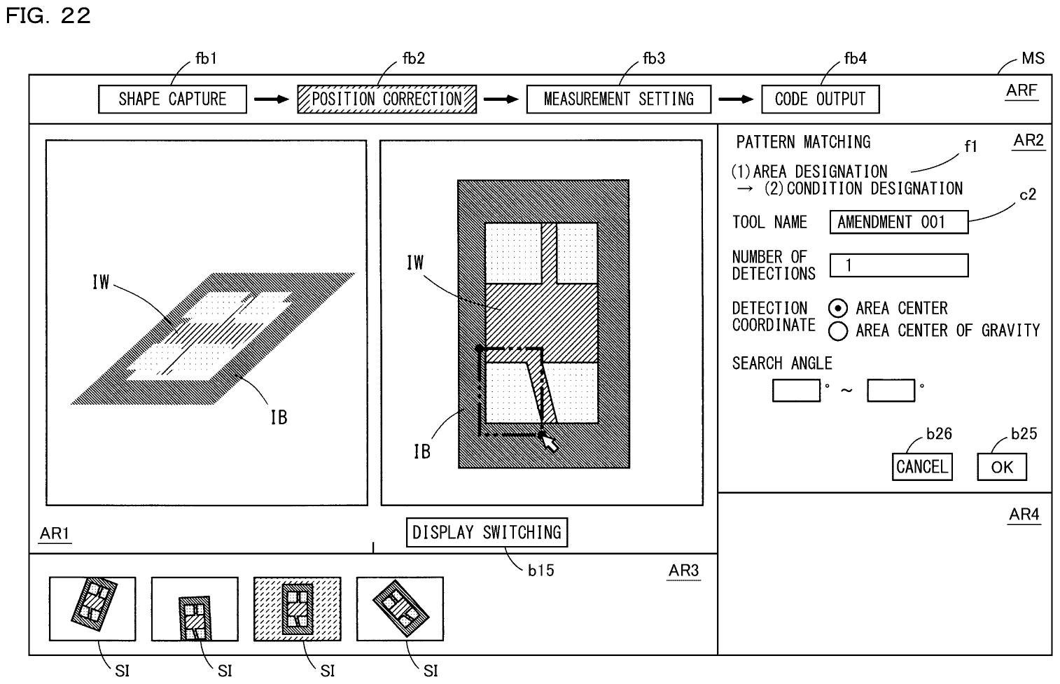

By operating the next button b24 in FIG. 21, various input fields and selection units for further setting conditions for the correction method are displayed in the second display area AR2 as illustrated in FIG. 22. Furthermore, an OK button b25 and a cancel button b26 are displayed.

The OK button b25 is a button for setting the content of the correction method or the like designated based on the content displayed in the second display area AR2 in FIGS. 21 and 22 as the correction information. The cancel button b26 is a button for canceling the setting of the correction method based on pattern matching. As a result, the user can set the correction information (set a tool for correcting the position of the shape data) according to a message or the like displayed in the second display area AR2.

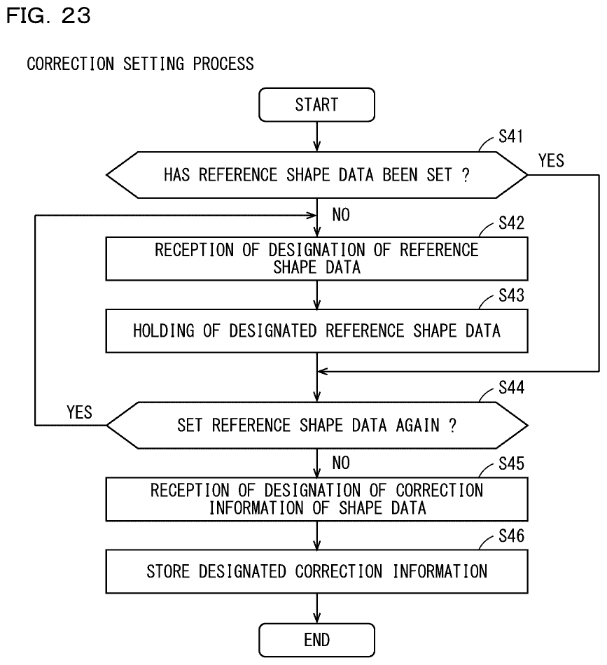

As described above, the second phase is an operation stage corresponding to the correction setting process of FIG. 5. Therefore, details of the correction setting process will be described. FIG. 23 is a flowchart illustrating an example of the correction setting process.

The correction setting process is started, for example, in response to the user operating the second phase button fb2. When the correction setting process is started, the reference data holding unit 33 in FIG. 3 determines whether or not the reference shape data has been set (step S41). This determination is made based on whether or not the reference shape data is held in the reference data holding unit 33.

In a case where the reference shape data has been set, the process proceeds to step S44 described later. On the other hand, in a case where the reference shape data has not been set, the reception unit 31 in FIG. 3 receives designation of the reference shape data (step S42). The designation of the reference shape data is performed on the basis of, for example, an operation of a user interface displayed on the measurement screen MS of FIG. 19. Thereafter, the reference data holding unit 33 holds the designated reference shape data (step S43).

Next, the reception unit 31 determines whether or not an instruction to set the reference shape data again has been received (step S44). This determination is made based on, for example, whether or not the reference update button b23 in FIG. 20 has been operated. In a case where an instruction to set the reference shape data again has been received, the process proceeds to step S42. On the other hand, in a case where the instruction to set the reference shape data again is not received, the reception unit 31 receives the designation of the correction information of the shape data (step S45). Furthermore, the measurement setting generation unit 34 in FIG. 3 stores the received correction information (step S46). Thereafter, in response to the user operating the phase buttons fb1, fb3, and fb4 other than the second phase button fb2, the correction setting process ends.

Note that, as described above, the order of the second phase and the third phase may be interchanged or repeated. Therefore, in a case where the second phase is performed after the third phase, the execution order of the plurality of tools is adjusted such that the execution order of the tools set in the second phase is preferentially executed over the various tools set in the third phase.

### <5> Third Phase

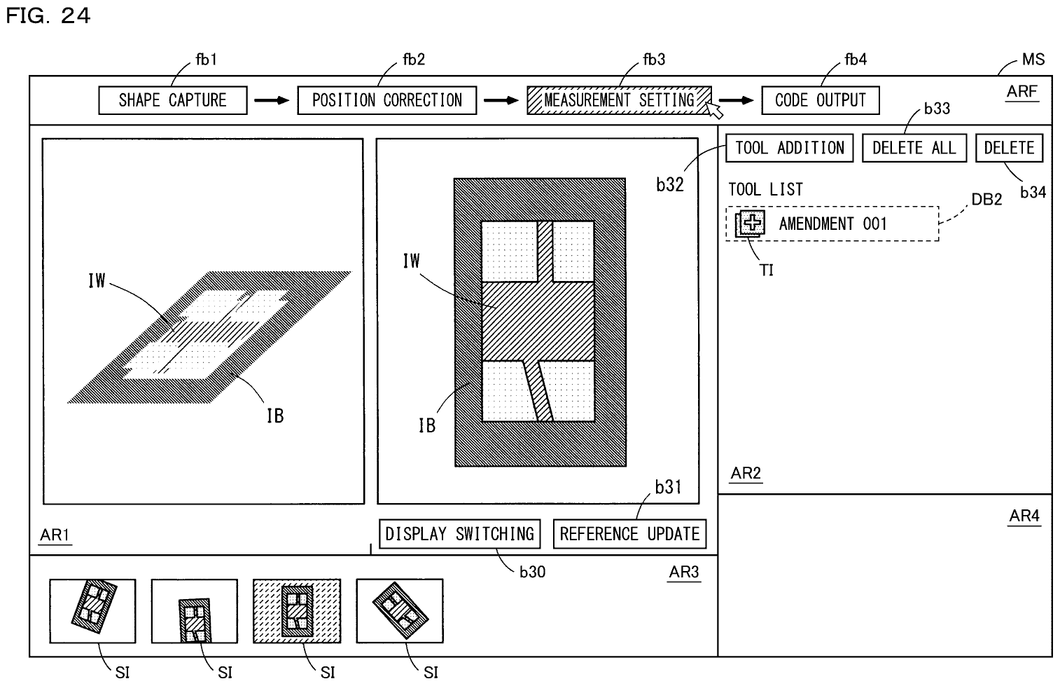

When the third phase button fb3 is operated on the measurement screen MS in the second phase, the correction setting process is ended, and the measurement condition setting process is started. FIGS. 24 to 38 are diagrams illustrating a transition example of the measurement screen MS displayed on the display device 13 in the third phase.

When the third phase button fb3 is operated, the display mode of the second phase button fb2 returns to the initial display mode. On the other hand, the display mode of the third phase button fb3 changes so as to be distinguishable from other phase buttons (for example, highlight display). Here, in a case where the reference shape data is not set at the time of operating the third phase button fb3, the setting window w3 of FIG. 19 is superimposed and displayed on the second display area AR2. Accordingly, the user needs to set the reference shape data by operating the setting window w3 or the like.

In a case where the reference shape data is set in advance, as illustrated in FIG. 24, a height image (in this example, a two-dimensional height image and a three-dimensional height image) of the reference shape data set in the first display area AR1 is displayed. Furthermore, a display switching button b30 for switching the image of the workpiece W displayed in the first display area AR1 and a reference update button b31 for resetting the reference shape data are displayed in the first display area AR1. Note that the display switching button b30 may exist as one of window menus at the upper part of the measurement screen MS. Furthermore, the reference update button b31 may exist as one of the function menus at the lower part of the measurement screen MS. As the function menu, in addition to the reference update button b31, there may be a button for outputting a measurement result in a spreadsheet format, a button for resetting a setting as to whether or not to synthesize the settings of the data capture source (a setting that can be set only for the first time), and the like.

When the user operates the display switching button b30, the height image displayed in the first display area AR1 is switched as described in the examples of FIGS. 11 to 14. When the user operates the reference update button b31, the setting window w3 in FIG. 19 is superimposed and displayed on the measurement screen MS. Accordingly, the user can set the reference shape data again.

Moreover, in the measurement screen MS of FIG. 24, a tool addition button b32, a delete all button b33, a delete button b34, and a tool list are displayed on the second display area AR2. The tool list displays (lists) tools that have been set at the present time. In the tool list of FIG. 24, a display block DB2 indicating the tool (the tool for correcting the position of the shape data) set in the second phase of FIGS. 19 to 22 is selectably displayed. The display block DB2 includes a tool icon TI corresponding to the set tool and a tool name. As a result, the user can easily grasp the tool set at the present time.

The tool addition button b32 is a button for setting a new tool related to the measurement of the workpiece W. The delete all button b33 is a button for canceling the settings of all the tools displayed in the tool list.

As described above, the display block DB2 displayed in the tool list can be selected by the user. The delete button b34 is a button for canceling the setting of the tool of the display block DB2 selected by the user.

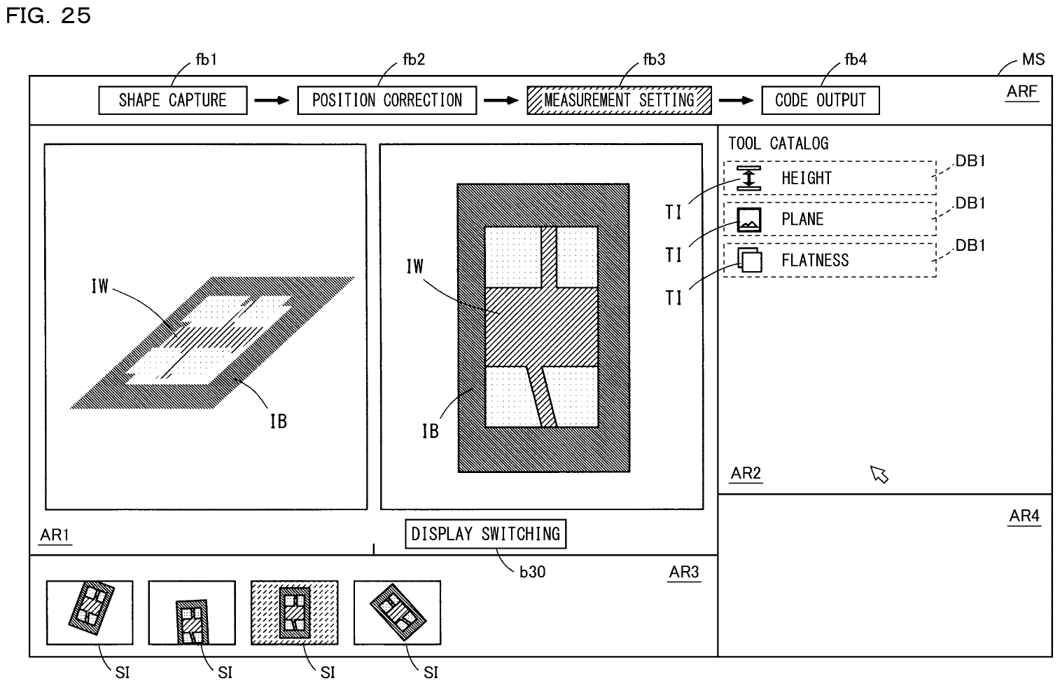

The user operates the tool addition button b32 to perform desired measurement on the workpiece W. In this case, as illustrated in FIG. 25, the tool catalog is displayed on the second display area AR2. In the tool catalog of FIG. 25, a display block DB1 corresponding to the measurement of the height, a display block DB1 corresponding to the specification of the plane, and a display block DB1 corresponding to the measurement of the flatness are selectably displayed.

The user selects a desired type from a plurality of types of tools displayed in the tool catalog. Accordingly, images for guiding appropriate operations for setting the selected type of tool are sequentially displayed in the second display area AR2.

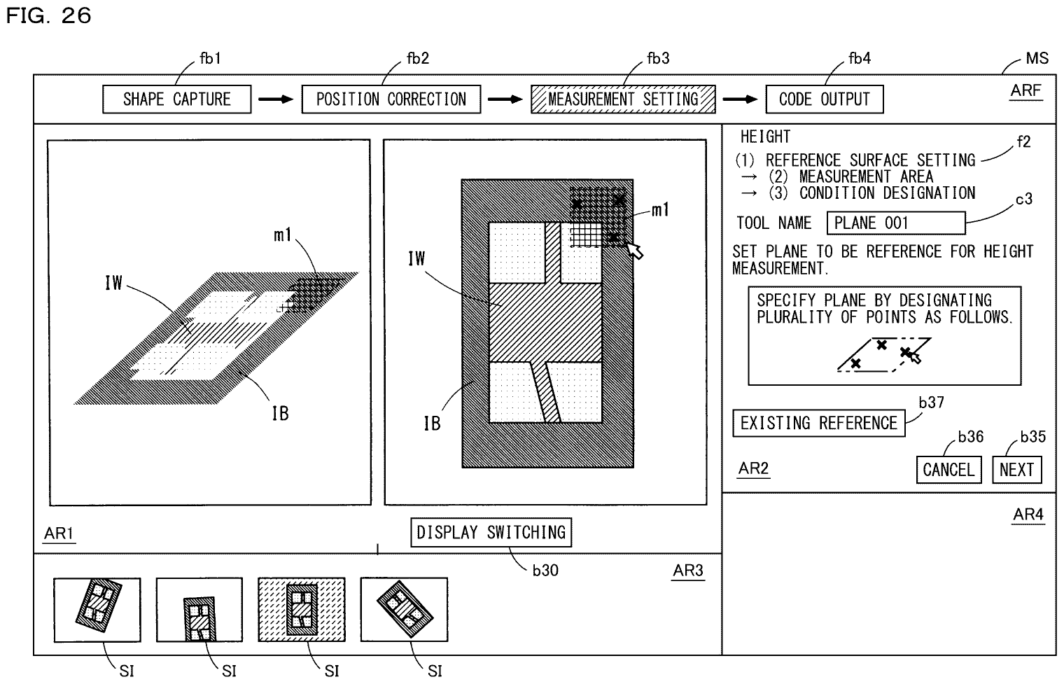

For example, in a case where the user wants to set a tool for measuring the height, the user operates the display block DB1 corresponding to the measurement of the height in FIG. 25. When the display block DB1 corresponding to the measurement of the height in the tool catalog of FIG. 25 is operated, a flow f2 of the setting work of the measurement of the height is displayed in the second display area AR2 as illustrated in FIG. 26. Here, in order to measure the height of the workpiece W, it is necessary to specify a surface (reference surface) serving as a reference of the height and then specify a portion where the height is to be measured. That is, first, it is necessary to set a tool for specifying a plane as a reference surface.

Therefore, in the second display area AR2 of FIG. 26, a message, an illustration, and the like for allowing the user to designate the plane are displayed, and an input field c3 of a tool name of a tool for specifying the plane is displayed.

Accordingly, the user inputs the tool name in the input field c3. Furthermore, the user performs a setting operation necessary for the tool for specifying the plane according to the message and the illustration displayed in the second display area AR2. For example, the user designates three points for specifying a plane on the two-dimensional height image. As a result, an index m1 representing the surface specified by the designated three points is displayed to be superimposed on the two-dimensional height image and the three-dimensional height image. In the example of FIG. 26, as indicated by a grid-like pattern in the first display area AR1, a plane serving as a reference is set on the upper surface of the table member on which the workpiece W is placed. Note that the height image of the workpiece W to be operated at the time of setting the tool is preferably a two-dimensional height image in consideration of ease of designation.

In addition to the above buttons, a next button b35, a cancel button b36, and an existing reference button b37 are displayed in the second display area AR2 of FIG. 26. The next button b35 is a button for proceeding with the subsequent setting work. The cancel button b36 is a button for canceling the setting of the height measurement.

The existing reference button b37 is a button for reading a tool that has been set at the present time. For example, in a case where a tool for specifying a plane has been set in the past, the tool is operated to call the tool. Therefore, the user can set the reference surface for height measurement using the past tool by operating the existing reference button b37. Note that, at the time of setting the tool, it may be possible to select whether to refer to an existing reference surface, a new reference surface, or no reference surface.

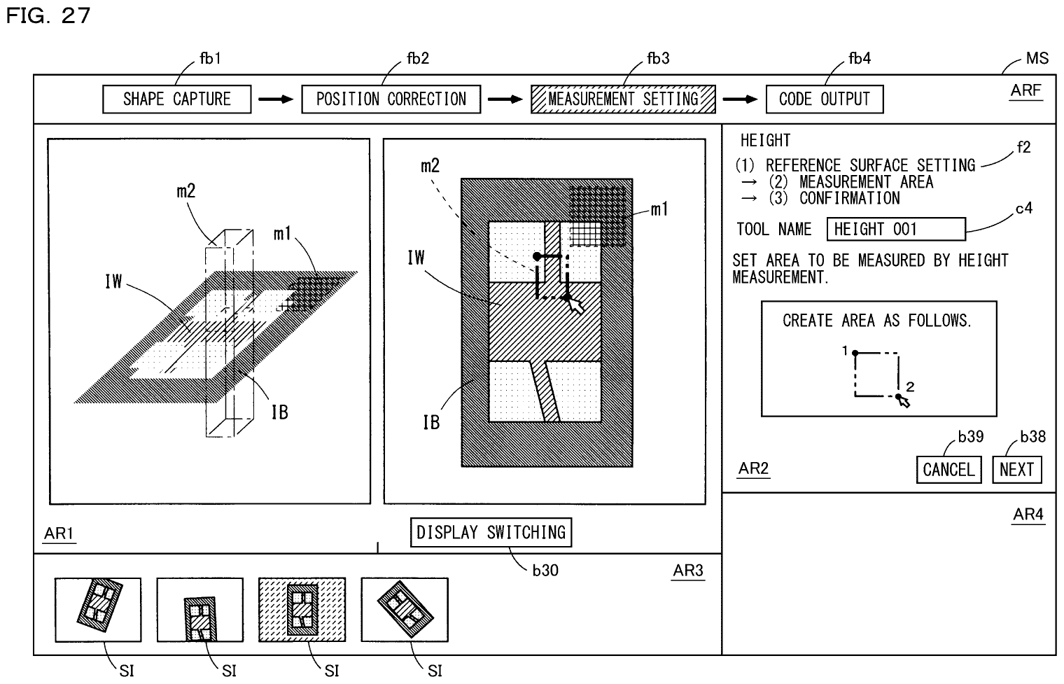

When the next button b35 in FIG. 26 is operated, the flow f2 of the setting work is continuously displayed in the second display area AR2 as illustrated in FIG. 27. Moreover, a message, an illustration, and the like for allowing the user to designate an area (measurement area) where the height is to be measured are displayed, and an input field c4 of a tool name of a tool for measuring the height is displayed.

Accordingly, the user inputs the tool name in the input field c4. Furthermore, in accordance with the message and the illustration displayed in the second display area AR2, the user performs setting for specifying the height measurement area as setting necessary for the tool for measuring the height. For example, the user designates a desired area by performing a drag operation or the like on the two-dimensional height image. As a result, an index m2 representing the designated area is displayed superimposed on the two-dimensional height image and the three-dimensional height image. In the example of FIG. 27, as indicated by a thick two-dot chain line, a partial area including the second upper surface portion 93 (FIG. 7) and the third upper surface portion 94 (FIG. 7) of the workpiece W is set as a height measurement area.

In addition to the above buttons, a next button b38 and a cancel button b39 are displayed in the second display area AR2 of FIG. 27. The next button b38 is a button for proceeding with the subsequent setting work. The cancel button b39 is a button for canceling the setting of the height measurement.

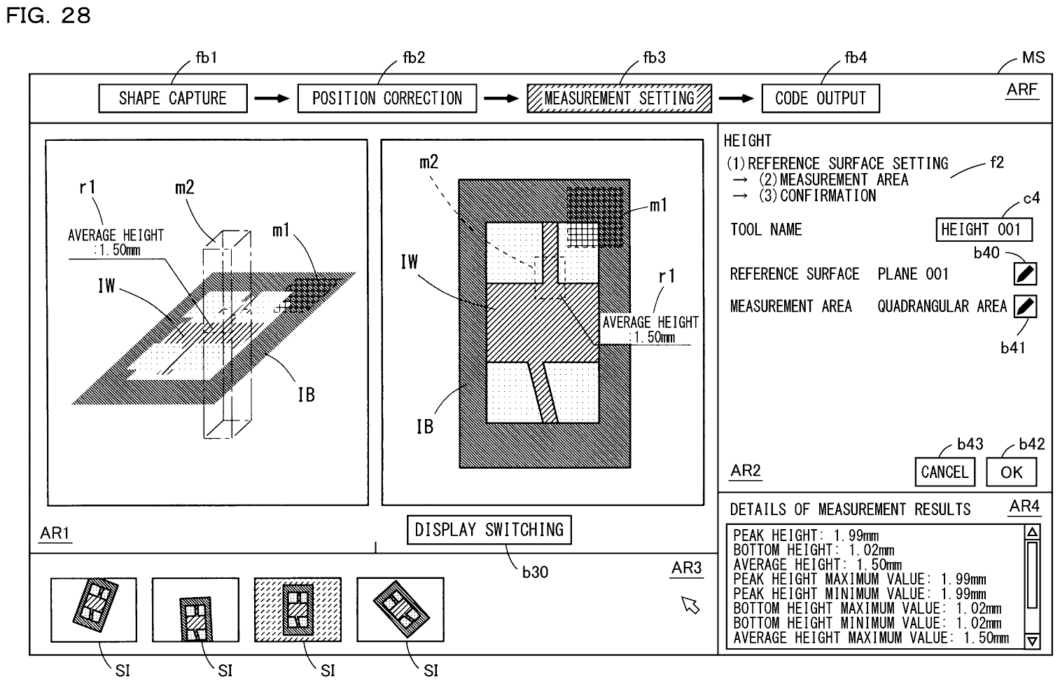

When the next button b38 in FIG. 27 is operated after the measurement area of the height is designated, the flow f2 of the setting work is continuously displayed in the second display area AR2 as illustrated in FIG. 28. Furthermore, the input field c4 of the tool name of a tool for measuring the height is displayed, and contents set up to the present time are displayed. In this example, it is indicated that a tool “plane 001” for specifying a plane is set as a reference plane of the height, and a rectangular area is set as a measurement area of the height. Furthermore, edit buttons b40 and b41 are displayed in the vicinity of these explanatory sentences, respectively.

The edit buttons b40 and b41 are buttons for editing the setting contents for specifying the plane and the setting contents of the height measurement area. Therefore, the user can return the display state of FIG. 28 to the display state of FIG. 26 by operating the edit button b40. Furthermore, the user can return the display state of FIG. 28 to the display state of FIG. 27 by operating the edit button b41.

At the timing when the measurement screen MS of FIG. 28 is displayed, one set of contents (the reference surface and the measurement area of the height) necessary for the tool for measuring the height is set. Accordingly, in the measurement screen MS of FIG. 28, all the measurement results calculated based on the contents set up to the present time are displayed in the fourth display area AR4. According to the setting of this example, “peak height”, “bottom height”, “average height”, “peak height maximum value”, “peak height minimum value”, “bottom height maximum value”, “bottom height minimum value”, “average height maximum value”, and “average height minimum value” are calculated as measurement results.

The “peak height” is the maximum value of the height from the reference surface in the measurement area of the height. The “bottom height” is the minimum value of the height from the reference surface in the measurement area of the height. The “average height” is an average value of the height from the reference surface in the measurement area of the height.

The “peak height maximum value” is a maximum value of a plurality of peak heights of a plurality of measurement areas in a case where a plurality of measurement areas of height is set. Furthermore, the “peak height minimum value” is a minimum value of a plurality of peak heights of a plurality of measurement areas in a case where a plurality of measurement areas of height is set. Therefore, in a case where there is only one measurement area of the set height, the “peak height maximum value” and the “peak height minimum value” are equal to the “peak height”.

The “bottom height maximum value” is a maximum value of a plurality of bottom heights of a plurality of measurement areas in a case where a plurality of measurement areas of heights is set. Furthermore, the “minimum bottom height value” is a minimum value of a plurality of bottom heights of a plurality of measurement areas in a case where a plurality of measurement areas of heights is set. Therefore, in a case where there is only one measurement area of the set height, the “bottom height maximum value” and the “bottom height minimum value” are equal to the “bottom height”.

The “average height maximum value” is a maximum value of a plurality of average heights of a plurality of measurement areas in a case where a plurality of measurement areas of height is set. Furthermore, the “average height minimum value” is a minimum value of a plurality of average heights of a plurality of measurement areas in a case where a plurality of measurement areas of height is set. Therefore, in a case where there is only one measurement area of the set height, the “average height maximum value” and the “average height minimum value” are equal to the “average height”.

Moreover, in the measurement screen MS of FIG. 28, an index r1 indicating the measurement result of the “average height” is superimposed and displayed on the two-dimensional height image and the three-dimensional height image as a predefined representative measurement result in the first display area AR1. Furthermore, a lead line is displayed between each index r1 and the index m2 representing the set measurement area.

As a result, the user can visually recognize the measurement results illustrated in the first display area AR1 and the fourth display area AR4 of FIG. 28 to easily grasp whether or not the desired measurement is performed by the tool set up to the present point of time.

Note that, in the first display area AR1, an index indicating the measurement result of the “peak height” or an index indicating the measurement result of the “bottom height” may be displayed as a predefined representative measurement result. Furthermore, a plurality of measurement results may be displayed. For example, all the measurement results displayed in the fourth display area AR4 may be displayed.

In the measurement screen MS of FIG. 28, an OK button b42 and a cancel button b43 are further displayed in the second display area AR2. The OK button b42 is a button for confirming setting of the current tool. The cancel button b43 is a button for canceling setting of the current tool.

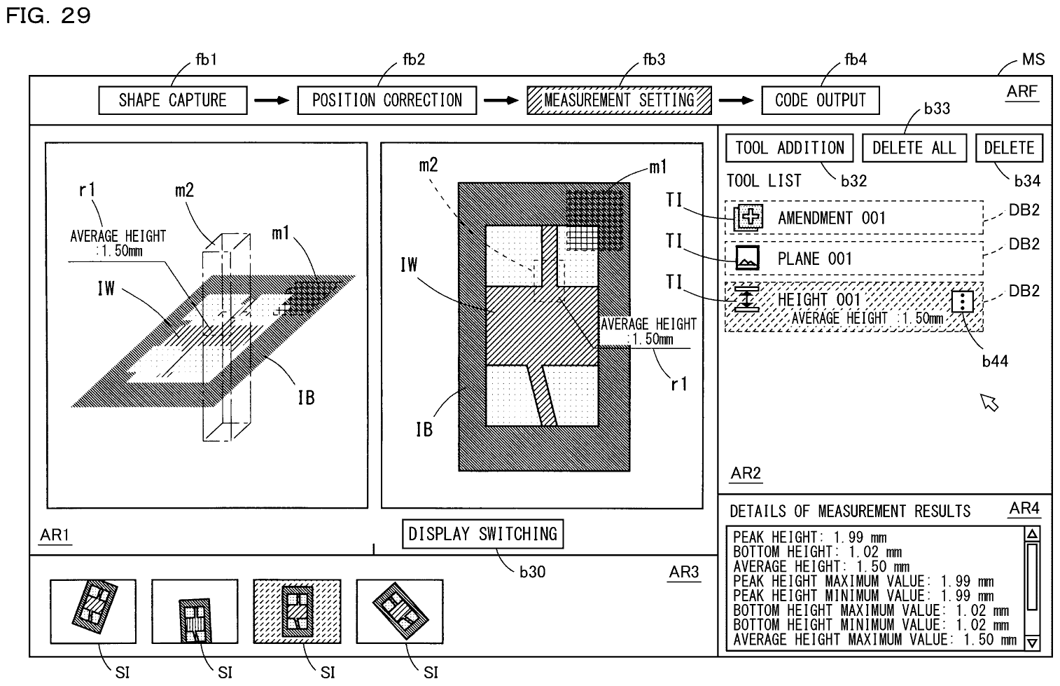

When the OK button b42 in FIG. 28 is operated, the display content of the second display area AR2 is switched as illustrated in FIG. 29. Specifically, as in the example of FIG. 24, a tool addition button b32, a delete all button b33, a delete button b34, and a tool list are displayed in the second display area AR2.

In the tool list of FIG. 29, the display block DB2 of the tool displayed as set is increased as compared with the tool list of FIG. 24. The tool list of FIG. 29 includes a display block DB2 indicating the tools set in the third phase of FIGS. 24 to 28. As a result, the user can easily grasp the tool set at the present time.

As described above, each display block DB2 of the tool list can be selected by the user. When any one of the display blocks DB2 is selected while the plurality of display blocks DB2 are displayed in the tool list, the display mode of the selected display block DB2 changes so as to be distinguishable from other display blocks DB2 (for example, highlight display).

Furthermore, in the first display area AR1, the index related to the selected display block DB2 is superimposed and displayed. In the example of FIG. 29, when the display block DB2 corresponding to the tool for measuring the height is selected, an index m1 indicating a surface serving as a reference of the height and an index m2 indicating a measurement area of the height are displayed. Moreover, an index r1 indicating a measurement result actually measured at the time of setting the tool (tool for measuring height) of the selected display block DB2 is displayed.

Here, in the display block DB2 corresponding to a tool for measuring a physical quantity such as height and flatness, a predefined representative measurement result is displayed together with a tool name. In the example of FIG. 29, the measurement result of the “average height” is displayed on the display block DB2 corresponding to the tool for measuring the height.

Furthermore, a result display setting button b44 for setting an item of a measurement result to be displayed in the first display area AR1 and the display block DB2 is displayed in the display block DB2 corresponding to a tool for measuring a physical quantity.

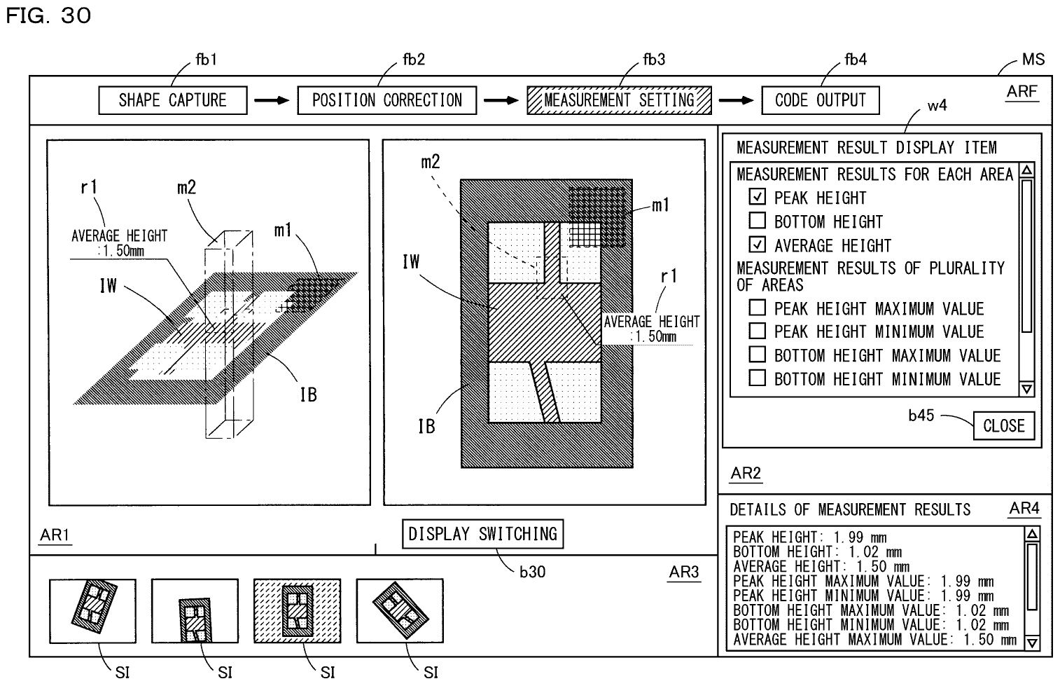

When the result display setting button b44 is operated, a result display setting window w4 is superimposed and displayed on the second display area AR2 as illustrated in FIG. 30. In the result display setting window w4, all the types of measurement results calculated on the basis of the target tool are selectively displayed by, for example, a check box. Furthermore, a close button b45 is displayed in the result display setting window w4.

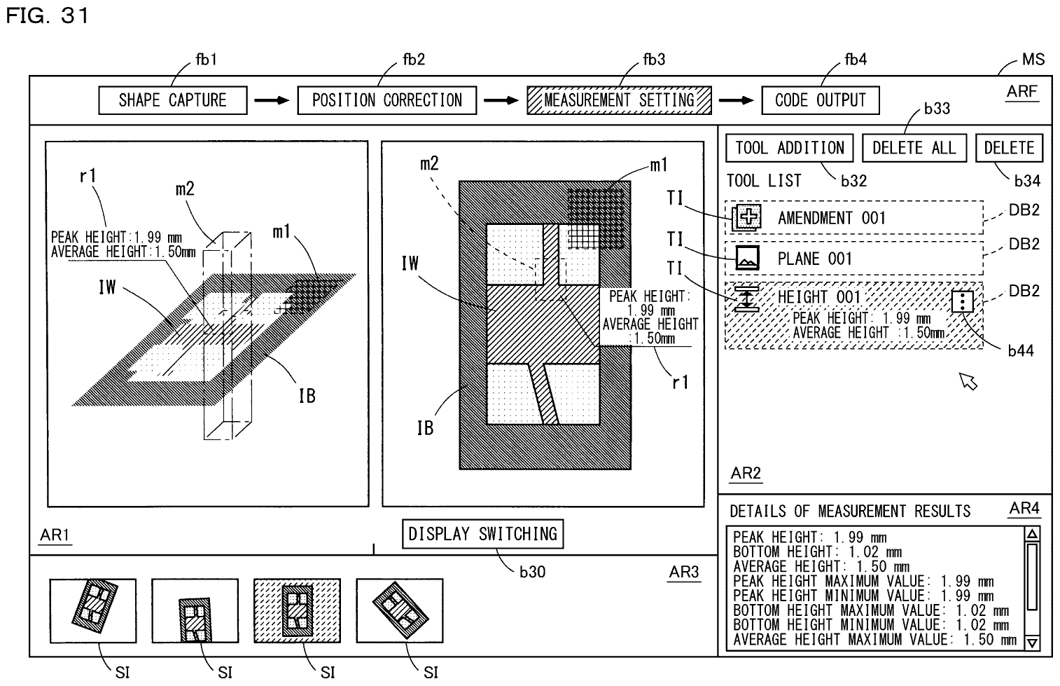

For example, the user selects “peak height” and “average height” from a plurality of types of measurement results displayed in the result display setting window w4, and operates the close button b45. As a result, the result display setting window w4 is closed, and the index r1 indicating the measurement results of the “peak height” and the “average height” is displayed to be superimposed on the two-dimensional height image and the three-dimensional height image in the first display area AR1 as illustrated in FIG. 31. Furthermore, in the second display area AR2, the measurement results of the “peak height” and the “average height” are displayed in the display block DB2 corresponding to the tool for measuring the height.

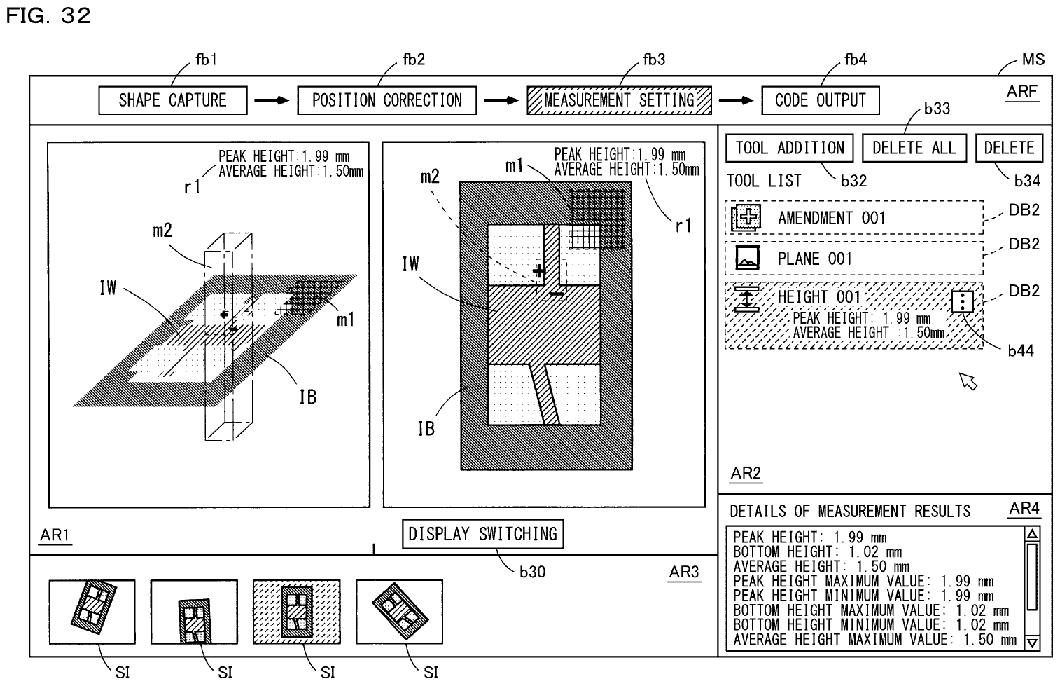

Note that, in the first display area AR1, the two-dimensional height image and the index r1 of the measurement result superimposed and displayed on the three-dimensional height image do not need to be displayed together with the lead line. For example, as illustrated in FIG. 32, the height image may be displayed in a predefined area (upper right corner in this example) of each height image without using a lead line. Furthermore, in the first display area AR1, on each height image, indexes such as a “+” mark and a “−” mark may be attached to a portion where the “peak height” is calculated and a portion where the “bottom height” is calculated in the height measurement area, respectively.

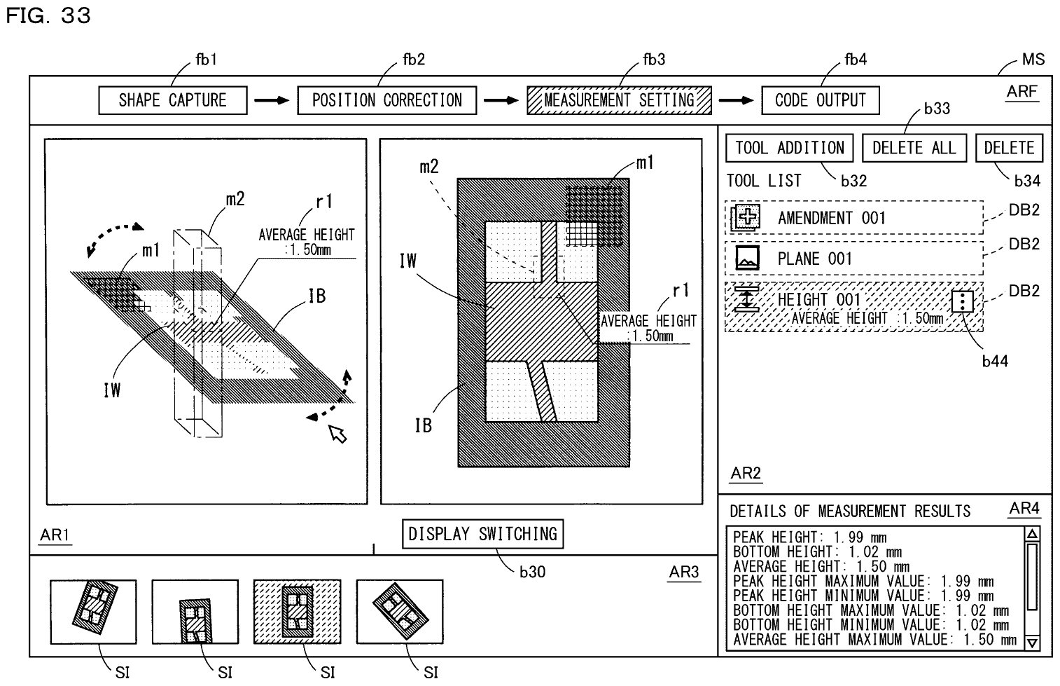

It is assumed that the user switches the viewpoint of the three-dimensional height image displayed in the first display area AR1 while the measurement screen MS in FIG. 29 is displayed. In this case, the indexes m1, m2, and r1 attached to the three-dimensional height image of FIG. 29 are displayed following the switching of the image as illustrated in FIG. 33. Accordingly, the user can easily and precisely grasp the measurement contents of the workpiece W and the measurement result thereof.

In a case where the correction method based on pattern matching is set in the second phase, the position of the other shape data is corrected so that the planar position information of the characteristic portion of the other shape data matches the planar position information of the characteristic portion of the reference shape data. Here, it is assumed that the user selects the thumbnail image SI corresponding to other shape data other than the reference shape data among the thumbnail images SI displayed in the third display area AR3 in a state where the measurement screen MS of FIG. 29 is displayed.

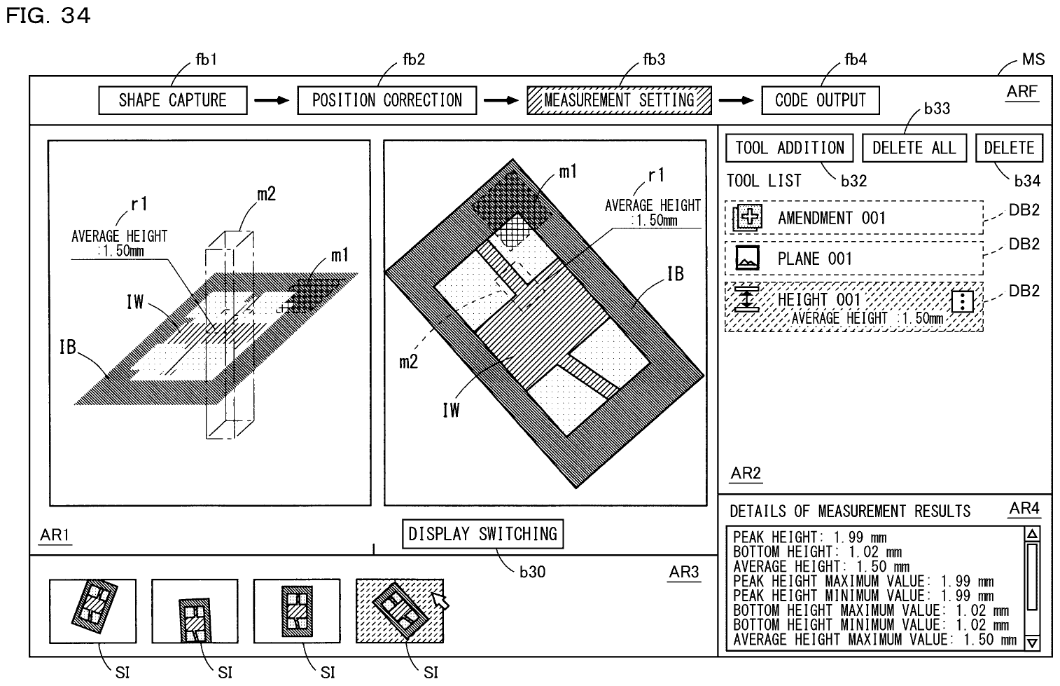

In this case, as illustrated in FIG. 34, a new height image based on the selected other shape data is displayed in the first display area AR1. Furthermore, in the new height image, the indexes m1, m2, and r1 attached to the height image of FIG. 29 are displayed in a state in which the position correction of the other shape data is taken into consideration.

As a result, the user can grasp the measurement result or the like by the set tool while confirming the height images of the plurality of pieces of shape data. Furthermore, the user can grasp that the position correction is appropriately set.

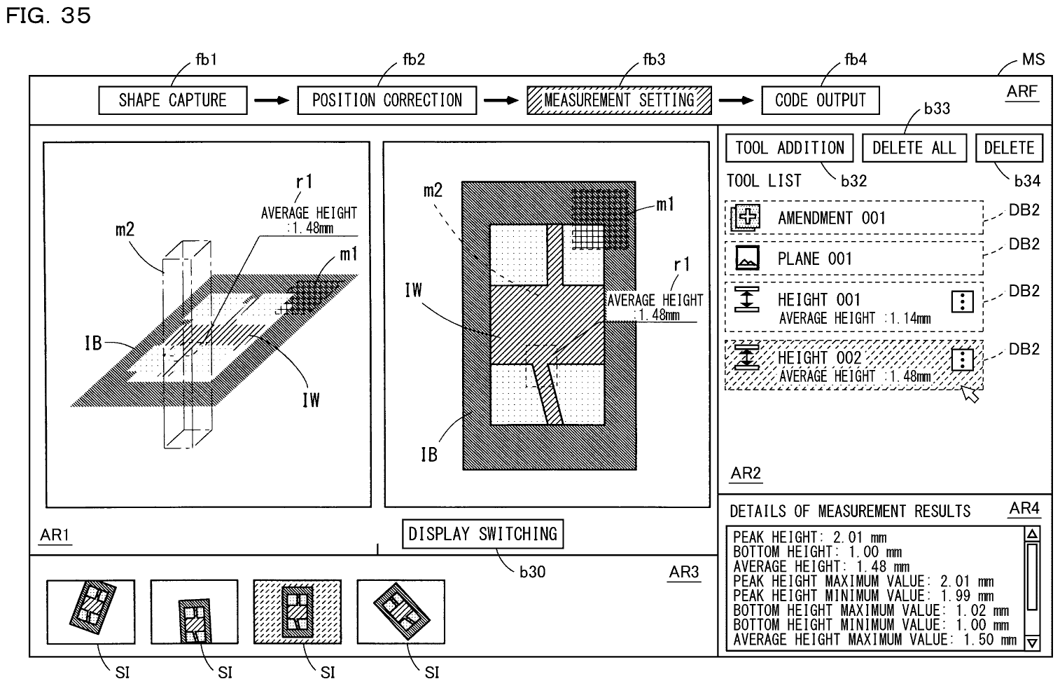

It is assumed that a plurality of tools is set in the third phase. In this case, as illustrated in FIG. 35, a plurality of display blocks DB2 respectively corresponding to a plurality of set tools is displayed in the second display area AR2. In the example of FIG. 35, a display block DB2 of a tool of “height 002” for measuring the height is additionally displayed as compared with the example of FIG. 29.

When the display block DB2 corresponding to the tool for measuring the physical quantity such as the height and the flatness is selected from the plurality of display blocks DB2, all the measurement results regarding the selected tool are displayed in the fourth display area AR4. In the first display area AR1, indexes m1, m2, and r1 related to the selected tool are superimposed and displayed on each height image.

In the example of FIG. 35, the added display block DB2 is selected. By visually recognizing the height image and the various indexes m1, m2, and r1 displayed in the first display area AR1, the user can easily grasp the setting contents by the tool of the display block DB2. Specifically, according to the selected tool, the user can grasp that the height of a partial area including the first upper surface portion 92 (FIG. 7) and the second upper surface portion 93 (FIG. 7) of the workpiece W is measured with the upper surface of the base member as a reference surface. Furthermore, the user can grasp how much the measurement result of the average height by the tool is.

In the main measurement device 20 according to the present embodiment, priority is assigned to each of a plurality of settable tool types. Therefore, in a case where a plurality of tools is sequentially set in the main measurement device 20, the order in which these tools are executed is determined on the basis of the actual setting order and the priority assigned to each tool.

For example, it is not preferable that shape data to be position-corrected is used for calculation of measurement in a state where the position is not corrected. Therefore, the tool for correcting the position of the shape data is assigned the highest priority as compared with other types of tools.

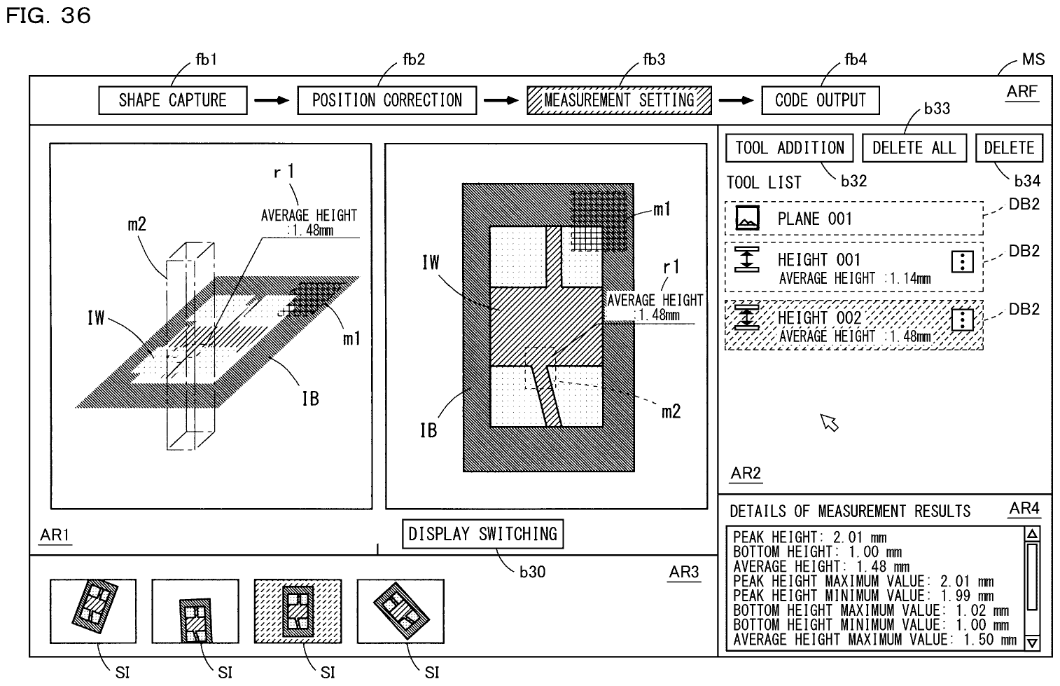

For example, as illustrated in FIG. 36, it is assumed that a tool for specifying a plane (tool of “plane 001”) and two tools for measuring a height (tools of “height 001” and “height 002”) are set in a state where a position correction tool is not set. Note that, in the example of FIG. 36, it is assumed that the tool of “plane 001” is used as a tool for specifying a reference surface common to the tools of “height 001” and “height 002”.

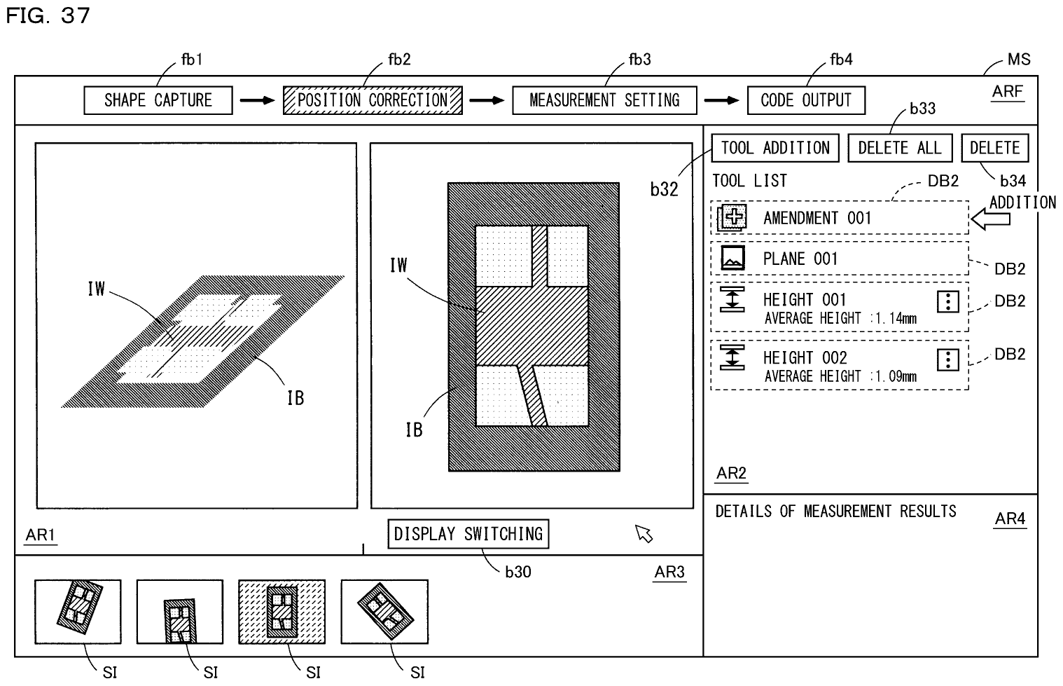

In this case, when the user sets a tool for position correction of the shape data by returning to the second phase, the set position correction tool is added as a tool to be executed first as illustrated in FIG. 37 (see a white arrow in FIG. 37).

Furthermore, for example, when a tool for measuring the height is executed, data of the reference surface corresponding to the measurement is required. Therefore, the tool for specifying the reference surface is assigned higher priority than the tool for measuring the height using the reference surface. Therefore, for example, in a case where the tool for specifying the reference surface used for the measurement is changed after the tool for measuring the height is set, the order of execution of the tool for specifying the changed reference surface is adjusted to be earlier than the previously set execution of the height measurement. Note that the display order of the tools may be aligned with or different from the execution order of the tools. As the display order of the tools, the order of creation of the tools and the order of types of the tools may be selected. In a case where the order of types of the tools is selected as the display order of the tools, the measurement tool, the position correction tool, and the reference surface may be displayed in this order.

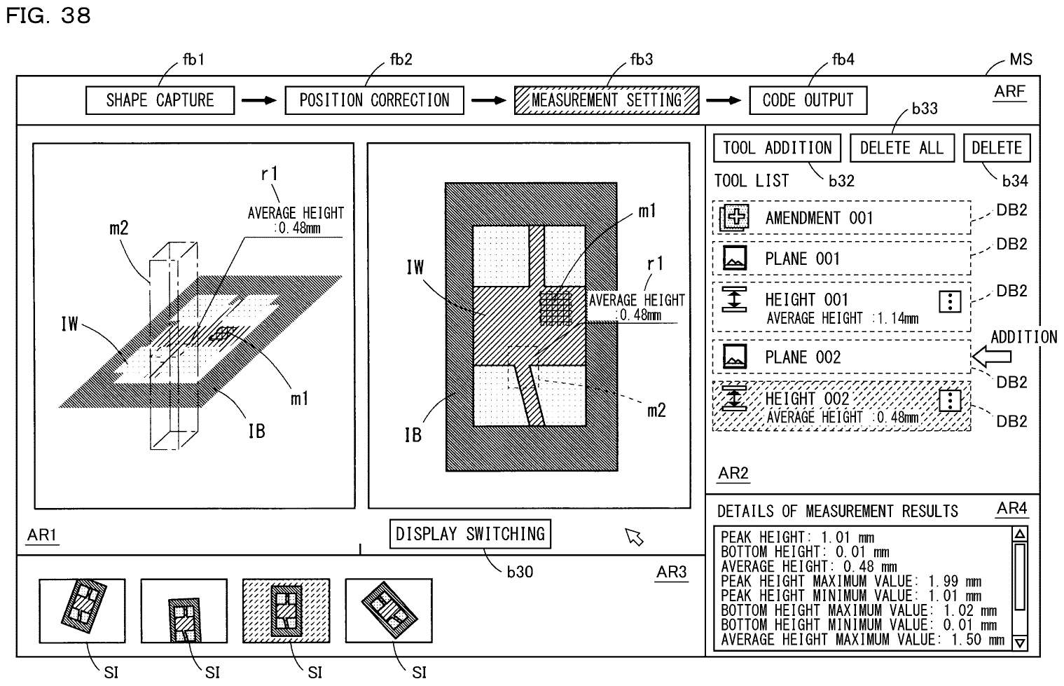

As illustrated in FIG. 36, it is assumed that one tool for specifying the plane and two tools for measuring the height are set in a state where the position correction tool is not set. Here, for a tool of “height 002” for measuring the height, a tool for specifying a plane is set in order to newly set a reference surface. In this case, as illustrated in FIG. 38, a tool for specifying a newly set plane (a tool of “plane 002”) is added as a tool to be executed before a tool of “height 002” for measuring a height (see an outlined arrow in FIG. 38). Note that, in the example of FIG. 38, the plane specified by the tool of “plane 002” is set in a partial area of the second upper surface portion 93 (FIG. 7) of the workpiece W as indicated by a lattice pattern in the first display area AR1.

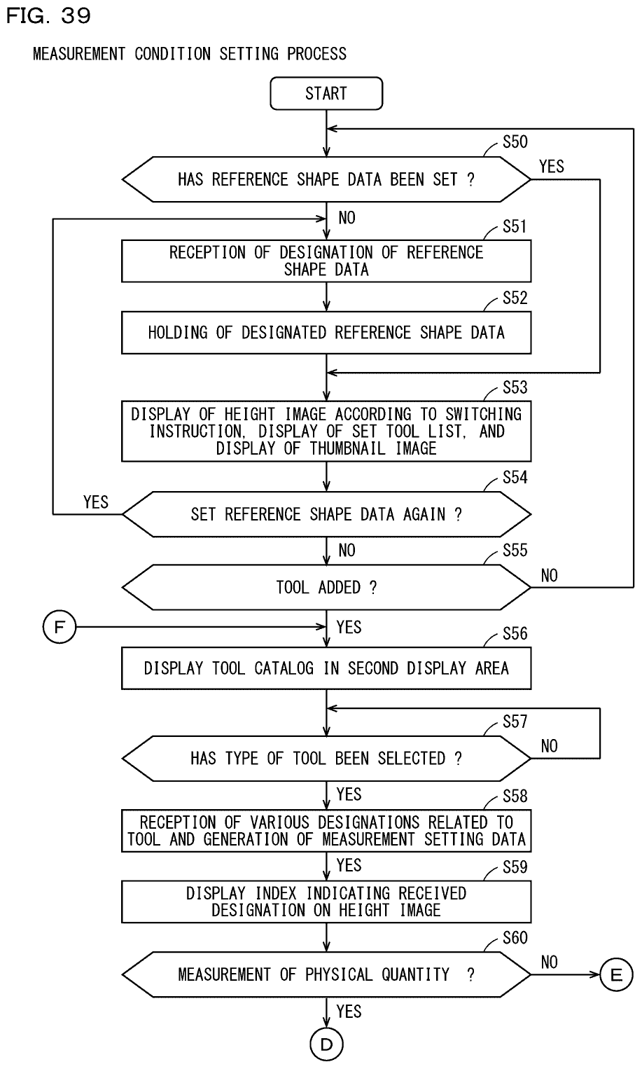

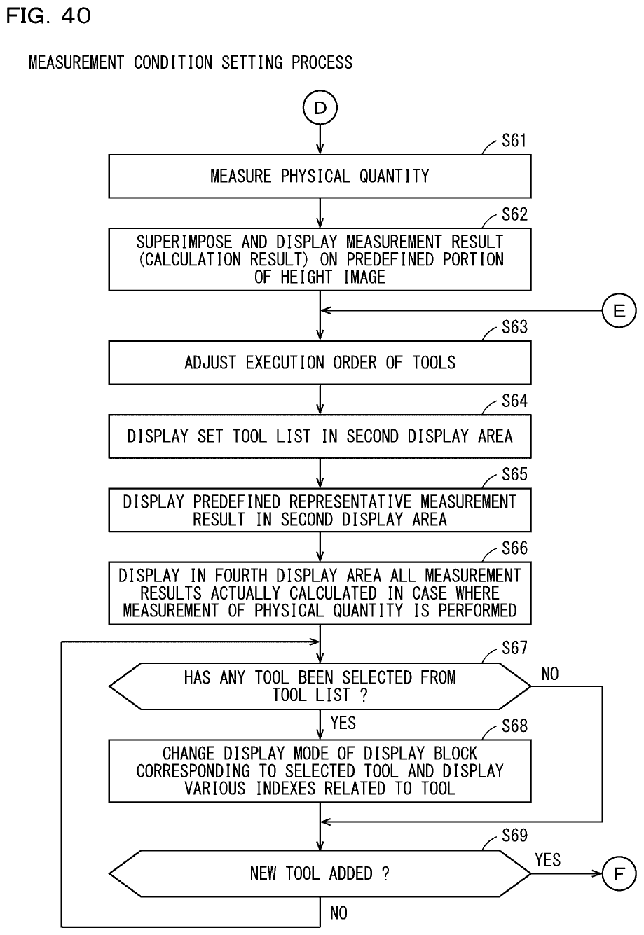

As described above, the third phase is an operation stage corresponding to the measurement condition setting process of FIG. 5. Therefore, details of the measurement condition setting process will be described. FIGS. 39 and 40 are flowcharts illustrating an example of the measurement condition setting process.

The measurement condition setting process is started, for example, in response to the user operating the third phase button fb3. When the correction setting process is started, the same processing as steps S41 to S43 of the correction setting process is first performed. Specifically, the reference data holding unit 33 in FIG. 3 determines whether or not the reference shape data has been set (step S50). In a case where the reference shape data has been set, the process proceeds to step S53 described later. On the other hand, in a case where the reference shape data has not been set, the reception unit 31 in FIG. 3 receives designation of the reference shape data (step S51). Thereafter, the reference data holding unit 33 holds the designated reference shape data (step S52).

Next, the screen generation unit 32 of FIG. 3 displays the height image according to the switching instruction by the user in the first display area AR1 based on the reference shape data, displays the tool list in the second display area AR2, and displays the thumbnail image in the third display area AR3 (step S53). The switching instruction by the user is an instruction received by operating the display switching button b30 in FIG. 24, for example.

Next, the reception unit 31 in FIG. 3 determines whether or not an instruction to set the reference shape data again has been received (step S54). This determination is made based on, for example, whether or not the reference update button b31 in FIG. 24 has been operated. In a case where an instruction to set the reference shape data again has been received, the process proceeds to step S51. On the other hand, in a case where the instruction to set the reference shape data again has not been received, the reception unit 31 determines whether or not the instruction to add the setting of the tool has been received (step S55). This determination is made based on, for example, whether or not the tool addition button b32 in FIG. 24 has been operated. In a case where there is no instruction to add the tool setting, the process proceeds to step S50. On the other hand, in a case where there is an instruction to add the setting of the tool, the screen generation unit 32 displays the tool catalog in the second display area AR2 (step S56).

Next, the reception unit 31 determines whether or not one tool type has been selected from one or a plurality of tool types displayed in the tool catalog (step S57). This determination is made based on, for example, whether or not one of the plurality of display blocks DB1 in FIG. 25 is selected.

In a case where the type of tool is not selected in step S57, the reception unit 31 repeats the processing of step S57. On the other hand, in a case where the type of the tool is selected, the reception unit 31 receives various designations related to the tool. The reception of the designation corresponds to reception of designation of one or a plurality of geometric elements and designation of one or a plurality of measurement items. Furthermore, the measurement setting generation unit 34 in FIG. 3 generates measurement setting data based on the designation received by the reception unit 31 (step S58). Various designation related to the tool is performed, for example, on the basis of an operation of a user interface displayed on the measurement screen MS in FIGS. 26 to 28.

At this time, in response to the reception of the designation by the reception unit 31, the screen generation unit 32 superimposes and displays an index indicating the received designation on the height image of the first display area AR1 (step S59). The index displayed here corresponds to, for example, indexes m1 and m2 superimposed and displayed on the height image in FIGS. 26 and 27.

Next, the execution unit 36 in FIG. 3 determines whether or not the tool related to the received designation is a tool for measuring a physical quantity (step S60). In a case where the tool related to the received designation is not a tool for measuring the physical quantity, the process proceeds to step S63 described later. In a case where the tool related to the received designation is a tool for measuring a physical quantity, the execution unit 36 measures a physical quantity such as height and flatness on the basis of the received designation (step S61).

Furthermore, the screen generation unit 32 superimposes and displays at least a part of the measurement result (calculation result) of the physical quantity calculated in step S61 on a predefined portion of the height image of the first display area AR1 (step S62). The measurement result displayed here corresponds to, for example, the index r1 superimposed and displayed on the height image in FIG. 28.

Note that the measurement result superimposed and displayed on the height image in step S62 may be a measurement result designated by the user using the result display setting window w4 in FIG. 30, or may be a predefined measurement result.

When the reception of various designation for one tool is completed, the measurement setting generation unit 34 in FIG. 3 adjusts the execution order of the tools set at the present time based on the predefined priority order of each tool (step S63). Note that the display order of the tools may be aligned with or different from the execution order of the tools. As the display order of the tools, the order of creation of the tools and the order of types of the tools may be selected. In a case where the order of types of the tools is selected as the display order of the tools, the measurement tool, the position correction tool, and the reference surface may be displayed in this order.

Next, the screen generation unit 32 displays the tool list in the second display area AR2 (step S64). Furthermore, in a case where a tool for measuring a physical quantity is set, the screen generation unit 32 displays a predefined representative measurement result among a plurality of measurement results calculated at the time of setting the tool in the second display area AR2 (step S65). The measurement result displayed here corresponds to, for example, a measurement result (average height) displayed in the display block DB2 of a part of the second display area AR2 in FIG. 29.

Note that the measurement result displayed in the second display area AR2 in step S64 may be a measurement result designated by the user using the result display setting window w4 in FIG. 30.

Next, in a case where the tool set immediately before is a tool for measuring the physical quantity, the screen generation unit 32 displays all of the measurement results calculated in the processing of step S61 in the fourth display area AR4 (step S66). The measurement results displayed here correspond to, for example, a plurality of measurement results (peak height, bottom height, average height . . . , etc.) displayed in the fourth display area AR4 in FIG. 29.

Next, the reception unit 31 determines whether or not any tool has been selected from the tool list in the second display area AR2 (step S67). This determination is made based on, for example, whether or not one of the plurality of display blocks DB2 in FIG. 29 is selected. In a case where no tool is selected from the tool list, the process proceeds to step S69 described later. On the other hand, in a case where any one tool is selected from the tool list, the screen generation unit 32 changes the display mode of the display block DB2 corresponding to the selected tool, and displays various indexes related to the tool on the measurement screen MS (step S68). The various indexes displayed here correspond to, for example, an index m1 indicating a surface serving as a reference of the height, an index m2 indicating a measurement area of the height, an index r1 indicating a measurement result, and the like displayed in the first display area AR1 in FIG. 29.

Next, the reception unit 31 determines whether or not an instruction to add setting of a new tool has been received (step S69). This determination is made based on, for example, whether or not the tool addition button b32 in FIG. 29 has been operated. In a case where there is an instruction to add tool setting, the process proceeds to step S56 described above. On the other hand, in a case where there is no instruction to add the tool setting, the process proceeds to step S67 described above. In the series of processing described above, the correction setting process ends in response to the user operating the phase buttons fb1, fb2, and fb4 other than the third phase button fb3.

### <6> Fourth Phase

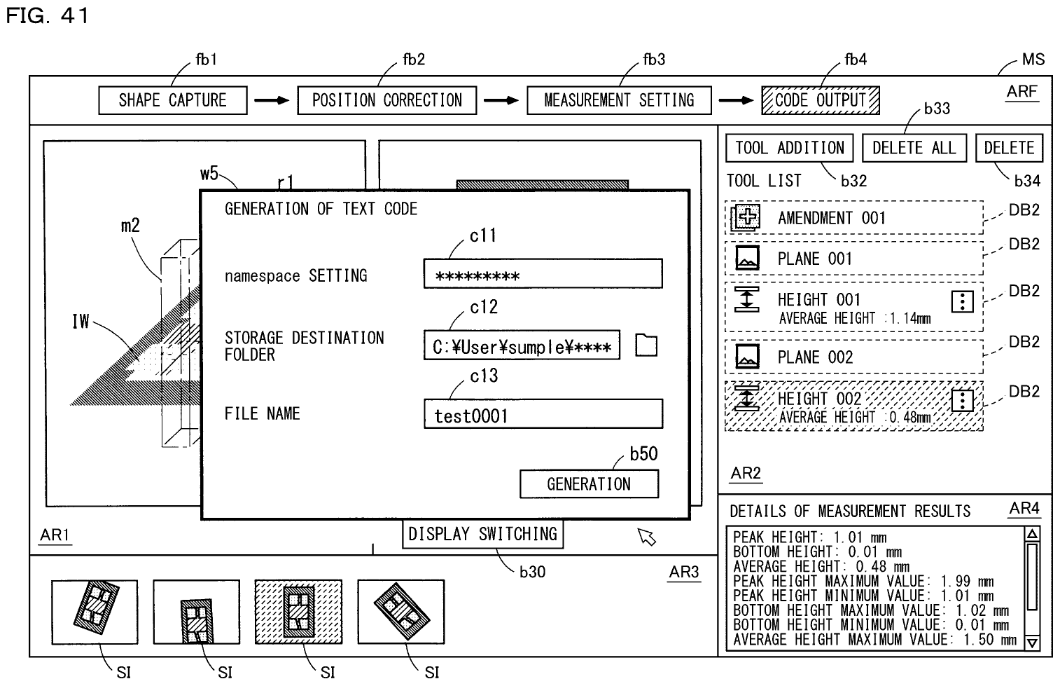

When the fourth phase button fb4 is operated on the measurement screen MS in the second phase or the third phase, the correction setting process or the measurement condition setting process is ended, and the text code generation process is started. FIGS. 41 to 43 are diagrams illustrating a transition example of the measurement screen MS displayed on the display device 13 in the fourth phase.

For example, it is assumed that the user operates the fourth phase button fb4 while the measurement screen MS of FIG. 38 is displayed. In this case, as illustrated in FIG. 41, the display mode of the third phase button fb3 returns to the initial display mode, and the display mode of the fourth phase button fb4 changes so as to be distinguishable from other phase buttons (for example, highlight display).

In the fourth phase, the user needs to perform an operation for generating a text code corresponding to one or a plurality of tools set in the first to third phases. As a result, when the fourth phase button fb4 is operated as described above, a code generation window w5 prompting an instruction regarding generation of the text code is superimposed and displayed at the center of the measurement screen MS.

In the code generation window w5, a namespace input field c11, a folder input field c12, a file name input field c13, and a generation button b50 are displayed. The namespace input field c11 is an input field for setting a namespace for the generated text code. The folder input field c12 is an input field for defining a file name for identifying a file of a text code to be generated. The file name input field c13 is an input field for determining an address such as a folder of a storage destination (output destination) of the generated text code.

As a result, the user can input corresponding information for the text code to be created in the namespace input field c11, the folder input field c12, and the file name input field c13 of the code generation window w5. In the following description, a plurality of pieces of information input to each input field (c11, c12, c13) of the code generation window w5 is referred to as file generation information.

The generation button b50 is a button for giving an instruction to generate a file of a text code. The user inputs the file generation information into each input field (c11, c12, c13) of the code generation window w5 and then operates the generation button b50. As a result, for example, a file of a text code having a desired file name is created in a desired folder in the storage device 22 of FIG. 3.

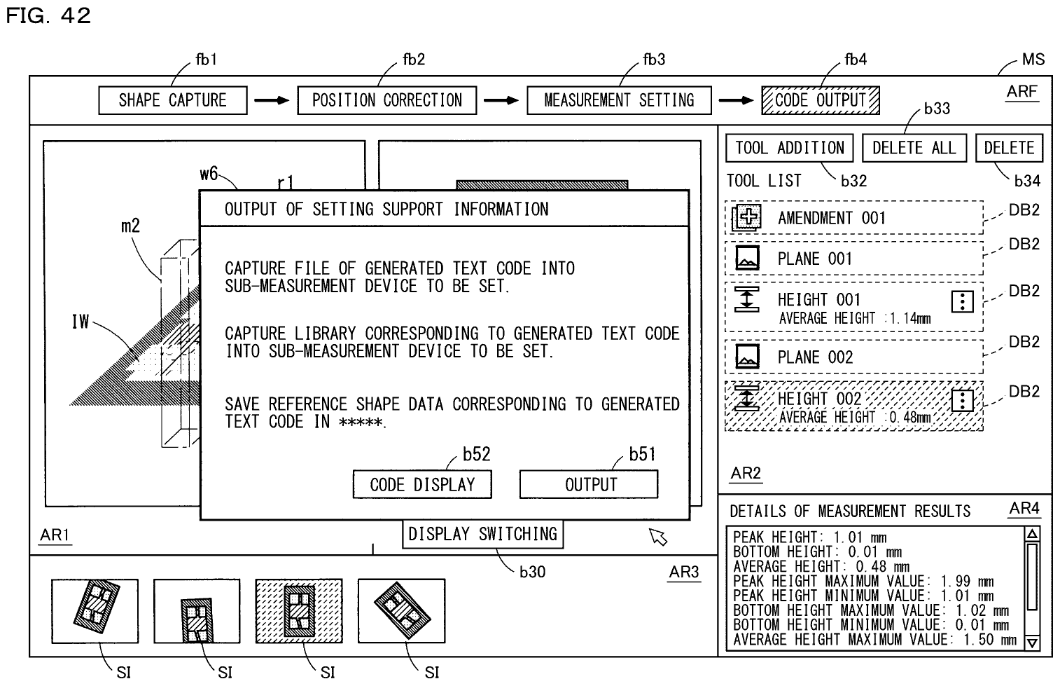

As described above, when the generation button b50 is operated, as illustrated in FIG. 42, an information output window w6 is displayed at the center of the measurement screen MS instead of the code generation window w5. In the information output window w6, a character string indicating a method of using the setting support information is displayed. That is, in the information output window w6, a character string indicating a file of a text code generated by a series of operations, a library corresponding thereto, and a method of using the reference shape data corresponding thereto is displayed.

Furthermore, in the information output window w6, an output button b51 is displayed in addition to the above character string. The user operates the output button b51 after confirming the usage method displayed in the information output window w6. When the output button b51 is operated, the information output window w6 is closed, and the display state of the measurement screen MS returns to the original display state (the display state in FIG. 38). Furthermore, the setting support information is output to a predefined output destination. Thus, the user can easily and smoothly perform the setting work of the sub-measurement devices 20A and 20B (FIG. 1) according to the use method displayed in the information output window w6.

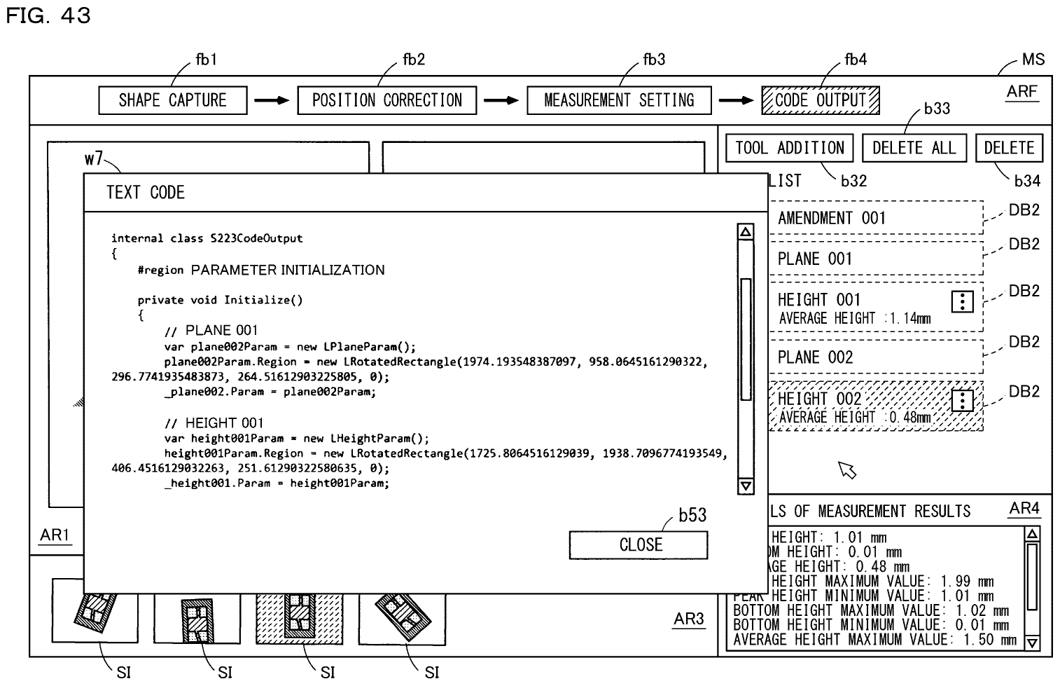

Moreover, a code display button b52 is displayed in the information output window w6. The code display button b52 is a button for displaying the content of the generated text code on the measurement screen MS. When the code display button b52 is operated, a code display window w7 is displayed at the center of the measurement screen MS as illustrated in FIG. 43. In the code display window w7, the created text code is displayed. As a result, the user can confirm the contents of the generated text code on the screen of the display device 13. In the code display window w7, a close button b53 for closing the code display window w7 is further displayed.

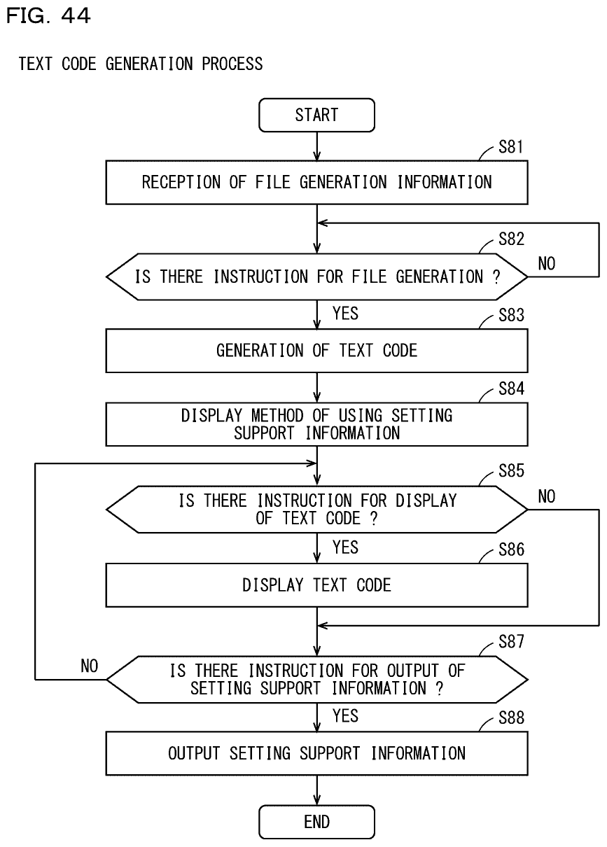

As described above, the fourth phase is an operation stage corresponding to the text code generation process in FIG. 5. Therefore, details of the text code generation process will be described. FIG. 44 is a flowchart illustrating an example of a text code generation process.

The text code generation process is started, for example, in response to the user operating the fourth phase button fb4. When the text code generation process is started, the reception unit 31 in FIG. 3 receives the file generation information (step S81). The reception of the file generation information is performed on the basis of, for example, an operation of the code generation window w5 displayed on the measurement screen MS of FIG. 41.

Next, the reception unit 31 determines whether or not there is an instruction to generate a file of a text code (step S82). This determination is made based on, for example, whether or not the generation button b50 in FIG. 41 is operated. In a case where there is no instruction to generate a file, the reception unit 31 repeats the processing of step S82. On the other hand, in a case where there is the instruction to generate a file, the code generation unit 38 generates a file of a text code on the basis of the file generation information received in step S81 (step S83).

More specifically, in step S83, the code generation unit 38 generates character information indicating the processing program to be called from the library as the processing program information on the basis of the set information (tool type) of the plurality of tools. Furthermore, the code generation unit 38 generates, as designation information, character information indicating a parameter or the like obtained by designation by the user in association with each piece of processing program information. Furthermore, the code generation unit 38 combines the processing program information and the designation information related to each other.

In the present embodiment, the library includes a processing program for setting a capture source of shape data (capture source setting) and setting processing for generating shape data (shape data generation processing setting). In this case, the code generation unit 38 includes information indicating the capture source of the shape data and the capture pitch of the profile data set by the user in the examples of FIGS. 10 and 16 in the text code as the data capture condition. Note that the library may not include the processing program for the capture source setting and the shape data generation processing setting. In a case where the library does not include the processing program for the capture source setting and the shape data generation processing setting, the code generation unit 38 does not include the information indicating the capture source of the shape data and the capture pitch of the profile data set by the user in the examples of FIGS. 10 and 16 in the text code as the data capture condition. Therefore, it is necessary for the user to set these pieces of information by a separate setting work at the time of setting the sub-measurement device 20A.

In the present embodiment, the library may include a processing program related to synthesis of shape data. In this case, in a case where a synthesis condition of a plurality of pieces of shape data to be described later is set, the code generation unit 38 includes the synthesis condition in the text code. Note that the library may not include the processing program related to the synthesis of the shape data. In this case, even if a synthesis condition of a plurality of pieces of shape data to be described later is set, the code generation unit 38 does not include the synthesis condition in the text code.

In a case where a specific measurement result is designated as a display target by the result display setting window w4 in FIG. 30 in the third phase, the code generation unit 38 may include information indicating the designated measurement result in the text code as the measurement result information. According to the text code including the measurement result information, it is possible to easily grasp a notable measurement result.

As described above, in a case where the measurement result information is included in the text code, the code generation unit 38 handles the measurement result information as a structure in the text code. Specifically, the measurement result includes information (value, unit, and item name) of each measurement item such as “peak height”, “bottom height”, “average height”, “peak height maximum value”, “peak height minimum value”, “bottom height maximum value”, “bottom height minimum value”, “average height maximum value”, and “average height minimum value”.

The value of each measurement item is of a floating point type, and the unit and the item name are of a character string type. Note that the language of the item name may be selected in conjunction with the language used in the code generation support program, or a language different from the language used in the code generation support program may be selected. In the text code, the code generation unit 38 may specify the measurement result to be noted by a structure of the measurement result including the value, the unit, and the item name of each measurement item and an identifier for identifying the measurement item to be noted. For example, the measurement item to be noted may be specified from a structure of a measurement result including a value, a unit, and an item name of each measurement item by an enumerator (enum constant) of an enum type as an identifier.

In the present embodiment, the library may include a processing program that executes a function that returns a measurement result corresponding to a measurement item to be noted from a structure of a processing result of an enumeration type using an enumerator as an argument. Furthermore, the function that returns the measurement result may include a function that outputs the measurement result as a floating-point value and a function that outputs the measurement result as a character string indicating a value with a unit such as “mm”. Moreover, the function that returns the measurement result may include a function that returns a character string indicating an item name using an enumerator as an argument. In this case, the code generation unit 38 can output an identifier such as an enumerator corresponding to the measurement item to be noted, and generate a text code for acquiring the item name of the measurement item to be noted and the unit-added value of the measurement result using the identifier.

In the present embodiment, the library may include a processing program that executes processing for displaying a measurement result. The processing program may display an item name of a measurement item to be noted and a value with a unit of a measurement result in a list. Furthermore, the library may include a processing program that executes a function that returns image data in which the measurement result for each area of the set tool is displayed on the two-dimensional height image or the upper or three-dimensional height image as illustrated in FIG. 31 using the shape data, the area of the tool, and the measurement result for each area as arguments.

Next, the screen generation unit 32 in FIG. 3 displays the method of using the setting support information on the measurement screen MS (step S84). Furthermore, the reception unit 31 determines whether or not there is an instruction to display the text code (step S85). This determination is made based on, for example, whether or not the code display button b52 in FIG. 42 is operated. In a case where there is no instruction to display the text code, the process proceeds to step S87 described later. On the other hand, in a case where there is an instruction to display the text code, the screen generation unit 32 displays the generated text code on the measurement screen MS (step S86). The display of the text code is ended, for example, in response to an instruction to stop the display of the text code (for example, the close button b53 in FIG. 43 is operated).

Next, the reception unit 31 determines whether or not the output of the setting support information has been instructed (step S87). This determination is made based on, for example, whether or not the output button b51 in FIG. 42 is operated. In a case where the output of the setting support information is not instructed, the process proceeds to step S85. On the other hand, in a case where the output of the setting support information is instructed, the output unit 39 associates the text code generated by the code generation unit 38 with the library and the reference shape data, and outputs the setting support information including the text code, the library, and the reference shape data (step S88). As a result, the text code generation process ends.

### <7> Text Code

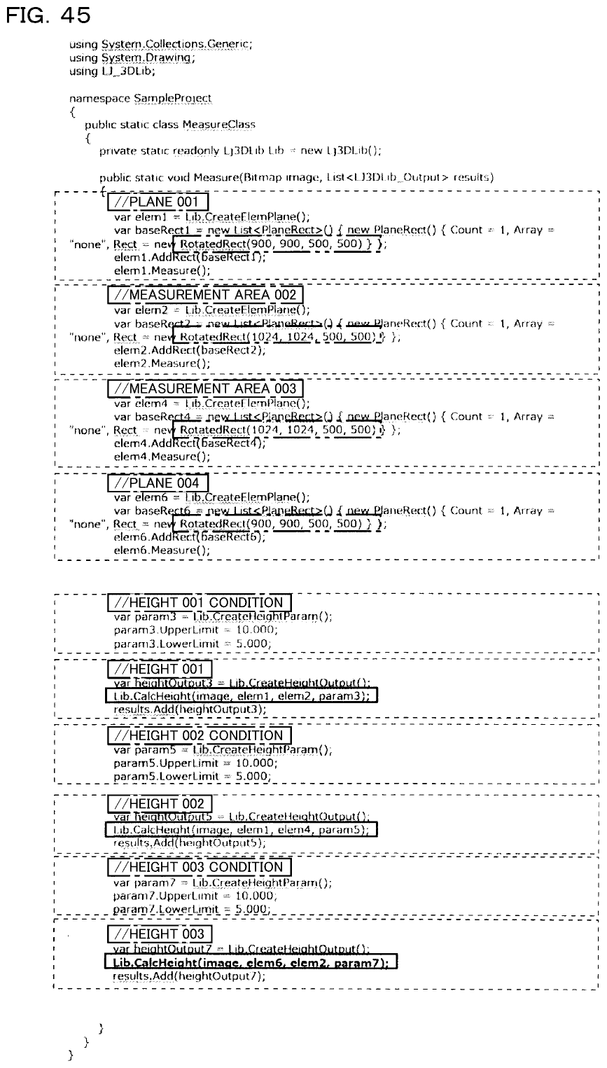

FIG. 45 is a diagram illustrating an example of a text code generated by the code generation unit 38 of FIG. 3. As illustrated in FIG. 45, in the text code generated in the main measurement device 20, as indicated by a plurality of dotted frames, a group of character strings indicating a plurality of set tools is arranged according to the execution order of the tools. Furthermore, the dotted frame of each tool includes a tool name set by the user when the code generation support program is executed, as illustrated in the frame of the one-dot chain line.

As a result, the user can easily grasp contents of a plurality of tools included in the text code, that is, one or a plurality of geometric elements and one or a plurality of measurement items to be set by visually recognizing the text code. Furthermore, the user can easily grasp the execution order of the plurality of tools.

The text code includes processing program information corresponding to the set tool as indicated by a solid line frame in a part of a plurality of dotted line frames. Moreover, the designation information corresponding to the tool is included in the dotted frame corresponding to some tools. Here, for example, as illustrated in the example of FIG. 27, the designation information includes planar position information of the area designated by the user.

In addition to the above, the text code includes, as the data capture condition, information indicating the capture source of the shape data and the capture pitch of the profile data set by the user in the examples of FIGS. 10 and 16 according to the contents of the processing program included in the library. Furthermore, the text code also includes information indicating a condition for synthesizing a plurality of pieces of shape data to be described later according to the content of the processing program included in the library.

Here, information indicating an address of a predefined storage destination (hereinafter, the storage destination is referred to as a prescribed storage destination) of the reference shape data is incorporated in the text code generated in the present embodiment. Furthermore, in the information output window w6 of FIG. 42, a message to store the reference shape data in the prescribed storage destination is displayed. As a result, for example, the user can set the prescribed storage destination indicated in the information output window w6 in the sub-measurement device 20A and store the reference shape data in the set storage destination, thereby proceeding with the setting work of the sub-measurement device 20A.

### 6. Function of Synthesizing Plurality of Shape Data

The size of the shape data that can be generated by one measurement operation by the measurement head 11 is determined according to, for example, the specifications of the light projecting unit and the light receiving unit of the measurement head 11. Therefore, in the case of measuring the entire shape of the workpiece W having a size that cannot be generated by one measurement operation, it is desirable to perform a plurality of measurement operations on a plurality of portions of the workpiece W and synthesize a plurality of pieces of shape data generated by the measurement operations. Therefore, the main measurement device 20 according to the present embodiment has a function of synthesizing a plurality of pieces of shape data acquired from the measurement head 11.

In the case of using the function of synthesizing a plurality of pieces of shape data, the user needs to set a synthesis condition indicating how to synthesize a plurality of pieces of shape data acquired from the measurement head 11. The synthesis condition is generated, for example, when the user selects to synthesize a plurality of pieces of shape data with the radio button of FIG. 9 and operates the head button b11.

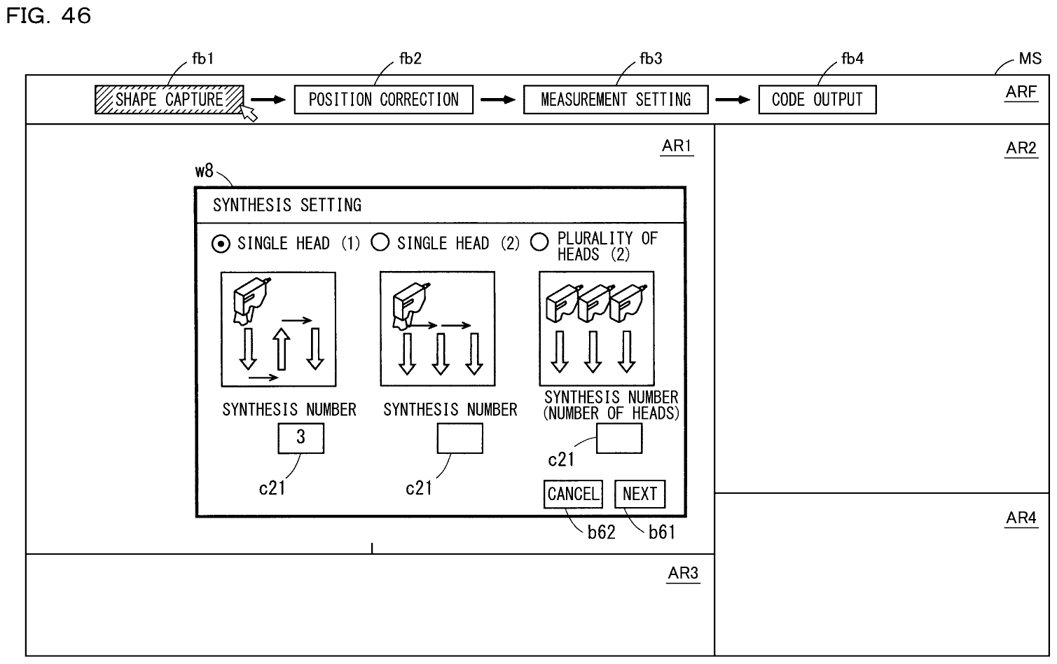

FIGS. 46 to 49 are diagrams illustrating transition examples of the measurement screen MS displayed on the display device 13 by the function of synthesizing a plurality of pieces of shape data. When the head button b11 in FIG. 9 is operated in a state where synthesizing of a plurality of pieces of shape data is selected in the radio button, a synthesis setting window w8 for determining a method of synthesizing a plurality of pieces of shape data is displayed at the center of the measurement screen MS.

In the synthesis setting window w8, a radio button for selecting one synthesis method from a plurality of types of synthesis methods for a plurality of pieces of shape data is displayed. In this example, as a plurality of kinds of synthesis methods, three synthesis methods (first synthesis method, second synthesis method, and third synthesis method) are illustrated together with illustrations.

A first synthesis method is a method of generating shape data each time the measurement head 11 moves in a direction orthogonal to one direction while moving in a rectangular wave shape in one direction, and synthesizing a plurality of pieces of generated shape data. In the first synthesis method, the traveling direction of the measurement head 11 is reversed every time the shape data is generated.

The second synthesis method is a method of generating shape data by moving the measurement head 11 in a direction orthogonal to one direction from one virtual straight line every time the measurement head 11 is moved by a predetermined distance in one direction on the one virtual straight line, and synthesizing a plurality of pieces of generated shape data. In the second synthesis method, the traveling direction of the measurement head 11 when the shape data is generated is maintained in a common direction.

The third synthesis method is a method of generating a plurality of pieces of shape data corresponding to the plurality of measurement heads 11 by moving the plurality of measurement heads 11 in one direction in a state of being adjacent to each other, and synthesizing the plurality of pieces of generated shape data.

An input field c21 for prescribing the number of pieces of shape data to be synthesized is displayed immediately below the illustration indicating each synthesis method. As a result, the user can select a desired synthesis method from the plurality of synthesis methods displayed in the synthesis setting window w8 and input the number of pieces of shape data to be synthesized by the synthesis method into the input field c21.

In the synthesis setting window w8, a next button b61 and a cancel button b62 are further displayed. In the synthesis setting window w8, for example, the next button b61 is operated in a state where the first synthesis method is selected and “3” is input as the number of pieces of shape data to be synthesized. In this case, the setting window w1 of FIG. 10 is displayed on the measurement screen MS. Thereby, the user can set up a measurement head for capturing shape data from the one or plurality of measurement heads 11 currently connected to the main measurement device 20.

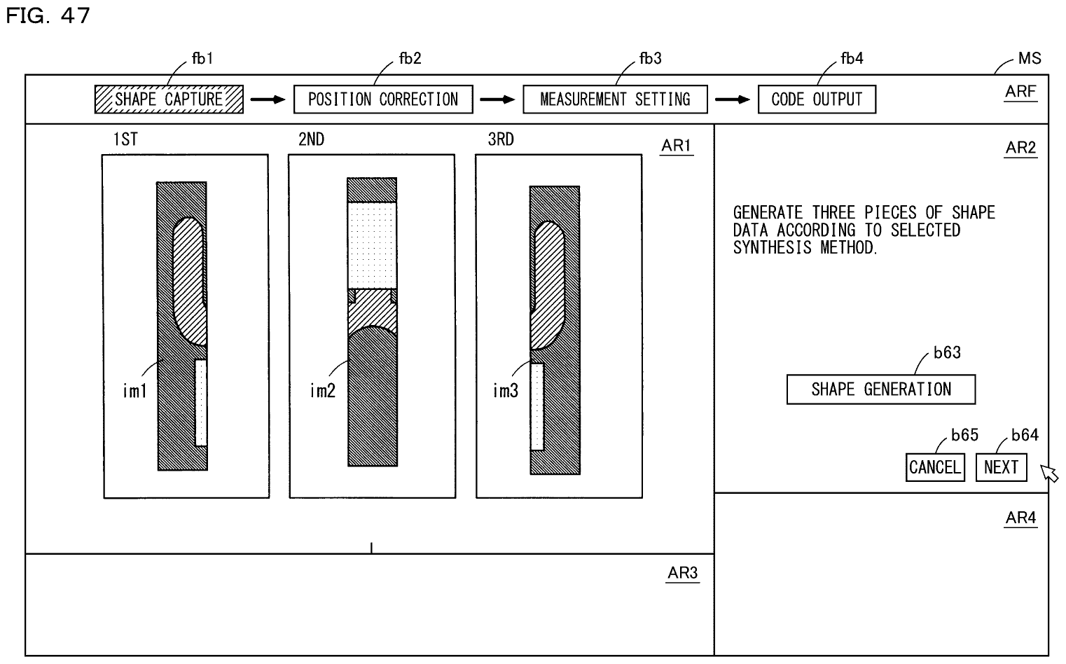

When the measurement head from which the shape data is to be captured is set and the determination button b14 (FIG. 10) of the setting window w1 is operated, as illustrated in FIG. 47, a message prompting generation of a plurality of pieces of shape data to be synthesized is displayed in the second display area AR2. Moreover, in the second display area AR2, a shape data generation button b63, a next button b64, and a cancel button b65 are displayed.

The shape data generation button b63 is a button for generating shape data using the measurement head 11 set by the user. In the present example, it is assumed that three pieces of shape data are generated by the user repeatedly operating the shape data generation button b63 and relatively moving the measurement head 11 and the workpiece W according to the first synthesis method set in the synthesis setting window w8. Note that, in the present example, it is further assumed that information necessary for generating shape data (such as a capture pitch of profile data) is set by default in advance.

In this case, a plurality of (three in this example) two-dimensional height images im1, im2, and im3 based on a plurality of pieces of generated shape data are displayed in the first display area AR1. Furthermore, in the third display area AR3, a thumbnail image SI corresponding to the image displayed in the first display area AR1 is displayed. Note that the images displayed in the first display area AR1 and the second display area AR2 in FIGS. 47 to 49 are images based on the shape data of the workpiece different from the workpiece W in FIG. 7.

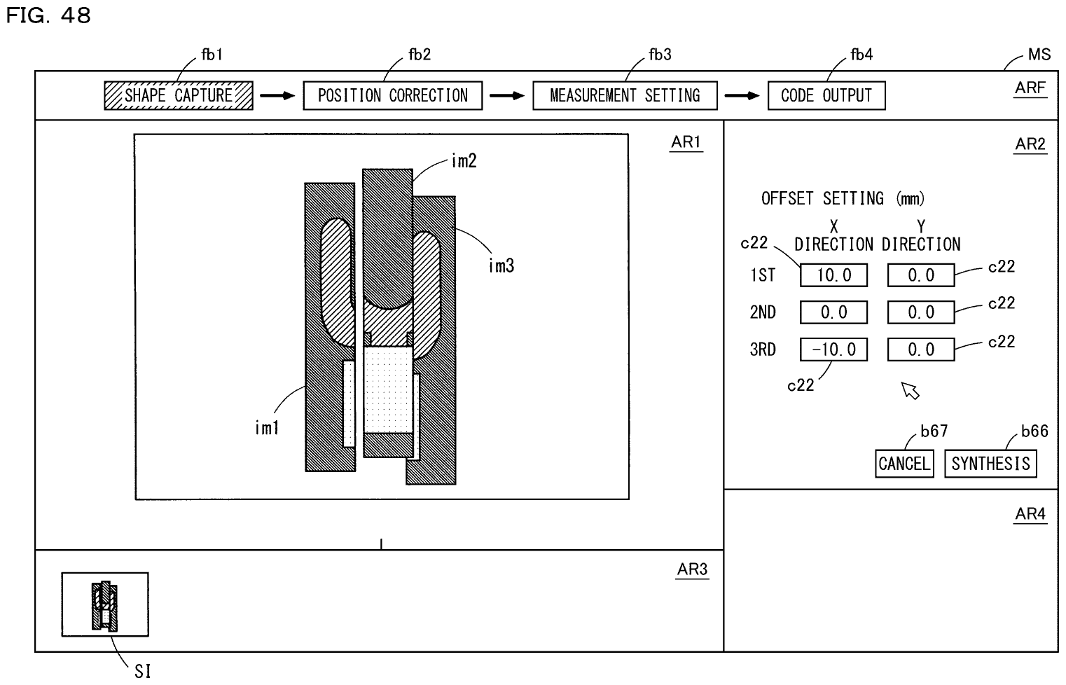

When the next button b64 is operated in the display state of FIG. 47, three two-dimensional height images im1, im2, and im3 are displayed in the first display area AR1 so as to be arranged on the common planar coordinate system as illustrated in FIG. 48.

At this time, the planar position information of each piece of shape data is adjusted so as to be matched with each other on the basis of the set synthesis method. Accordingly, the directions of the two-dimensional height images im1, im2, and im3 are appropriately inverted. In the example of FIG. 48, the two-dimensional height image im2 located at the center is vertically inverted with respect to the display example of FIG. 47.

In the second display area AR2, a plurality of input fields c22 for adjusting the planar position information is displayed for each of the shape data captured first, the shape data captured second, and the shape data captured third. The user can adjust the planar position information for each of the three pieces of shape data by inputting a numerical value, that is, an offset value with respect to the initial planar position information, to each of the plurality of input fields c22.

Furthermore, in the present example, the adjustment result of the planar position information is reflected on each of the three two-dimensional height images im1, im2, and im3 displayed in the first display area AR1. As a result, the user can adjust the plane position information of the three pieces of shape data while visually recognizing the three two-dimensional height images im1, im2, and im3 displayed in the first display area AR1.

In the second display area AR2, a synthesis button b66 and a cancel button b67 are further displayed. The synthesis button b66 is a button for determining the offset value input to the plurality of input fields c22 of the second display area AR2 as a part of the synthesis condition and synthesizing the plurality of pieces of shape data. When the synthesis button b66 is operated, a plurality of pieces of shape data in which the planar position information has been adjusted are synthesized.

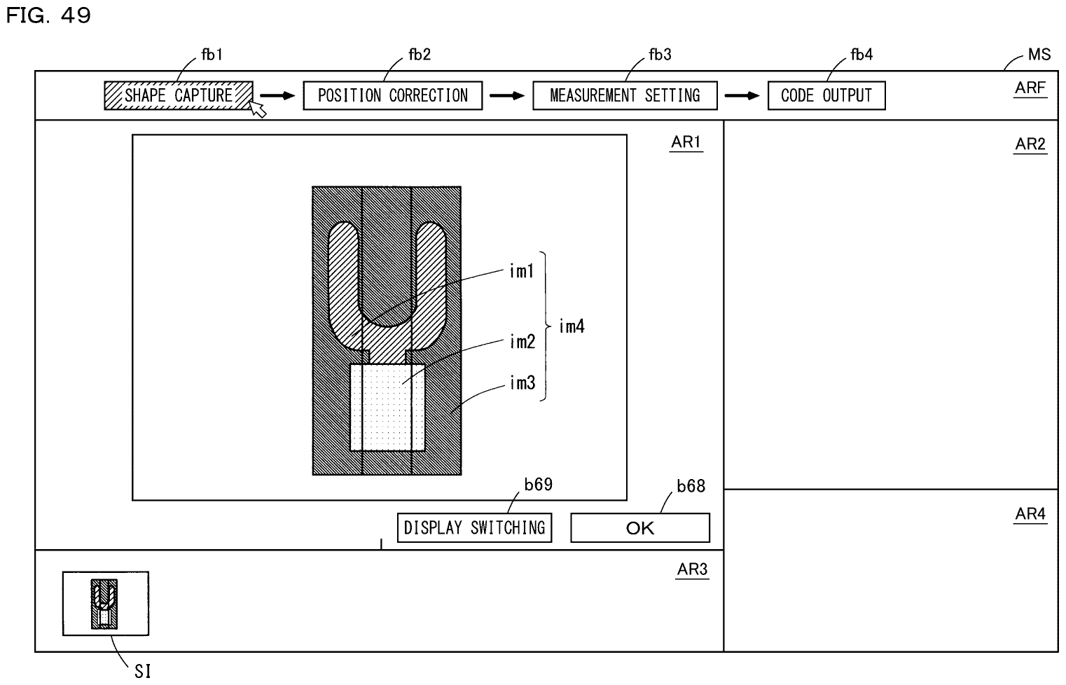

Furthermore, as illustrated in FIG. 49, a two-dimensional height image im4 based on the synthesized shape data is displayed in the first display area AR1. At this time, an OK button b68 and a display switching button b69 are displayed in the first display area AR1. By operating the display switching button b69, the user can switch the image displayed in the first display area AR1 to the three-dimensional height image, or switch to a state in which the two-dimensional height image and the three-dimensional height image are displayed side by side.

By the above series of operations, a method of synthesizing a plurality of pieces of shape data, the measurement head 11 used for the plurality of pieces of shape data, the number of pieces of shape data to be synthesized, and a synthesis condition including an offset value for the plurality of pieces of shape data are set. The OK button b68 is a button for instructing completion of setting of the synthesis condition. When the OK button b68 is operated, the set synthesis condition is stored.

In a case where the synthesis condition is stored as described above, the correction setting process, the measurement condition setting process, and the text code generation process described above can be performed on the shape data synthesized based on the synthesis condition.

The code generation support process according to the present embodiment includes a process for setting the above synthesis condition (hereinafter, it is referred to as synthesis condition setting process) in addition to the plurality of processes illustrated in FIG. 5. The synthesis condition setting process is, for example, a process executed in place of the shape data capture process of FIG. 5 based on a user's instruction. The synthesis condition setting process will be described.

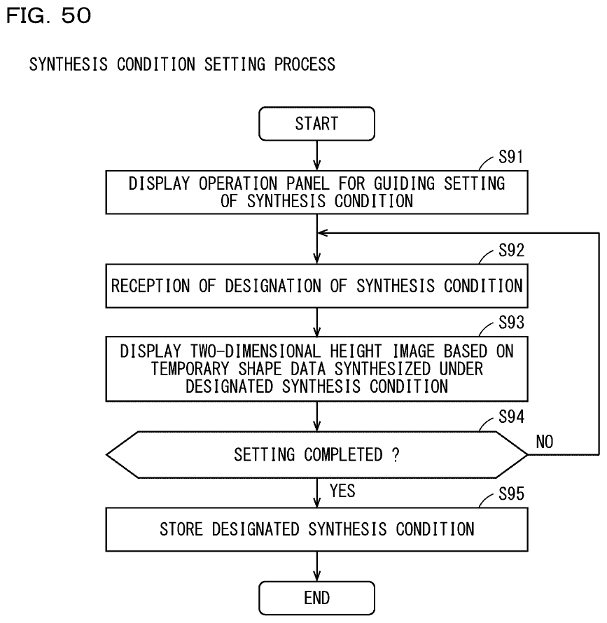

FIG. 50 is a flowchart illustrating an example of a synthesis condition setting process. The synthesis condition setting process is started in response to an instruction to set the synthesis condition by the user. In the above example, the instruction to set the synthesis condition corresponds to the user selecting to synthesize the plurality of pieces of shape data with the radio button in FIG. 9 and operating the head button b11.

When the synthesis condition setting process is started, the screen generation unit 32 in FIG. 3 displays an operation panel for guiding the setting of the synthesis condition on the measurement screen MS (step S91). Furthermore, the reception unit 31 of FIG. 3 receives various designations regarding the synthesis condition (step S92). The operation panel displayed here corresponds to, for example, a user interface displayed on the measurement screen MS in FIGS. 46 to 48.

Moreover, when the reception unit 31 receives various designations, the data pre-processing unit 40 synthesizes a plurality of pieces of shape data under designated synthesis conditions. Furthermore, the screen generation unit 32 causes the display device 13 to display the two-dimensional height image based on the temporary shape data synthesized under the designated synthesis condition (step S93). This two-dimensional height image corresponds to, for example, the two-dimensional height images im1, im2, and im3 displayed on the measurement screen MS in FIG. 48 and the two-dimensional height image im4 in FIG. 49.

Next, the reception unit 31 determines whether or not setting of the synthesis condition is completed (step S94). This determination is made based on, for example, whether or not the OK button b68 in FIG. 49 has been operated. In a case where the setting of the synthesis condition is not completed, the process proceeds to step S92. On the other hand, in a case where the setting of the synthesis condition is completed, the data pre-processing unit 40 stores the designated synthesis condition (step S95). Accordingly, the synthesis condition setting process ends.

Note that the data pre-processing unit 40 may determine whether or not there is pitch mismatch between the plane coordinate systems of the two pieces of shape data adjacent to each other at the time of the synthesis processing in step S93 described above. Then, in a case where it is determined that the pitch mismatch occurs between the two plane coordinate systems, the position correction that cancels the pitch mismatch between the two pieces of shape data may be automatically performed. Alternatively, the data pre-processing unit 40 may perform processing (complement processing or the like) for reducing a gap between two pieces of shape data caused by pitch mismatch.

### 7. Effects

(a) In the main measurement device 20 described above, one or a plurality of pieces of shape data of the workpiece W is captured, and reference shape data is set from the captured one or plurality of pieces of shape data. One or a plurality of tools are set in the reference shape data, and measurement setting data is generated. At the time of setting one or a plurality of tools, indexes m1 and m2 (FIG. 29) indicating designation information corresponding to the setting are displayed on the measurement screen MS. As a result, the user can easily grasp his/her designated contents.

One or a plurality of measurement results are calculated based on the generated measurement setting data. At least a part of the one or plurality of calculated measurement results is displayed on the measurement screen MS. Accordingly, the user can check whether the setting of each tool is appropriate.

Furthermore, according to the above code generation support device, the text code including the processing program information and the designation information corresponding to the set tool is generated. As a result, the user can easily and appropriately perform setting work of the sub-measurement devices 20A and 20B for performing desired measurement on the workpiece W by using the generated text code.

(b) The measurement screen MS for generating setting support information is displayed on the display device 13 of the main measurement device 20. A height image is mainly displayed in the first display area AR1 of the measurement screen MS. At the time of setting various tools, indexes m1 and m2 representing one or a plurality of geometric elements designated by the user are superimposed and displayed on the height image. Therefore, the user can easily and accurately grasp setting contents of the tool (designated contents of one or a plurality of element indexes) by visually recognizing the image and the indexes m1 and m2 having the height.

Furthermore, in the second display area AR2 of the measurement screen MS, tool lists are displayed in the second phase and the third phase. As a result, the user can easily grasp the tool (designated contents for one or a plurality of geometric elements and one or a plurality of measurement items) set at the present time by visually recognizing the tool list.

In the tool list, a predefined representative measurement result is displayed in the display block DB2 corresponding to a tool for measuring physical quantities such as height and flatness. Furthermore, when the display block DB2 corresponding to the tool for measuring the physical quantity is selected, the index r1 indicating the representative measurement result corresponding to the display block DB2 is superimposed and displayed on the height image of the first display area AR1. As a result, the user can easily grasp whether various settings are appropriate by visually recognizing the tool list and the index r1.

Furthermore, in the third display area AR3 of the measurement screen MS, thumbnail images SI of a plurality of pieces of shape data that can be used as the reference shape data are selectively displayed. Therefore, the user can select desired shape data from the plurality of pieces of shape data as the reference shape data.

(c) In the main measurement device 20, the generated text code and the setting support information including the library and the reference shape data corresponding to the text code are output. Therefore, by using the output setting support information, it is possible to easily perform setting work of the sub-measurement devices 20A and 20B for performing desired measurement without separately preparing the library and the reference shape data.

(d) As described above, the text code generated in the main measurement device 20 can include the processing program information and the designation information corresponding to the tool for correcting the position of the shape data. As a result, the user can easily perform setting work of the sub-measurement devices 20A and 20B for position correction of the shape data.

(e) Furthermore, the text code generated in the main measurement device 20 can include a data capture condition. As a result, the user can easily perform setting work of the sub-measurement devices 20A and 20B for capturing the shape data.

(f) In the text code generated in the main measurement device 20, the execution order of the plurality of processing programs corresponding to the plurality of tools is determined on the basis of the actual setting order and the priority assigned to each tool in advance. As a result, the user does not need to consider an appropriate setting order when setting a plurality of tools for generating the text code.

### 8. Other Embodiments

(a) In the above embodiment, a plurality of processing programs that can be used for measuring the shape of the workpiece W are collected by the library and held in the library holding unit 37, but the present invention is not limited thereto. Each of the plurality of processing programs may be individually held in a predefined storage area regardless of the library.

(b) The setting support information according to the above embodiment includes a text code, a library corresponding to the text code, and reference shape data, but the present invention is not limited thereto. The setting support information may not include the library and the reference shape data. In this case, it is necessary to separately prepare the library and the reference shape data at the time of setting work of the sub-measurement devices 20A and 20B.

Alternatively, the setting support information may include only a processing program to be called by the generated text code instead of the library. In this case, it is not necessary to store an extra processing program in the sub-measurement devices 20A and 20B at the time of setting work of the sub-measurement devices 20A and 20B.

(c) In the above embodiment, as the configuration for generating the shape data, the measurement head 11 capable of acquiring the profile data by irradiating the workpiece W with the strip-shaped light is used, but the present invention is not limited thereto. Instead of the measurement head 11, it is also possible to use a configuration capable of acquiring point cloud data indicating the three-dimensional shape of the workpiece W by irradiating the workpiece W with measurement light having a pattern. In this case, the setting support information can be generated for various measurements using the point cloud data.

(d) In the main measurement system 1 according to the above embodiment, a shape data generating device capable of generating shape data by receiving an output from the measurement head 11 may be provided between the measurement head 11 and the main measurement device 20. In this case, the acquisition unit 21 of the main measurement device 20 may acquire the shape data generated by the shape data generation device. Moreover, the data pre-processing unit 40 may capture shape data acquired by the acquisition unit 21. As described above, in a case where the shape data generating device is used, the processing of generating the shape data in the data pre-processing unit 40 becomes unnecessary.

### 9. Correspondence Between Each Part of Embodiment and Each Component of Claims

Hereinafter, an example of correspondence between each component of the claims and each component of the embodiment will be described. Various other elements having the configuration or function described in the claims can be used as each element of the claims.

In the above embodiment, the workpiece W is an example of the measurement object, the sub-measurement devices 20A and 20B are examples of the measurement device, the acquisition unit 21 and the data pre-processing unit 40 are examples of the capture unit, the measurement screen MS is an example of the measurement screen, the display device 13 is an example of the display unit, and the screen generation unit 32 is an example of the screen generation unit.

Furthermore, the reception unit 31 is an example of a reception unit, the index providing unit 35 is an example of an index display unit, the measurement setting generation unit 34 is an example of a measurement setting generation unit, the execution unit 36 is an example of an execution unit, the code generation unit 38 is an example of a code generation unit, and the main measurement device 20 is an example of a code generation support device and a processing device.

Furthermore, the library holding unit 37 is an example of the library holding unit, the output unit 39 is an example of the output unit, the character string displayed in the information output window w6 of FIG. 42 is an example of the character string indicating the usage, and the reference data holding unit 33 is an example of the reference data holding unit.

### 10. Overall of Embodiments

(Clause 1) A code generation support device according to clause 1 includes:
a capture unit configured to capture shape data representing a three-dimensional shape of a measurement object;
a screen generation unit configured to generate a measurement screen including an image of the measurement object based on the shape data captured by the capture unit and cause a display unit to display the measurement screen;
a reception unit configured to receive, as designation information, designation of one or a plurality of geometric elements and designation of one or a plurality of measurement items related to the one or plurality of geometric elements on the measurement screen displayed on the display unit;
an index display unit configured to cause an index indicating the received designation information to be displayed on the measurement screen displayed on the display unit in response to reception of the designation by the reception unit;
a measurement setting generation unit configured to generate measurement setting data for calculating values of the one or plurality of measurement items in the measurement object based on the designation information received by the reception unit;
an execution unit configured to calculate values of the one or plurality of measurement items in the measurement object based on the shape data captured by the capture unit and the measurement setting data generated by the measurement setting generation unit; and
a code generation unit configured to select, from a plurality of processing programs respectively corresponding to a plurality of processes for respectively specifying a plurality of predefined types of geometric elements and a plurality of processes for respectively calculating values of a plurality of predefined types of measurement items, a plurality of processing programs respectively corresponding to a process for specifying the one or plurality of designated geometric elements and a process for calculating values of the one or plurality of designated measurement items, and generate a text code including a plurality of pieces of processing program information indicating the plurality of selected processing programs and the designation information received by the reception unit.

According to the code generation support device, the shape data is captured, and the one or plurality of geometric elements and the one or the plurality of measurement items are designated for the captured shape data, whereby the measurement setting data is generated. When the one or plurality of geometric elements and the one or plurality of measurement items are designated, the index indicating the designation information of each designation is displayed on the measurement screen. Accordingly, a user can easily grasp designated contents.

Values of the one or plurality of designated measurement items are calculated based on the generated measurement setting data. Thereby, the user can check whether the designation of the one or plurality of geometric elements and the designation of the one or plurality of measurement items are appropriate based on the calculated values.

Furthermore, according to the above code generation support device, a text code including a plurality of pieces of processing program information indicating a processing program used for specifying the one or plurality of designated geometric elements and a processing program for calculating the one or plurality of designated measurement items, and designation information is generated.

As a result, the user can easily and appropriately perform setting work of a measurement device for performing desired measurement on the measurement object by using the generated text code.

(Clause 2) In the code generation support device according to clause 1,
the code generation support device may further include a library holding unit configured to hold one or a plurality of libraries including the plurality of processing programs, and each of the plurality of pieces of processing program information may include information for calling the processing program from the one or plurality of libraries held in the library holding unit.

In this case, according to the generated text code, a processing program corresponding to the process for specifying the one or plurality of designated geometric elements can be easily called from the one or plurality of libraries. Furthermore, a processing program corresponding to the process for calculating the values of the one or plurality of designated measurement items can be easily called from the one or plurality of libraries.

(Clause 3) In the code generation support device according to clause 1 or 2,
the code generation support device may further include an output unit configured to output the text code generated by the code generation unit and the plurality of processing programs indicated by the plurality of pieces of processing program information included in the text code in association with each other.

In this case, the user can easily perform setting work of the measurement device for performing desired measurement by using the generated text code and the plurality of processing programs.

(Item 4) In the code generation support device according to clause 3,
the screen generation unit may cause the display unit to display a character string indicating a method of using the text code and the plurality of processing programs to be output when the output unit outputs the text code and the plurality of processing programs.

In this case, the user can easily grasp the method of using the output text code and plurality of processing programs. Therefore, the user can easily and smoothly perform setting work of the measurement device for performing desired measurement.

(Clause 5) In the code generation support device according to clause 3 or 4,
the code generation support device may further include a reference data holding unit configured to hold, as reference shape data, shape data corresponding to an image of the measurement object to be displayed on the measurement screen when the reception unit receives the designation information, and
the output unit may output the text code and the plurality of processing programs in association with the reference shape data used to generate the text code.

In this case, the user can easily perform setting work of the measurement device for performing desired measurement by using the generated text code and the reference shape data.

(Clause 6) In the code generation support device according to clause 5,
the reception unit may be able to receive, as correction information, designation of a correction method for correcting position information of the shape data based on the reference shape data, and
in a case where the reception unit receives the correction information, the code generation unit may select, from a plurality of processing programs respectively corresponding to a plurality of processes for respectively executing a plurality of predefined types of correction methods, a processing program corresponding to a process for executing the correction method designated, and generate a text code including processing program information indicating the selected processing program and the correction information received by the reception unit.

In this case, the user can easily perform setting work of the measurement device for performing desired correction on the shape data by using the generated text code.

(Clause 7) In the code generation support device according to clause 6,
priority may be predefined for a plurality of processing programs respectively corresponding to a plurality of processes for respectively specifying the plurality of types of geometric elements, a plurality of processes for respectively calculating values of the plurality of types of measurement items, and a plurality of processes for respectively executing the plurality of types of correction methods, and
the code generation unit may generate a text code so that an order of the plurality of pieces of processing program information is arranged according to the predefined priority.

In this case, by inputting the generated text code to the measurement device, the user can cause the measurement device to perform the processes according to the priority of the plurality of processing programs.

(Clause 8) In the code generation support device according to any one of clauses 1 to 7,
the reception unit may be able to receive, as data capture information, designation of a condition for capturing the shape data by the capture unit, and
in a case where the reception unit receives the data capture information, the code generation unit may generate a text code to further include the received data capture information.

In this case, the user can easily perform setting work of the measurement device for capturing desired shape data using the generated text code.

(Clause 9) In the code generation support device according to any one of clauses 1 to 8,
the reception unit may be able to receive, as designation of the one or each of the plurality of geometric elements, designation for specifying a type of a shape of the one or plurality of geometric elements and designation for specifying a position of the one or plurality of geometric elements, and may be able to receive, as designation of the one or plurality of measurement items, designation for specifying a type of the one or plurality of measurement items. In this case, the user can easily specify the type and position of the geometric elements.

(Clause 10) In the code generation support device according to any one of clauses 1 to 9,
when receiving the designation of the one or plurality of geometric elements and the designation of the one or plurality of measurement items, the reception unit may be configured to receive a character string related to each designation, and
in a case where, together with reception of one designation, the character string related to the one designation is received, the code generation unit may include the received character string in a text code as information indicating contents of the one designation.

In this case, the user can include in the text code a desired character string corresponding to the designation of the one or plurality of geometric elements and the designation of the one or plurality of measurement items, respectively. Accordingly, the user can grasp various setting contents represented in the text code based on the character string included in the generated text code.

(Clause 11) A code generation support program according to clause 11 is a code generation support program executable by a processing device, the code generation support program causing the processing device to execute:
a process of capturing shape data representing a three-dimensional shape of a measurement object;
a process of generating a measurement screen including an image of the measurement object based on the shape data captured by the capturing process and causing a display unit to display the measurement screen;
a process of receiving, as designation information, designation of one or a plurality of geometric elements and designation of one or a plurality of measurement items related to the one or plurality of geometric elements on the measurement screen displayed on the display unit;
a process of causing an index indicating the received designation information to be displayed on the measurement screen displayed on the display unit in response to reception of the designation by the receiving process;
a process of generating measurement setting data for calculating values of the one or plurality of measurement items in the measurement object based on the designation information received by the receiving process;
a process of calculating values of the one or plurality of measurement items in the measurement object based on the shape data captured by the capturing process and the measurement setting data generated by the process of generating the measurement setting data; and
a process of selecting, from a plurality of processing programs respectively corresponding to a plurality of processes for respectively specifying a plurality of predefined types of geometric elements and a plurality of processes for respectively calculating values of a plurality of predefined types of measurement items, a plurality of processing programs respectively corresponding to a process for specifying the one or plurality of designated geometric elements and a process for calculating values of the one or plurality of designated measurement items, and generating a text code including a plurality of pieces of processing program information indicating the plurality of selected processing programs and the designation information received by the receiving process.

According to the above code generation support program, the shape data is captured, and the one or plurality of geometric elements and the one or plurality of measurement items are designated for the captured shape data, whereby the measurement setting data is generated. When the one or plurality of geometric elements and the one or plurality of measurement items are designated, the index indicating the designation information of each designation is displayed on the measurement screen. As a result, the user can easily grasp his/her designated contents.

Values of the one or plurality of designated measurement items are calculated based on the generated measurement setting data. Thereby, the user can check whether the designation of the one or plurality of geometric elements and the designation of the one or plurality of measurement items are appropriate based on the calculated values.

Furthermore, according to the above code generation support program, the text code including the plurality of pieces of processing program information indicating the processing program used for specifying one or a plurality of designated geometric elements and the processing program for calculating one or a plurality of designated measurement items, and the designation information is generated.

Thus, by using the generated text code, the user can easily perform setting work of the measurement device for performing desired measurement on the measurement object.

What is claimed is:

1. A code generation support device comprising:
a capture unit configured to capture shape data representing a three-dimensional shape of a measurement object;
a screen generation unit configured to generate a measurement screen including an image of the measurement object based on the shape data captured by the capture unit and cause a display unit to display the measurement screen;
a reception unit configured to receive, as designation information, designation of one or a plurality of geometric elements and designation of one or a plurality of measurement items related to the one or plurality of geometric elements on the measurement screen displayed on the display unit;
an index display unit configured to cause an index indicating the received designation information to be displayed on the measurement screen displayed on the display unit in response to reception of the designation by the reception unit;
a measurement setting generation unit configured to generate measurement setting data for calculating values of the one or plurality of measurement items in the measurement object based on the designation information received by the reception unit;
an execution unit configured to calculate values of the one or plurality of measurement items in the measurement object based on the shape data captured by the capture unit and the measurement setting data generated by the measurement setting generation unit; and
a code generation unit configured to select, from a plurality of processing programs respectively corresponding to a plurality of processes for respectively specifying a plurality of predefined types of geometric elements and a plurality of processes for respectively calculating values of a plurality of predefined types of measurement items, a plurality of processing programs respectively corresponding to a process for specifying the one or plurality of designated geometric elements and a process for calculating values of the one or plurality of designated measurement items, and generate a text code including a plurality of pieces of processing program information indicating the plurality of selected processing programs and the designation information received by the reception unit.

2. The code generation support device according to claim 1, further comprising a library holding unit configured to hold one or a plurality of libraries including the plurality of processing programs, wherein each of the plurality of pieces of processing program information includes information for calling the processing program from the one or plurality of libraries held in the library holding unit.

3. The code generation support device according to claim 1, further comprising an output unit configured to output the text code generated by the code generation unit and the plurality of processing programs indicated by the plurality of pieces of processing program information included in the text code in association with each other.

4. The code generation support device according to claim 3, wherein the screen generation unit causes the display unit to display a character string indicating a method of using the text code and the plurality of processing programs to be output when the output unit outputs the text code and the plurality of processing programs.

5. The code generation support device according to claim 3, further comprising a reference data holding unit configured to hold, as reference shape data, shape data corresponding to an image of the measurement object to be displayed on the measurement screen when the reception unit receives the designation information, wherein the output unit outputs the text code and the plurality of processing programs in association with the reference shape data used to generate the text code.

6. The code generation support device according to claim 5, wherein the reception unit can receive, as correction information, designation of a correction method for correcting position information of the shape data based on the reference shape data, and
in a case where the reception unit receives the correction information, the code generation unit selects, from a plurality of processing programs respectively corresponding to a plurality of processes for respectively executing a plurality of predefined types of correction methods, a processing program corresponding to a process for executing the correction method designated, and generates a text code including processing program information indicating the selected processing program and the correction information received by the reception unit.

7. The code generation support device according to claim 6, wherein priority is predefined for a plurality of processing programs respectively corresponding to a plurality of processes for respectively specifying the plurality of types of geometric elements, a plurality of processes for respectively calculating values of the plurality of types of measurement items, and a plurality of processes for respectively executing the plurality of types of correction methods, and
the code generation unit generates a text code so that an order of the plurality of pieces of processing program information is arranged according to the predefined priority.

8. The code generation support device according to claim 1, wherein the reception unit can receive, as data capture information, designation of a condition for capturing the shape data by the capture unit, and
in a case where the reception unit receives the data capture information, the code generation unit generates the text code to further include the received data capture information.

9. The code generation support device according to claim 1, wherein the reception unit can receive, as designation of the one or each of the plurality of geometric elements, designation for specifying a type of a shape of the one or plurality of geometric elements and designation for specifying a position of the one or plurality of geometric elements, and can receive, as designation of the one or plurality of measurement items, designation for specifying a type of the one or plurality of measurement items.

10. The code generation support device according to claim 1, wherein when receiving the designation of the one or plurality of geometric elements and the designation of the one or plurality of measurement items, the reception unit is configured to receive a character string related to each designation, and
in a case where, together with reception of one designation, the character string related to the one designation is received, the code generation unit includes the received character string in the text code as information indicating contents of the one designation.

11. A program products comprising a non-transitory computer-readable medium having a code generation support program executable by a processing device, the code generation support program causing the processing device to execute:
a process of capturing shape data representing a three-dimensional shape of a measurement object;
a process of generating a measurement screen including an image of the measurement object based on the shape data captured by the capturing process and causing a display unit to display the measurement screen;
a process of receiving, as designation information, designation of one or a plurality of geometric elements and designation of one or a plurality of measurement items related to the one or plurality of geometric elements on the measurement screen displayed on the display unit;
a process of causing an index indicating the received designation information to be displayed on the measurement screen displayed on the display unit in response to reception of the designation by the receiving process;
a process of generating measurement setting data for calculating values of the one or plurality of measurement items in the measurement object based on the designation information received by the receiving process;
a process of calculating values of the one or plurality of measurement items in the measurement object based on the shape data captured by the capturing process and the measurement setting data generated by the process of generating the measurement setting data; and
a process of selecting, from a plurality of processing programs respectively corresponding to a plurality of processes for respectively specifying a plurality of predefined types of geometric elements and a plurality of processes for respectively calculating values of a plurality of predefined types of measurement items, a plurality of processing programs respectively corresponding to a process for specifying the one or plurality of designated geometric elements and a process for calculating values of the one or plurality of designated measurement items, and generating a text code including a plurality of pieces of processing program information indicating the plurality of selected processing programs and the designation information received by the receiving process.
